(19) United States
(12) Patent Application Publication
(10) Pub. No.: US 2024/0086915 A1
(43) Pub. Date: Mar. 14, 2024

(54) Systems and Methods for Token-based Asset Ownership

(71) Applicant: Artema Labs, Inc, Los Angeles, CA (US)

(72) Inventor: Keir Finlow-Bates, Eura (FI)

(73) Assignee: Artema Labs, Inc, Los Angeles, CA (US)

(21) Appl. No.: 18/467,661

(22) Filed: Sep. 14, 2023

Related U.S. Application Data
(60) Provisional application No. 63/375,663, filed on Sep. 14, 2022.

(51) Int. Cl. G06Q 20/40; H04L 9/08; H04L 9/32

(52) U.S. Cl. CPC G06Q 20/401; H04L 9/0825; H04L 9/3247; G06Q 2220/10

(57) ABSTRACT

Systems and techniques for ownership-directed functionalities within NFT platforms are illustrated for determining ownership over a token. The method receives a transaction request, wherein the transaction request seeks to grant ownership access to a first token over a second token. The transaction request includes a first token identifier corresponding to the first token; and a second token identifier corresponding to the second token. The method assesses whether the transaction request is authorized. When the transaction request is assessed to be authorized: the method obtaining a mapping including: the first token identifier, and a record of tokens owned by the first token; and grants ownership access over the second token to the first token, based on the mapping and the second token identifier. Granting ownership access over the second token to the first token includes adding the second token identifier to the record of tokens owned by the first token.

### CROSS-REFERENCE TO RELATED APPLICATIONS

The current application claims the benefit of and priority under 35 U.S.C. § 119(e) to U.S. Provisional Patent Application No. 63/375,663 entitled “NFTs that Own Assets,” filed Sep. 14, 2022, the disclosure of which is hereby incorporated by reference in its entirety for all purposes.

### FIELD OF THE INVENTION

The present invention generally relates to smart contract configurations facilitating token ownership of content.

### BACKGROUND

In the context of blockchains, the term smart contract is often used to refer to software programs that run on a blockchain. While standard legal contracts outline the terms of particular (legal) relationships, smart contracts are used for enforcing sets of rules using cryptographic code. Smart contracts are often developed as high-level programming abstractions that is compiled down to bytecode that can be deployed to a blockchain for execution by computer systems. Once a smart contract is written to a blockchain, the code of the smart contract acts as a programmatically defined autonomous agent. An NFT smart contract is used for the management of digital assets, such as non-fungible tokens.

### SUMMARY OF THE INVENTION

Systems and techniques for ownership-directed functionalities within NFT platforms are illustrated. One embodiment includes a method for determining ownership over a token. The method receives a transaction request, wherein the transaction request seeks to grant ownership access to a first token over a second token. The transaction request includes a first token identifier corresponding to the first token; and a second token identifier corresponding to the second token. The method assesses whether the transaction request is authorized. When the transaction request is assessed to be authorized: the method obtaining a mapping including: the first token identifier, and a record of tokens owned by the first token; and grants ownership access over the second token to the first token, based on the mapping and the second token identifier. Granting ownership access over the second token to the first token includes adding the second token identifier to the record of tokens owned by the first token.

In a further embodiment, the first token is a non-fungible token (NFT).

In another embodiment: the first token is associated with a first smart contract; the second token is associated with a second smart contract; and a contract identifier for the second smart contract is included in the transaction request.

In a further embodiment, the first smart contract instantiated the first token.

In another embodiment, the second token corresponds to a sum of cryptocurrency.

In still another embodiment, the transaction request is sent by a root token; the root token is a non-fungible token (NFT); and the root token has ownership access over the first token.

In a further embodiment, the root token corresponds to a public key; and the public key is associated with a private key that is used to control changes to the ownership access.

In still yet another embodiment, the record of tokens takes a form selected from the group consisting of an array, a JSON, and a dictionary; and the record of tokens distinguishes between different types of tokens owned by the first token.

In another embodiment, assessing whether the transaction request is authorized includes assessing validity of the transaction request by comparing structure of the transaction request to pre-determined protocols. Assessing whether the transaction request is authorized further includes verifying the transaction request has been approved by being digitally signed by a current owner of the second token using a digital signing algorithm specified by the pre-determined protocols.

In a further embodiment, the pre-determined protocols are established for a blockchain.

One embodiment includes a non-transitory computer-readable medium storing instructions that, when executed by a processor, are configured to cause the processor to perform operations for determining ownership over a token. The processor receives a transaction request, wherein the transaction request seeks to grant ownership access to a first token over a second token. The transaction request includes a first token identifier corresponding to the first token; and a second token identifier corresponding to the second token. The processor assesses whether the transaction request is authorized. When the transaction request is assessed to be authorized: the processor obtaining a mapping including: the first token identifier, and a record of tokens owned by the first token; and grants ownership access over the second token to the first token, based on the mapping and the second token identifier. Granting ownership access over the second token to the first token includes adding the second token identifier to the record of tokens owned by the first token.

In a further embodiment, the first token is a non-fungible token (NFT).

In another embodiment: the first token is associated with a first smart contract; the second token is associated with a second smart contract; and a contract identifier for the second smart contract is included in the transaction request.

In a further embodiment, the first smart contract instantiated the first token.

In another embodiment, the second token corresponds to a sum of cryptocurrency.

In still another embodiment, the transaction request is sent by a root token; the root token is a non-fungible token (NFT); and the root token has ownership access over the first token.

In a further embodiment, the root token corresponds to a public key; and the public key is associated with a private key that is used to control changes to the ownership access.

In still yet another embodiment, the record of tokens takes a form selected from the group consisting of an array, a JSON, and a dictionary; and the record of tokens distinguishes between different types of tokens owned by the first token.

In another embodiment, assessing whether the transaction request is authorized includes assessing validity of the transaction request by comparing structure of the transaction request to pre-determined protocols. Assessing whether the transaction request is authorized further includes verifying the transaction request has been approved by being digitally signed by a current owner of the second token using a digital signing algorithm specified by the pre-determined protocols.

In a further embodiment, the pre-determined protocols are established for a blockchain.

Additional embodiments and features are set forth in part in the description that follows, and in part will become apparent to those skilled in the art upon examination of the specification or may be learned by the practice of the invention. A further understanding of the nature and advantages of the present invention may be realized by reference to the remaining portions of the specification and the drawings, which forms a part of this disclosure.

### BRIEF DESCRIPTION OF THE DRAWINGS

The description and claims will be more fully understood with reference to the following figures and data graphs, which are presented as exemplary embodiments of the invention and should not be construed as a complete recitation of the scope of the invention.

FIG. 1 is a conceptual diagram of an NFT platform in accordance with an embodiment of the invention.

FIG. 2 is a network architecture diagram of an NFT platform in accordance with an embodiment of the invention.

FIG. 3 is a conceptual diagram of a permissioned blockchain in accordance with an embodiment of the invention.

FIG. 4 is a conceptual diagram of a permissionless blockchain in accordance with an embodiment of the invention.

FIGS. 5A-5B are diagrams of a dual blockchain in accordance with a number of embodiments of the invention.

FIG. 6 conceptually illustrates a process followed by a Proof of Work consensus mechanism in accordance with an embodiment of the invention.

FIG. 7 conceptually illustrates a process followed by a Proof of Space consensus mechanism in accordance with an embodiment of the invention.

FIG. 8 illustrates a dual proof consensus mechanism configuration in accordance with an embodiment of the invention.

FIG. 9 illustrates a process followed by a Trusted Execution Environment-based consensus mechanism in accordance with some embodiments of the invention.

FIGS. 10-12 depicts various devices that may be utilized alongside an NFT platform in accordance with various embodiments of the invention.

FIG. 13 depicts a media wallet application configuration in accordance with an embodiment of the invention.

FIGS. 14A-14C depicts user interfaces of various media wallet applications in accordance with a number of embodiments of the invention.

FIG. 15 illustrates an NFT ledger entry corresponding to an NFT identifier.

FIGS. 16A-16B illustrate an NFT arrangement relationship with corresponding physical content in accordance with an embodiment of the invention.

FIG. 17 illustrates a process for establishing a relationship between an NFT and corresponding physical content.

FIG. 18 illustrates a process for updating balance using smart contracts configured in accordance with numerous embodiments of the invention.

FIG. 19 illustrates a balance incrementing function, utilized in smart contracts configured in accordance with various embodiments of the invention.

FIG. 20 illustrates a withdrawal function, utilized in smart contracts configured in accordance with several embodiments of the invention.

FIG. 21 illustrates a transfer function, utilized in smart contracts configured in accordance with a number of embodiments of the invention.

FIG. 22 illustrates an NFT smart contract, configured in accordance with multiple embodiments of the invention, to implement various functions.

FIG. 23 illustrates an NFT smart contract, configured in accordance with certain embodiments of the invention, to store multiple token types.

FIG. 24A-24B illustrates systems for token ownership, facilitated by meta-tokens configured in accordance with various embodiments of the invention.

FIG. 25 illustrates a process to change the ownership of tokens configured in accordance with many embodiments of the invention.

FIGS. 26A-26C illustrates example of NFT smart contracts configured in accordance with numerous embodiments of the invention.

FIG. 27 illustrates a physical model of smart contracts configured in accordance with various embodiments of the invention.

FIG. 28 illustrates a diagram of an NFT smart contract configured in accordance with multiple embodiments of the invention, for separating token ownership from conferred token rights.

FIG. 29 illustrates a diagram of an NFT smart contract configured in accordance with various embodiments of the invention, for managing conferred token rights.

FIG. 30 illustrates a proxy rights smart contract configured in accordance with several embodiments of the invention.

FIG. 31 illustrates a fungible token smart contract configured in accordance with numerous embodiments of the invention.

### DETAILED DESCRIPTION

Systems and methods for incorporating ownership-directed functionalities into non-fungible token (NFT) platforms, in accordance with many embodiments of the invention, are described herein. Ownership-directed functionality may include, but is not limited to configurations enabling NFT ownership of various tokens; facilitating token hierarchy structures; and/or managing access to tokens and content.

Systems and methods in accordance with certain embodiments may establish token hierarchies that allow for tokens to directly control ownership rights. In accordance with some embodiments, meta-tokens may be implemented that allow a token to obtain ownership of another token, thereby tying ownership. Additionally or alternatively, in accordance with many embodiments, smart contracts may be implemented that allow NFTs, through the use of smart contracts, to directly own tokens including but not limited to cryptocurrency and digital fungible tokens. Such ownership assertions may be used for management including but not limited to management of access to the owned tokens.

While various token and smart contract configurations are discussed above, access-based functionalities that may be utilized within NFT platforms in accordance with various embodiments of the invention are discussed further below.

### Non-Fungible Token (NFT) Platforms

Turning now to the drawings, systems and methods for implementing blockchain-based Non-Fungible Token (NFT) platforms in accordance with various embodiments of the invention are illustrated. In several embodiments, blockchain-based NFT platforms are platforms which enable content creators to issue, mint, and transfer Non-Fungible Tokens (NFTs) directed to content including, but not limited to, rich media content.

In a number of embodiments, content creators may issue NFTs to users within the NFT platform. NFTs may be created around a large range of real-world media content and intellectual property. Movie studios may mint digital collectibles for their movies, characters, notable scenes and/or notable objects. Record labels may mint digital collectibles for artists, bands, albums and/or songs. Similarly, official digital trading cards may be made from likeness of celebrities, cartoon characters and/or gaming avatars.

NFTs minted using NFT platforms in accordance with various embodiments of the invention may have multifunctional programmable use cases including rewards, private access to premium content and experiences, as discounts toward the purchase of goods, among many other value-added use cases.

In many embodiments, each NFT may have a set of attributes that define its unique properties. NFTs may therefore be classified based on which attributes are emphasized. Possible classifications may address, but are not limited to: NFTs as identifying entities, NFTs output by other NFTs, NFTs as content creation assets, and NFTs as evaluating entities. NFTs may be interpreted differently by various platforms in order to create platform-specific user experiences. The metadata associated with an NFT may also include digital media assets such as (but not limited to) images, videos about the specific NFT, and the context in which it was created (studio, film, band, company song etc.).

In many embodiments, NFT storage may be facilitated through mechanisms for the transfer of payment from users to one or more service providers. Through these mechanisms, a payment system for NFT maintenance may allow for incremental payment and ongoing asset protection. NFT storage may be additionally self-regulated through willing participants disclosing unsatisfactory NFT management in exchange for rewards.

In many embodiments, the NFT platform may include media wallet applications that enable users to securely store NFTs and/or other tokens on their devices. Furthermore, media wallets (also referred to as “digital wallets”) may enable users to obtain NFTs that prove purchase of rights to access a particular piece of media content on one platform and use the NFT to gain access to the purchased content on another platform. The consumption of such content may be governed by content classification directed to visual user interface systems.

In several embodiments, users may download and install media wallet applications to store NFTs on the same computing devices used to consume streamed and/or downloaded content. Media wallet applications and NFTs may disseminate data concerning media consumption on the computing devices on which the media wallet applications are installed and/or based upon observations indicative of media consumption independently of the device. Media consumption data may include, but is not limited to, data reporting the occurrence of NFT transactions, data reporting the occurrence of NFT event interactions data reporting the content of NFT transactions, data reporting the content of media wallet interactions, and/or data reporting the occurrence of media wallet interactions.

While various aspects of NFT platforms, NFTs, media wallets, blockchain configurations, reporting structures, and maintenance systems are discussed above, NFT platforms and different components that may be utilized within NFT platforms in accordance with various embodiments of the invention are discussed further below.

### NFT Platforms

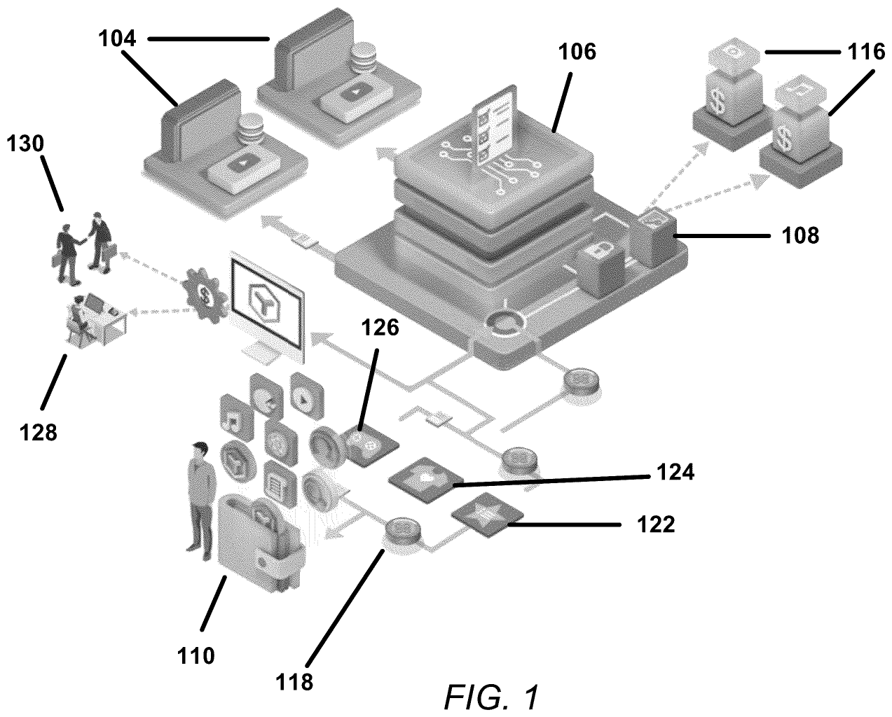

An NFT platform in accordance with an embodiment of the invention is illustrated in FIG. 1. The NFT platform 100 utilizes one or more immutable ledgers (e.g. one or more blockchains) to enable a number of verified content creators 104 to access an NFT registry service to mint NFTs 106 in a variety of forms including (but not limited to) celebrity NFTs 122, character NFTs from games 126, NFTs that are redeemable within games 126, NFTs that contain and/or enable access to collectibles 124, and NFTs that have evolutionary capabilities representative of the change from one NFT state to another NFT state.

Issuance of NFTs 106 via the NFT platform 100 enables verification of the authenticity of NFTs independently of the content creator 104 by confirming that transactions written to one or more of the immutable ledgers are consistent with the smart contracts 108 underlying the NFTs.

As is discussed further below, content creators 104 may provide the NFTs 106 to users to reward and/or incentivize engagement with particular pieces of content and/or other user behavior including (but not limited to) the sharing of user personal information (e.g. contact information or user ID information on particular services), demographic information, and/or media consumption data with the content creator and/or other entities. In addition, the smart contracts 108 underlying the NFTs may cause payments of residual royalties 116 when users engage in specific transactions involving NFTs (e.g. transfer of ownership of the NFT).

In a number of embodiments, users utilize media wallet applications 110 on their devices to store NFTs 106 distributed using the NFT platform 100. Users may use media wallet applications 110 to obtain and/or transfer NFTs 106. In facilitating the retention or transfer of NFTs 106, media wallet applications may utilize wallet user interfaces that engage in transactional restrictions through either uniform or personalized settings. Media wallet applications 110 in accordance with some embodiments may incorporate NFT filtering systems to avoid unrequested NFT assignment. Methods for increased wallet privacy may also operate through multiple associated wallets with varying capabilities. As may readily be appreciated, NFTs 106 that are implemented using smart contracts 108 having interfaces that comply with open standards are not limited to being stored within media wallets and may be stored in any of a variety of wallet applications as appropriate to the requirements of a given application. Furthermore, a number of embodiments of the invention support movement of NFTs 106 between different immutable ledgers. Processes for moving NFTs between multiple immutable ledgers in accordance with various embodiments of the invention are discussed further below.

In several embodiments, content creators 104 may incentivize users to grant access to media consumption data using offers including (but not limited to) offers of fungible tokens 118 and/or NFTs 106. In this way, the ability of the content creators to mint NFTs enables consumers to engage directly with the content creators and may be utilized to incentivize users to share with content creators' data concerning user interactions with additional content. The permissions granted by individual users may enable the content creators 104 to directly access data written to an immutable ledger. In many embodiments, the permissions granted by individual users enable authorized computing systems to access data within an immutable ledger and content creators 104 may query the authorized computing systems to obtain aggregated information. Numerous other example functions for content creators 104 are possible, some of which are discussed below.

NFT blockchains in accordance with various embodiments of the invention enable issuance of NFTs by verified users. In many embodiments, the verified users may be content creators that are vetted by an administrator of networks that may be responsible for deploying and maintaining the NFT blockchain. Once the NFTs are minted, users may obtain and conduct transactions with the NFTs. In several embodiments, the NFTs may be redeemable for items or services in the real world such as (but not limited to) admission to movie screenings, concerts, and/or merchandise.

As illustrated in FIG. 1, users may install the media wallet application 110 onto their devices and use the media wallet application 110 to purchase fungible tokens. The media wallet application could also be provided by a browser, or by a dedicated hardware unit executing instructions provided by a wallet manufacturer. The different types of wallets may have slightly different security profiles and may offer different features, but would all be able to be used to initiate the change of ownership of tokens, such as NFTs. In many embodiments, the fungible tokens may be fully converted into fiat currency and/or other cryptocurrency. In several embodiments, the fungible tokens are implemented using split blockchain models in which the fungible tokens may be issued to multiple blockchains (e.g. Ethereum). As may readily be appreciated, the fungible tokens and/or NFTs utilized within an NFT platform in accordance with various embodiments of the invention are largely dependent upon the requirements of a given application.

In several embodiments, the media wallet application is capable of accessing multiple blockchains by deriving accounts from each of the various immutable ledgers used within an NFT platform. For each of these blockchains, the media wallet application may automatically provide simplified views whereby fungible tokens and NFTs across multiple accounts and/or multiple blockchains may be rendered as single user profiles and/or wallets. In many embodiments, the single view may be achieved using deep-indexing of the relevant blockchains and API services that may rapidly provide information to media wallet applications in response to user interactions. In certain embodiments, the accounts across the multiple blockchains may be derived using BIP32 deterministic wallet key. In other embodiments, any of a variety of techniques may be utilized by the media wallet application to access one or more immutable ledgers as appropriate to the requirements of a given application.

NFTs may be purchased by way of exchanges 130 and/or from other users 128. In addition, content creators may directly issue NFTs to the media wallets of specific users (e.g. by way of push download or AirDrop). In many embodiments, the NFTs are digital collectibles such as celebrity NFTs 122, character NFTs from games 126, NFTs that are redeemable within games 126, and/or NFTs that contain and/or enable access to collectibles 124. It should be appreciated that a variety of NFTs are described throughout the discussion of the various embodiments described herein and may be utilized in any NFT platform and/or with any media wallet application.

While the NFTs are shown as static in the illustrated embodiment, content creators may utilize users' ownership of NFTs to engage in additional interactions with the user. In this way, the relationship between users and particular pieces of content and/or particular content creators may evolve over time around interactions driven by NFTs. In a number of embodiments, collection of NFTs may be gamified to enable unlocking of additional NFTs. In addition, leaderboards may be established with respect to particular content and/or franchises based upon users' aggregation of NFTs. As is discussed further below, NFTs and/or fungible tokens may also be utilized by content creators to incentivize users to share data.

NFTs minted in accordance with several embodiments of the invention may incorporate a series of instances of digital content elements in order to represent the evolution of the digital content over time. Each one of these digital elements may have multiple numbered copies, just like a lithograph, and each such version may have a serial number associated with it, and/or digital signatures authenticating its validity. The digital signature may associate the corresponding image to an identity, such as the identity of the artist. The evolution of digital content may correspond to the transition from one representation to another representation. This evolution may be triggered by the artist, by an event associated with the owner of the artwork, by an external event measured by platforms associated with the content, and/or by specific combinations or sequences of event triggers. Some such NFTs may also have corresponding series of physical embodiments. These may be physical and numbered images that are identical to the digital instances described above. They may also be physical representations of another type, e.g., clay figures or statues, whereas the digital representations may be drawings. The physical embodiments may further be of different aspects that relate to the digital series. Evolution in compliance with some embodiments may also be used to spawn additional content, for example, one NFT directly creating one or more secondary NFTs.

When the user wishes to purchase an NFT using fungible tokens, media wallet applications may request authentication of the NFT directly based upon the public key of the content creator and/or indirectly based upon transaction records within the NFT blockchain. As discussed above, minted NFTs may be signed by content creators and administrators of the NFT blockchain. In addition, users may verify the authenticity of particular NFTs without the assistance of entities that minted the NFT by verifying that the transaction records involving the NFT within the NFT blockchain are consistent with the various royalty payment transactions required to occur in conjunction with transfer of ownership of the NFT by the smart contract underlying the NFT.

Applications and methods in accordance with various embodiments of the invention are not limited to media wallet applications or use within NFT platforms. Accordingly, it should be appreciated that the data collection capabilities of any media wallet application described herein may also be implemented outside the context of an NFT platform and/or in a dedicated application and/or in an application unrelated to the storage of fungible tokens and/or NFTs. Various systems and methods for implementing NFT platforms and media wallet applications in accordance with various embodiments of the invention are discussed further below.

### NFT Platform Network Architectures

NFT platforms in accordance with many embodiments of the invention utilize public blockchains and permissioned blockchains. In several embodiments, the public blockchain is decentralized and universally accessible. Additionally, in a number of embodiments, private/permissioned blockchains are closed systems that are limited to publicly inaccessible transactions. In many embodiments, the permissioned blockchain may be in the form of distributed ledgers, while the blockchain may alternatively be centralized in a single entity.

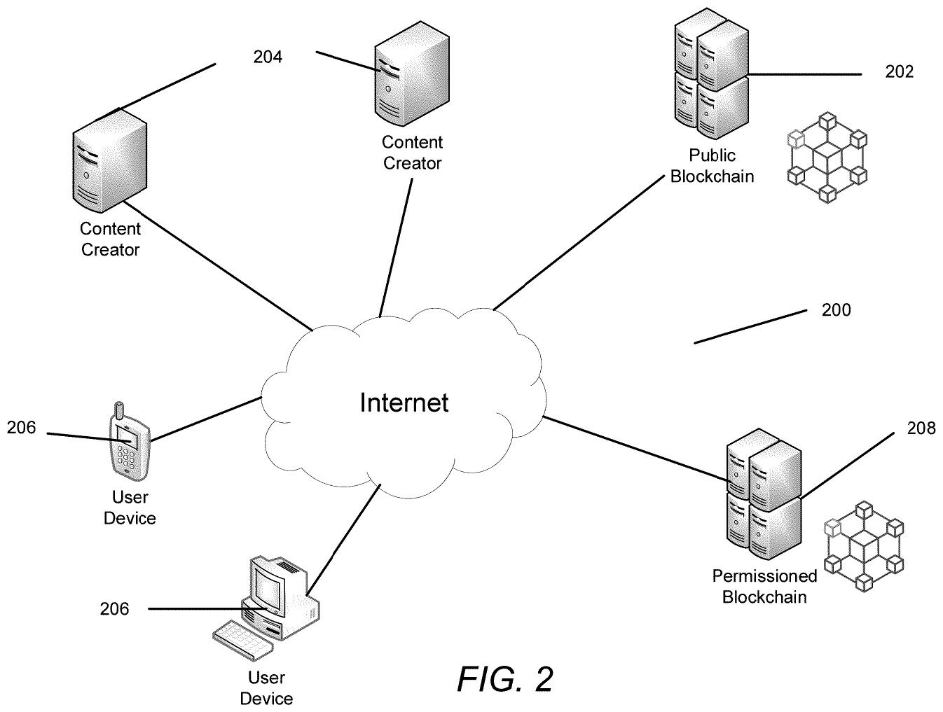

An example of network architecture that may be utilized to implement an NFT platform including a public blockchain and a permissioned blockchain in accordance with several embodiments of the invention is illustrated in FIG. 2. The NFT platform 200 utilizes computer systems implementing a public blockchain 202 such as (but not limited to) Ethereum and Solana. A benefit of supporting interactions with public blockchains 202 is that the NFT platform 200 may support minting of standards based NFTs that may be utilized in an interchangeable manner with NFTs minted by sources outside of the NFT platform on the public blockchain. In this way, the NFT platform 200 and the NFTs minted within the NFT platform are not part of a walled garden, but are instead part of a broader blockchain-based ecosystem. The ability of holders of NFTs minted within the NFT platform 200 to transact via the public blockchain 202 increases the likelihood that individuals acquiring NFTs will become users of the NFT platform. Initial NFTs minted outside the NFT platform may also be developed through later minted NFTs, with the initial NFTs being used to further identify and interact with the user based upon their ownership of both NFTs. Various systems and methods for facilitating the relationships between NFTs, both outside and within the NFT platform are discussed further below.

Users may utilize user devices configured with appropriate applications including (but not limited to) media wallet applications to obtain NFTs. In many embodiments, media wallets are smart device enabled, front-end applications for fans and/or consumers, central to all user activity on an NFT platform. As is discussed in detail below, different embodiments of media wallet applications may provide any of a variety of functionality that may be determined as appropriate to the requirements of a given application. In the illustrated embodiment, the user devices 206 are shown as mobile phones and personal computers. As may readily be appreciated user devices may be implemented using any class of consumer electronics device including (but not limited to) tablet computers, laptop computers, televisions, game consoles, virtual reality headsets, mixed reality headsets, augmented reality headsets, media extenders, and/or set top boxes as appropriate to the requirements of a given application.

In many embodiments, NFT transaction data entries in the permissioned blockchain 208 are encrypted using users' public keys so that the NFT transaction data may be accessed by the media wallet application. In this way, users control access to entries in the permissioned blockchain 208 describing the user's NFT transaction. In several embodiments, users may authorize content creators 204 to access NFT transaction data recorded within the permissioned blockchain 208 using one of a number of appropriate mechanisms including (but not limited to) compound identities where the user is the owner of the data and the user may authorize other entities as guests that may also access the data. As may readily be appreciated, particular content creators' access to the data may be revoked by revoking their status as guests within the compound entity authorized to access the NFT transaction data within the permissioned blockchain 208. In certain embodiments, compound identities are implemented by writing authorized access records to the permissioned blockchain using the user's public key and the public keys of the other members of the compound entity.

When content creators wish to access particular pieces of data stored within the permissioned blockchain 208, they may make a request to a data access service. The data access service may grant access to data stored using the permissioned blockchain 208 when the content creators' public keys correspond to public keys of guests. In a number of embodiments, guests may be defined within a compound identity. The access record for the compound entity may also authorize the compound entity to access the particular piece of data. In this way, the user has complete control over access to their data at any time by admitting or revoking content creators to a compound entity, and/or modifying the access policies defined within the permissioned blockchain 208 for the compound entity. In several embodiments, the permissioned blockchain 208 supports access control lists and users may utilize a media wallet application to modify permissions granted by way of the access control list. In many embodiments, the manner in which access permissions are defined enables different restrictions to be placed on particular pieces of information within a particular NFT transaction data record within the permissioned blockchain 208. As may readily be appreciated, the manner in which NFT platforms and/or immutable ledgers provide fine-grained data access permissions largely depends upon the requirements of a given application.

In many embodiments, storage nodes within the permissioned blockchain 208 do not provide content creators with access to entire NFT transaction histories. Instead, the storage nodes simply provide access to encrypted records. In several embodiments, the hash of the collection of records from the permissioned blockchain is broadcast. Therefore, the record is verifiably immutable and each result includes the hash of the record and the previous/next hashes. As noted above, the use of compound identities and/or access control lists may enable users to grant permission to decrypt certain pieces of information or individual records within the permissioned blockchain. In several embodiments, the access to the data is determined by computer systems that implement permission-based data access services.

In many embodiments, the permissioned blockchain 208 may be implemented using any blockchain technology appropriate to the requirements of a given application. As noted above, the information and processes described herein are not limited to data written to permissioned blockchains 208, and NFT transaction data simply provides an example. Systems and methods in accordance with various embodiments of the invention may be utilized to enable applications to provide fine-grained permission to any of a variety of different types of data stored in an immutable ledger as appropriate to the requirements of a given application in accordance with various embodiments of the invention.

While various implementations of NFT platforms are described above with reference to FIG. 2, NFT platforms may be implemented using any number of immutable and pseudo-immutable ledgers as appropriate to the requirements of specific applications in accordance with various embodiments of the invention. Blockchain databases in accordance with various embodiments of the invention may be managed autonomously using peer-to-peer networks and distributed timestamping servers. In some embodiments, any of a variety of consensus mechanisms may be used by public blockchains, including but not limited to Proof of Space mechanisms, Proof of Work mechanisms, Proof of Stake mechanisms, and hybrid mechanisms.

NFT platforms in accordance with many embodiments of the invention may benefit from the oversight and increased security of private blockchains. As may readily be appreciated, a variety of approaches may be taken to the writing of data to permissioned blockchains and the particular approach is largely determined by the requirements of particular applications. As such, computer systems in accordance with various embodiments of the invention may have the capacity to create verified NFT entries written to permissioned blockchains.

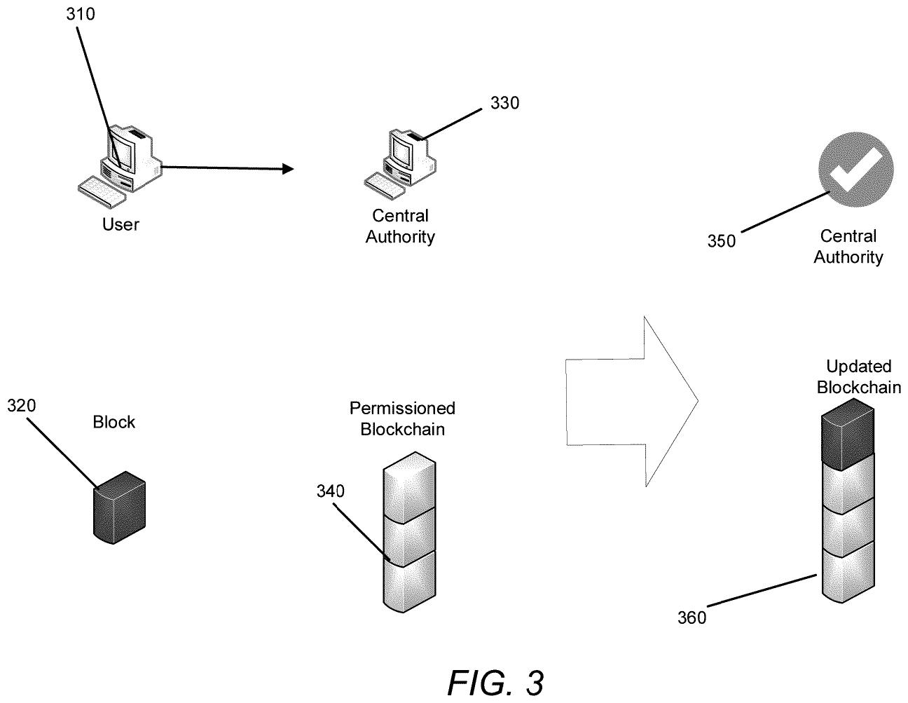

An implementation of permissioned (or private) blockchains in accordance with some embodiments of the invention is illustrated in FIG. 3. Permissioned blockchains 340 may typically function as closed computing systems in which each participant is well defined. In several embodiments, private blockchain networks may require invitations. In a number of embodiments, entries, or blocks 320, to private blockchains may be validated. In some embodiments, the validation may come from central authorities 330. Private blockchains may allow an organization or a consortium of organizations to efficiently exchange information and record transactions. Specifically, in a permissioned blockchain, a preapproved central authority 330 (which should be understood as potentially encompassing multiple distinct authorized authorities) may approve a change to the blockchain. In a number of embodiments, approval may come without the use of a consensus mechanism involving multiple authorities. As such, through a direct request from users 310 to the central authority 330, the determination of whether blocks 320 may be allowed access to the permissioned blockchain 340 may be determined. Blocks 320 needing to be added, eliminated, relocated, and/or prevented from access may be controlled through these means. In doing so the central authority 330 may manage accessing and controlling the network blocks incorporated into the permissioned blockchain 340. Upon the approval 350 of the central authority, the now updated blockchain 360 may reflect the added block 320.

NFT platforms in accordance with many embodiments of the invention may also benefit from the anonymity and accessibility of a public blockchain. Therefore, NFT platforms in accordance with many embodiments of the invention may have the capacity to create verified NFT entries written to a permissioned blockchain.

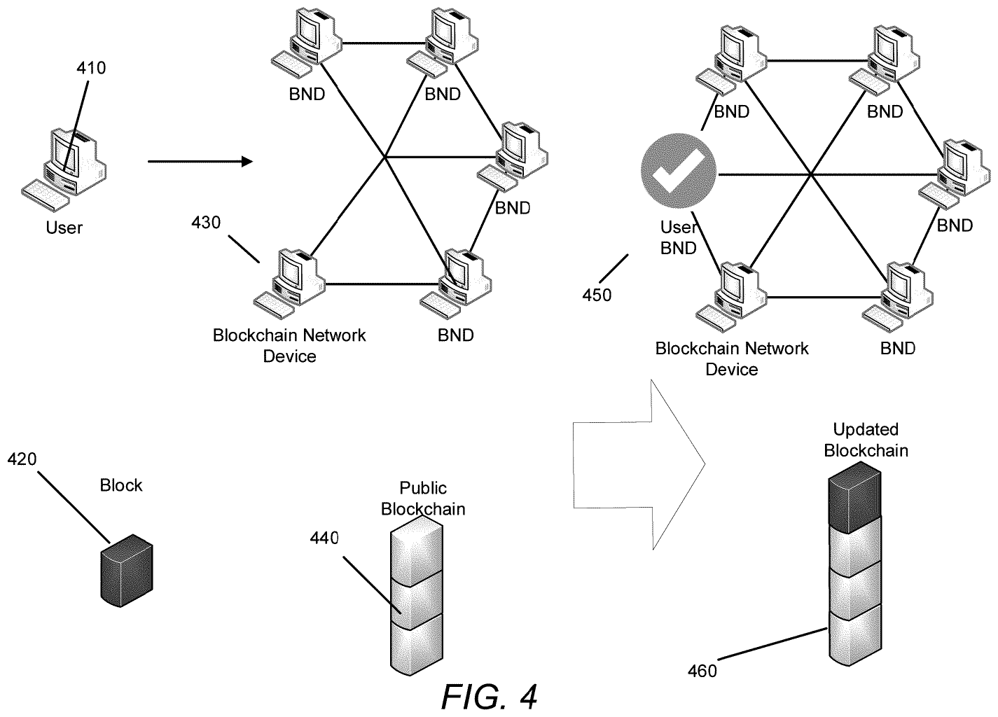

An implementation of a permissionless, decentralized, or public blockchain in accordance with an embodiment of the invention is illustrated in FIG. 4. In a permissionless blockchain, individual users 410 may directly participate in relevant networks and operate as blockchain network devices 430. As blockchain network devices 430, parties would have the capacity to participate in changes to the blockchain and participate in transaction verifications (via the mining mechanism). Transactions are broadcast over the computer network and data quality is maintained by massive database replication and computational trust. Despite being decentralized, an updated blockchain 460 cannot remove entries, even if anonymously made, making it immutable. In many decentralized blockchains, many blockchain network devices 430, in the decentralized system may have copies of the blockchain, allowing the ability to validate transactions. In many instances, the blockchain network device 430 may personally add transactions, in the form of blocks 420 appended to the public blockchain 440. To do so, the blockchain network device 430 would take steps to allow for the transactions to be validated 450 through various consensus mechanisms (Proof of Work, Proof of Stake, etc.). A number of consensus mechanisms in accordance with various embodiments of the invention are discussed further below.

Additionally, in the context of blockchain configurations, the term smart contract is often used to refer to software programs that run on blockchains. While a standard legal contract outlines the terms of a relationship (usually one enforceable by law), a smart contract enforces a set of rules using self-executing code within NFT platforms. As such, smart contracts may have the means to automatically enforce specific programmatic rules through platforms. Smart contracts are often developed as high-level programming abstractions that may be compiled down to bytecode. Said bytecode may be deployed to blockchains for execution by computer systems using any number of mechanisms deployed in conjunction with the blockchain. In many instances, smart contracts execute by leveraging the code of other smart contracts in a manner similar to calling upon a software library.

A number of existing decentralized blockchain technologies intentionally exclude or prevent rich media assets from existing within the blockchain, because they would need to address content that is not static (e.g., images, videos, music files). Therefore, NFT platforms in accordance with many embodiments of the invention may address this with blockchain mechanisms, that preclude general changes but account for updated content.

NFT platforms in accordance with many embodiments of the invention may therefore incorporate decentralized storage pseudo-immutable dual blockchains. In some embodiments, two or more blockchains may be interconnected such that traditional blockchain consensus algorithms support a first blockchain serving as an index to a second, or more, blockchains serving to contain and protect resources, such as the rich media content associated with NFTs.

In storing rich media using blockchain, several components may be utilized by an entity (“miner”) adding transactions to said blockchain. References, such as URLs, may be stored in the blockchain to identify assets. Multiple URLs may also be stored when the asset is separated into pieces. An alternative or complementary option may be the use of APIs to return either the asset or a URL for the asset. In accordance with many embodiments of the invention, references may be stored by adding a ledger entry incorporating the reference enabling the entry to be timestamped. In doing so, the URL, which typically accounts for domain names, may be resolved to IP addresses. However, when only files of certain types are located on particular resources, or where small portions of individual assets are stored at different locations, users may require methods to locate assets stored on highly-splintered decentralized storage systems. To do so, systems may identify at least primary asset destinations and update those primary asset destinations as necessary when storage resources change. The mechanisms used to identify primary asset destinations may take a variety of forms including, but not limited to, smart contracts.

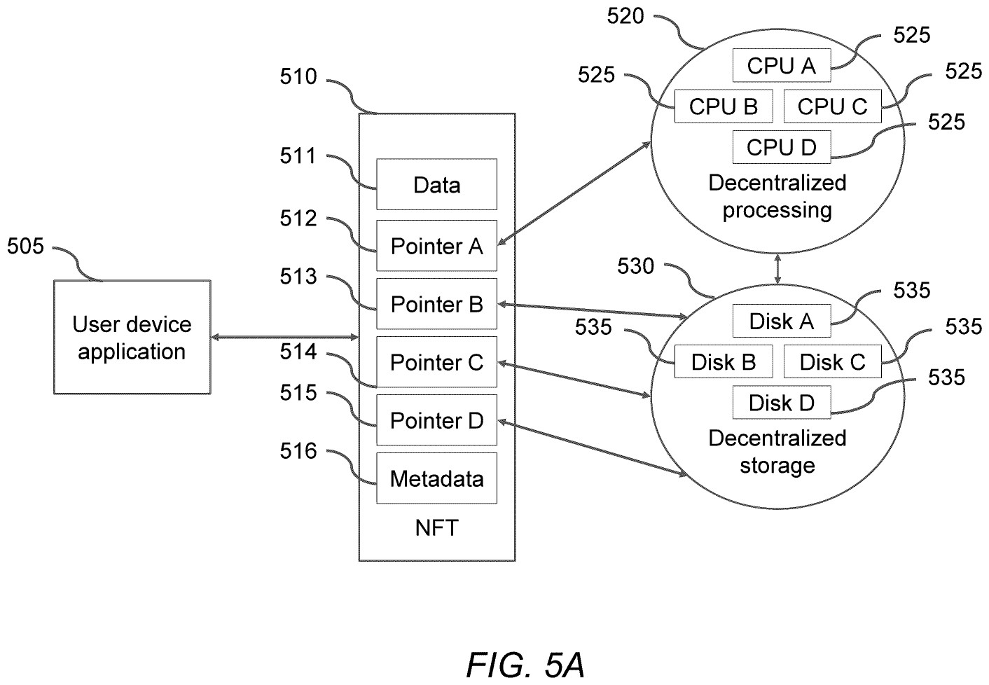

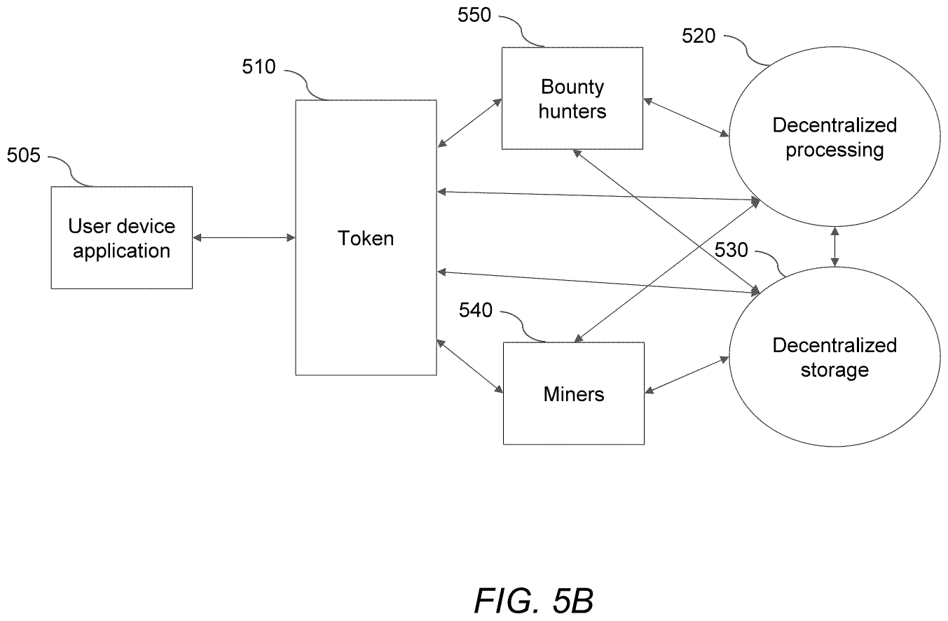

A dual blockchain, including decentralized processing 520 and decentralized storage 530 blockchains, in accordance with some embodiments of the invention is illustrated in FIG. 5A. Application running on devices 505, may interact with or make a request related to NFTs 510 interacting with such a blockchain. An NFT 510 in accordance with several embodiments of the invention may include many values including generalized data 511 (e.g. URLs), and pointers such as pointer A 512, pointer B 513, pointer C 514, and pointer D 515. In accordance with many embodiments of the invention, the generalized data 511 may be used to access corresponding rich media through the NFT 510. The NFT 510 may additionally have associated metadata 516.

Pointers within the NFT 510 may direct an inquiry toward a variety of on or off-ledger resources. In some embodiments of the invention, as illustrated FIG. 5A, pointer A 512 may direct the need for processing to the decentralized processing network 520. Processing systems are illustrated as CPU A, CPU B, CPU C, and CPU D 525. The CPUs 525 may be personal computers, server computers, mobile devices, edge IoT devices, etc. Pointer A may select one or more processors at random to perform the execution of a given smart contract. The code may be secure or nonsecure and the CPU may be a trusted execution environment (TEE), depending upon the needs of the request. In the example reflected in FIG. 5A, pointer B 513, pointer C 514, and pointer D 515 all point to a decentralized storage network 530 including remote off-ledger resources including storage systems illustrated as Disks A, B, C, and D 535.

The decentralized storage system may co-mingle with the decentralized processing system as the individual storage systems utilize CPU resources and connectivity to perform their function. From afunctional perspective, the two decentralized systems may also be separate. Pointer B 513 may point to one or more decentralized storage networks 530 for the purposes of maintaining an off-chain log file of token activity and requests. Pointer C 514 may point to executable code within one or more decentralized storage networks 530. And Pointer D 515 may point to rights management data, security keys, and/or configuration data within one or more decentralized storage networks 530.

Dual blockchains may additionally incorporate methods for detection of abuse, essentially operating as a “bounty hunter” 550. FIG. 5B illustrates the inclusion of bounty hunters 550 within dual blockchain structures implemented in accordance with an embodiment of the invention. Bounty hunters 550 allow NFTs 510, which may point to networks that may include decentralized processing 520 and/or storage networks 530, to be monitored. The bounty hunter's 550 objective may be to locate incorrectly listed or missing data and executable code within the NFT 510 or associated networks. Additionally, the miner 540 may have the capacity to perform all necessary minting processes or any process within the architecture that involves a consensus mechanism.

Bounty hunters 550 may also choose to verify each step of a computation, and if they find an error, submit evidence of this in return for some reward. This may have the effect of invalidating the incorrect ledger entry and, potentially based on policies, all subsequent ledger entries. Such evidence may be submitted in a manner that is associated with a public key, in which the bounty hunter 550 proves knowledge of the error, thereby assigning value (namely the bounty) with the public key.

Assertions made by bounty hunters 550 may be provided directly to miners 540 by broadcasting the assertion. Assertions may be broadcast in a manner including, but not limited to posting it to a bulletin board. In some embodiments of the invention, assertions may be posted to ledgers of blockchains, for instance, the blockchain on which the miners 540 operate. If the evidence in question has not been submitted before, this may automatically invalidate the ledger entry that is proven wrong and provide the bounty hunter 550 with some benefit.

Applications and methods in accordance with various embodiments of the invention are not limited to use within NFT platforms. Accordingly, it should be appreciated that the capabilities of any blockchain configuration described herein may also be implemented outside the context of an NFT platform network architecture unrelated to the storage of fungible tokens and/or NFTs. A variety of components, mechanisms, and blockchain configurations that may be utilized within NFT platforms are discussed further below. Moreover, any of the blockchain configurations described herein with reference to FIGS. 3-5B (including permissioned, permissionless, and/or hybrid mechanisms) may be utilized within any of the networks implemented within the NFT platforms described above.

### NFT Platform Consensus Mechanisms

NFT platforms in accordance with many embodiments of the invention may depend on consensus mechanisms to achieve agreement on network state, through proof resolution, to validate transactions. In accordance with many embodiments of the invention, Proof of Work (PoW) mechanisms may be used as a means of demonstrating non-trivial allocations of processing power. Proof of Space (PoS) mechanisms may be used as a means of demonstrating non-trivial allocations of memory or disk space. As a third possible approach, Proof of Stake mechanisms may be used as a means of demonstrating non-trivial allocations of fungible tokens and/or NFTs as a form of collateral. Numerous consensus mechanisms are possible in accordance with various embodiments of the invention, some of which are expounded on below.

Traditional mining schemes, such as Bitcoin, are based on Proof of Work, based on performing the aforementioned large computational tasks. The cost of such tasks may not only be computational effort, but also energy expenditure, a significant environmental concern. To address this problem, mining methods operating in accordance with many embodiments of the invention may instead operate using Proof of Space mechanisms to accomplish network consensus, wherein the distinguishing factor may be memory rather than processing power. Specifically, Proof of Space mechanisms may perform this through network optimization challenges. In several embodiments the network optimization challenge may be selected from any of a number of different challenges appropriate to the requirements of specific applications including graph pebbling. In some embodiments, graph pebbling may refer to a resource allocation game played on discrete mathematics graphs, ending with a labeled graph disclosing how a player might get at least one pebble to every vertex of the graph.

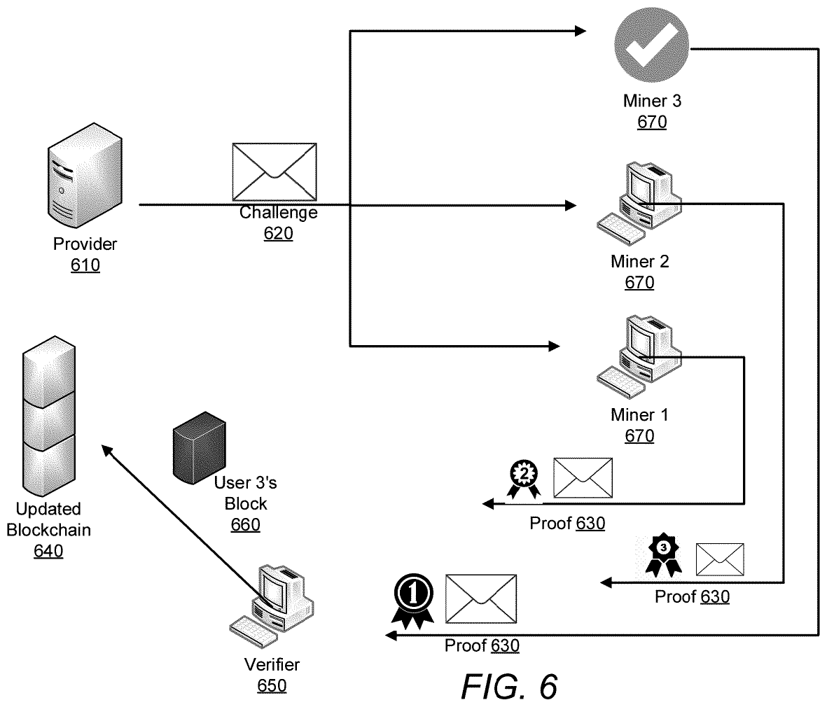

An example of Proof of Work consensus mechanisms that may be implemented in decentralized blockchains, in accordance with a number of embodiments of the invention, is conceptually illustrated in FIG. 6. The example disclosed in this figure is a challenge-response authentication, a protocol classification in which one party presents a complex problem (“challenge”) 610 and another party must broadcast a valid answer (“proof”) 620 to have clearance to add a block to the decentralized ledger that makes up the blockchain 630. As a number of miners may be competing to have this ability, there may be a need for determining factors for the addition to be added first, which in this case is processing power. Once an output is produced, verifiers 640 in the network may verify the proof, something which typically requires much less processing power, to determine the first device that would have the right to add the winning block 650 to the blockchain 630. As such, under a Proof of Work consensus mechanism, each miner involved may have a success probability proportional to the computational effort expended.

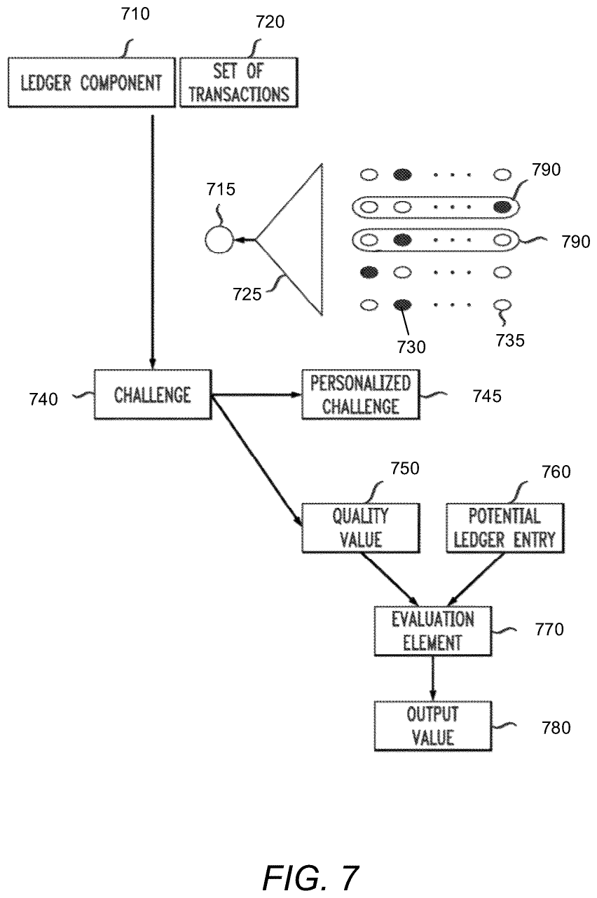

An example of Proof of Space implementations on devices in accordance with some embodiments of the invention is conceptually illustrated in FIG. 7. The implementation includes a ledger component 710, a set of transactions 720, and a challenge 740 computed from a portion of the ledger component 710. A representation 715 of a miner's state may also be recorded in the ledger component 710 and be publicly available.

In some embodiments, the material stored on the memory of the device includes a collection of nodes 730, 735, where nodes that depend on other nodes have values that are functions of the values of the associated nodes on which they depend. For example, functions may be one-way functions, such as cryptographic hash functions. In several embodiments the cryptographic hash function may be selected from any of a number of different cryptographic hash functions appropriate to the requirements of specific applications including (but not limited to) the SHA1 cryptographic hash function. In such an example, one node in the network may be a function of three other nodes. Moreover, the node may be computed by concatenating the values associated with these three nodes and applying the cryptographic hash function, assigning the result of the computation to the node depending on these three parent nodes. In this example, the nodes are arranged in rows, where two rows 790 are shown. The nodes are stored by the miner, and may be used to compute values at a setup time. This may be done using Merkle tree hash-based data structures 725, or another structure such as a compression function and/or a hash function.

Challenges 740 may be processed by the miner to obtain personalized challenges 745, made to the device according to the miner's storage capacity. The personalized challenge 745 may be the same or have a negligible change, but could also undergo an adjustment to account for the storage space accessible by the miner, as represented by the nodes the miner stores. For example, when the miner does not have a large amount of storage available or designated for use with the Proof of Space system, a personalized challenge 745 may adjust challenges 740 to take this into consideration, thereby making a personalized challenge 745 suitable for the miner's memory configuration.

In some embodiments, the personalized challenge 745 may indicate a selection of nodes 730, denoted in FIG. 7 by filled-in circles. In the FIG. 7 example specifically, the personalized challenge corresponds to one node per row. The collection of nodes selected as a result of computing the personalized challenge 745 may correspond to a valid potential ledger entry 760. However, here a quality value 750 (also referred to herein as a qualifying function value) may also be computed from the challenge 740, or from other public information that is preferably not under the control of any one miner.

A miner may perform matching evaluations 770 to determine whether the set of selected nodes 730 matches the quality value 750. This process may take into consideration what the memory constraints of the miner are, causing the evaluation 770 to succeed with a greater frequency for larger memory configurations than for smaller memory configurations. This may simultaneously level the playing field to make the likelihood of the evaluation 770 succeeding roughly proportional to the size of the memory used to store the nodes used by the miner. In some embodiments, non-proportional relationships may be created by modifying the function used to compute the quality value 750. When the evaluation 770 results in success, then the output value 780 may be used to confirm the suitability of the memory configuration and validate the corresponding transaction.

In many embodiments, nodes 730 and 735 may also correspond to public keys. The miner may submit valid ledger entries, corresponding to a challenge-response pair including one of these nodes. In that case, public key values may become associated with the obtained NFT. As such, miners may use a corresponding secret/private key to sign transaction requests, such as purchases. Additionally, any type of digital signature may be used in this context, such as RSA signatures, Merkle signatures, DSS signatures, etc. Further, the nodes 730 and 735 may correspond to different public keys or to the same public key, the latter preferably augmented with a counter and/or other location indicator such as a matrix position indicator, as described above. Location indicators in accordance with many embodiments of the invention may be applied to point to locations within a given ledger. In accordance with some embodiments of the invention, numerous Proof of Space consensus configurations are possible, some of which are discussed below.

Hybrid methods of evaluating Proof of Space problems may also be implemented in accordance with many embodiments of the invention. In many embodiments, hybrid methods may be utilized that conceptually correspond to modifications of Proof of Space protocols in which extra effort is expanded to increase the probability of success, or to compress the amount of space that may be applied to the challenge. Both come at a cost of computational effort, thereby allowing miners to improve their odds of winning by spending greater computational effort. Accordingly, in many embodiments of the invention dual proof-based systems may be used to reduce said computational effort. Such systems may be applied to Proof of Work and Proof of Space schemes, as well as to any other type of mining-based scheme.

When utilizing dual proofs in accordance with various embodiments of the invention, the constituent proofs may have varying structures. For example, one may be based on Proof of Work, another on Proof of Space, and a third may be a system that relies on a trusted organization for controlling the operation, as opposed to relying on mining for the closing of ledgers. Yet other proof structures may be combined in this way. The result of the combination will inherit properties of its components. In many embodiments, the hybrid mechanism may incorporate a first and a second consensus mechanism. In several embodiments, the hybrid mechanism includes a first, a second, and a third consensus mechanisms. In a number of embodiments, the hybrid mechanism includes more than three consensus mechanisms. Any of these embodiments may utilize consensus mechanisms selected from the group including (but not limited to) Proof of Work, Proof of Space, and Proof of Stake without departing from the scope of the invention. Depending on how each component system is parametrized, different aspects of the inherited properties will dominate over other aspects.

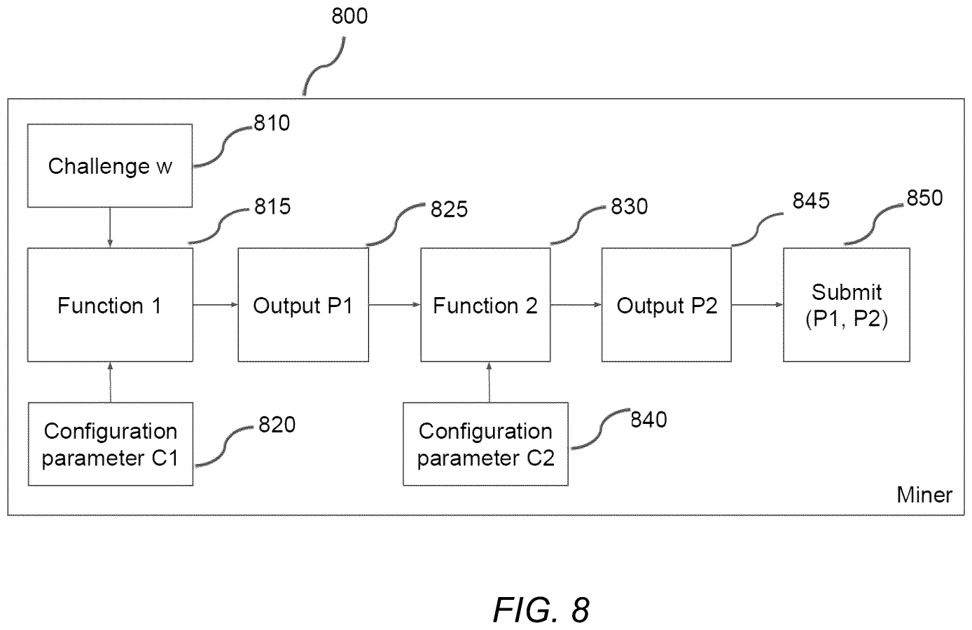

Dual proof configurations in accordance with a number of embodiments of the invention is illustrated in FIG. 8. A proof configuration in accordance with some embodiments of the invention may tend to use the notion of quality functions for tie-breaking among multiple competing correct proofs relative to a given challenge (w) 810. This classification of proof may be described as a qualitative proof, inclusive of proofs of work and proofs of space. In the example reflected in FIG. 8, proofs P1 and P2 are each one of a Proof of Work, Proof of Space, Proof of Stake, and/or any other proof related to a constrained resource, wherein P2 may be of a different type than P1, or may be of the same type.

Systems in accordance with many embodiments of the invention may introduce the notion of a qualifying proof, which, unlike qualitative proofs, are either valid or not valid, using no tie-breaking mechanism. Said systems may include a combination of one or more qualitative proofs and one or more qualifying proofs. For example, it may use one qualitative proof that is combined with one qualifying proof, where the qualifying proof is performed conditional on the successful creation of a qualitative proof. FIG. 8 illustrates challenge w 810, as described above, with a function 1 815, which is a qualitative function, and function 2 830, which is a qualifying function.

To stop miners from expending effort after a certain amount of effort has been spent, thereby reducing the environmental impact of mining, systems in accordance with a number of embodiments of the invention may constrain the search space for the mining effort. This may be done using a configuration parameter that controls the range of random or pseudo-random numbers that may be used in a proof. Upon challenge w 810 being issued to one or more miners 800, it may be input to Function 1 815 along with configuration parameter C1 820. Function 1 815 may output proof P1 825, in this example the qualifying proof to Function 2 830. Function 2 830 is also provided with configuration parameter C2 840 and computes qualifying proof P2 845. The miner 800 may then submit the combination of proofs (P1, P2) 850 to a verifier, in order to validate a ledger associated with challenge w 810. In some embodiments, miner 800 may also submit the proofs (P1, P2) 850 to be accessed by a 3rd-party verifier.

NFT platforms in accordance with many embodiments of the invention may additionally benefit from alternative energy-efficient consensus mechanisms. Therefore, computer systems in accordance with several embodiments of the invention may instead use consensus-based methods alongside or in place of proof-of-space and proof-of-space based mining. In particular, consensus mechanisms based instead on the existence of a Trusted Execution Environment (TEE), such as ARM TrustZone™ or Intel SGX™ may provide assurances exist of integrity by virtue of incorporating private/isolated processing environments.

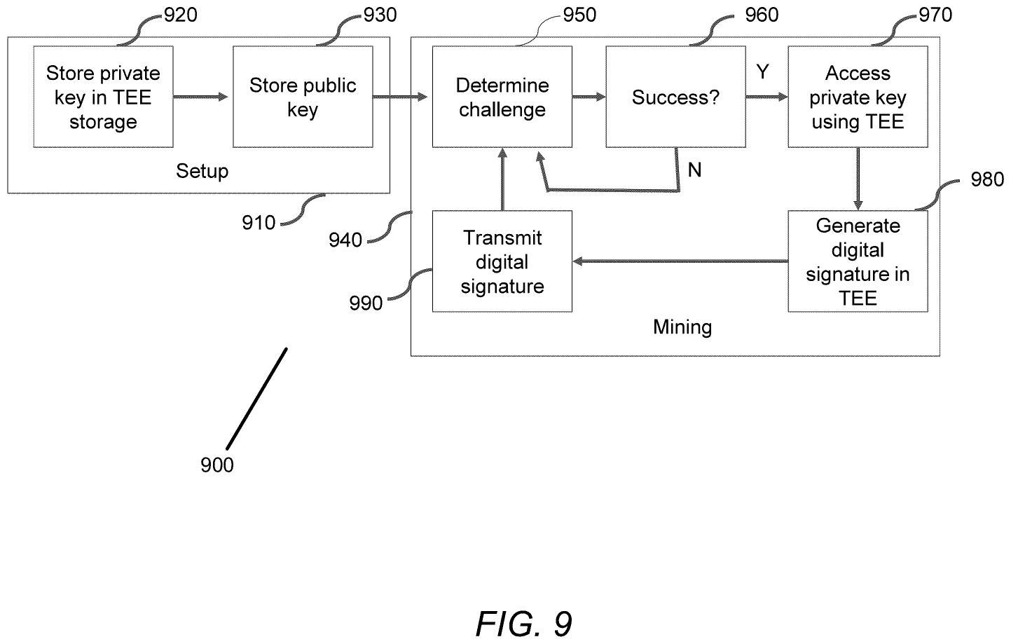

An illustration of sample process 900 undergone by TEE-based consensus mechanisms in accordance with some embodiments of the invention is depicted in FIG. 9. In some such configurations, a setup 910 may be performed by an original equipment manufacturer (OEM) or a party performing configurations of equipment provided by an OEM. Once a private key/public key pair is generated in the secure environment, process 900 may store (920) the private key in TEE storage (i.e. storage associated with the Trusted Execution Environment). While storage may be accessible from the TEE, it may be shielded from applications running outside the TEE. Additionally, processes may store (930) the public key associated with the TEE in any storage associated with the device containing the TEE. Unlike the private key, the public key may also be accessible from applications outside the TEE. In a number of embodiments, the public key may also be certified. Certification may come from OEMs or trusted entities associated with the OEMs, wherein the certificate may be stored with the public key.

In many embodiments of the invention, mining-directed steps may also be influenced by the TEE. In the illustrated embodiment, the process 900 may determine (950) a challenge. For example, this may be by computing a hash of the contents of a ledger. In doing so, process 900 may also determine whether the challenge corresponds to success 960. In some embodiments of the invention, the determination of success may result from some pre-set portion of the challenge matching a pre-set portion of the public key, e.g. the last 20 bits of the two values matching. In several embodiments the success determination mechanism may be selected from any of a number of alternate approaches appropriate to the requirements of specific applications. The matching conditions may also be modified over time. For example, modification may result from an announcement from a trusted party or based on a determination of a number of participants having reached a threshold value.

When the challenge does not correspond to a success 960, process 900 may return to determine (950) a new challenge. In this context, process 900 may determine (950) a new challenge after the ledger contents have been updated and/or a time-based observation is performed. In several embodiments the determination of a new challenge may come from any of a number of approaches appropriate to the requirements of specific applications, including, but not limited to, the observation of as a second elapsing since the last challenge. If the challenge corresponds to a success 960, then the processing may continue on to access (970) the private key using the TEE.

When the private key is accessed, process may generate (980) a digital signature using the TEE. The digital signature may be on a message that includes the challenge and/or which otherwise references the ledger entry being closed. Process 900 may also transmit (980) the digital signature to other participants implementing the consensus mechanism. In cases where multiple digital signatures are received and found to be valid, a tie-breaking mechanism may be used to evaluate the consensus. For example, one possible tie-breaking mechanism may be to select the winner as the party with the digital signature that represents the smallest numerical value when interpreted as a number. In several embodiments the tie-breaking mechanism may be selected from any of a number of alternate tie-breaking mechanisms appropriate to the requirements of specific applications.

Applications and methods in accordance with various embodiments of the invention are not limited to use within NFT platforms. Accordingly, it should be appreciated that consensus mechanisms described herein may also be implemented outside the context of an NFT platform network architecture unrelated to the storage of fungible tokens and/or NFTs. Moreover, any of the consensus mechanisms described herein with reference to FIGS. 6-9 (including Proof of Work, Proof of Space, Proof of Stake, and/or hybrid mechanisms) may be utilized within any of the blockchains implemented within the NFT platforms described above with reference to FIGS. 3-5B. Various systems and methods for implementing NFT platforms and applications in accordance with numerous embodiments of the invention are discussed further below.

### NFT Platform Constituent Devices and Applications

A variety of computer systems that may be utilized within NFT platforms and systems that utilize NFT blockchains in accordance with various embodiments of the invention are illustrated below. The computer systems in accordance with many embodiments of the invention may implement a processing system 1010, 1120, 1220 using one or more CPUs, GPUs, ASICs, FPGAs, and/or any of a variety of other devices and/or combinations of devices that are typically utilized to perform digital computations. As may readily be appreciated each of these computer systems may be implemented using one or more of any of a variety of classes of computing devices including (but not limited to) mobile phone handsets, tablet computers, laptop computers, personal computers, gaming consoles, televisions, set top boxes and/or other classes of computing device.

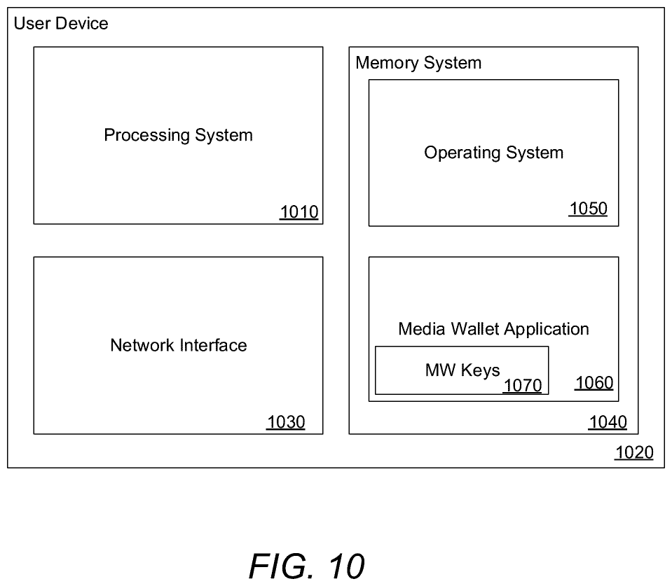

A user device capable of communicating with an NFT platform in accordance with an embodiment of the invention is illustrated in FIG. 10. The memory system 1040 of particular user devices may include an operating system 1050 and media wallet applications 1060. Media wallet applications may include sets of media wallet (MW) keys 1070 that may include public key/private key pairs. The set of MW keys may be used by the media wallet application to perform a variety of actions including, but not limited to, encrypting and signing data. In many embodiments, the media wallet application enables the user device to obtain and conduct transactions with respect to NFTs by communicating with an NFT blockchain via the network interface 1030. In some embodiments, the media wallet applications are capable of enabling the purchase of NFTs using fungible tokens via at least one distributed exchange. User devices may implement some or all of the various functions described above with reference to media wallet applications as appropriate to the requirements of a given application in accordance with various embodiments of the invention.

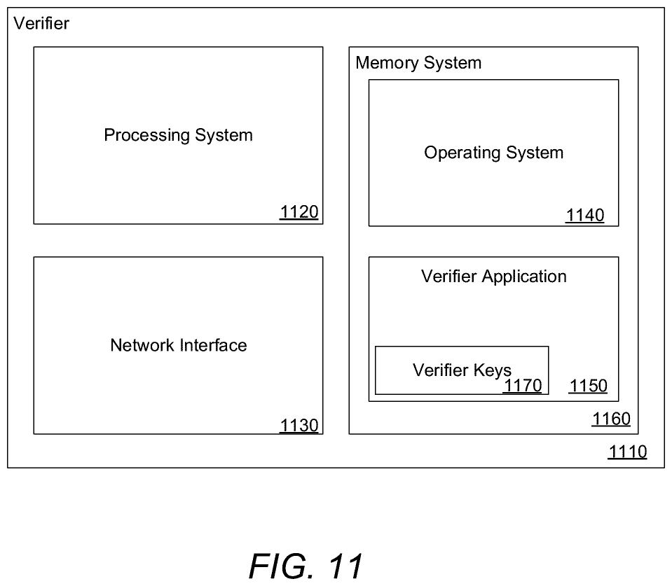

A verifier 1110 capable of verifying blockchain transactions in an NFT platform in accordance with many embodiments of the invention is illustrated in FIG. 11. The memory system 1160 of the verifier computer system includes an operating system 1140 and a verifier application 1150 that enables the verifier 1110 computer system to access a decentralized blockchain in accordance with various embodiments of the invention. Accordingly, the verifier application 1150 may utilize a set of verifier keys 1170 to affirm blockchain entries. When blockchain entries may be verified, the verifier application 1150 may transmit blocks to the corresponding blockchains. The verifier application 1150 may also implement some or all of the various functions described above with reference to verifiers as appropriate to the requirements of a given application in accordance with various embodiments of the invention.

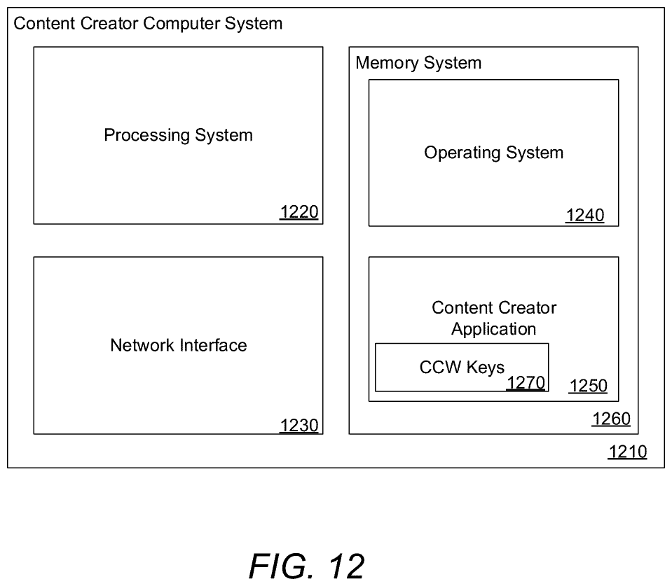

A content creator system 1210 capable of disseminating content in an NFT platform in accordance with an embodiment of the invention is illustrated in FIG. 12. The memory system 1260 of the content creator computer system may include an operating system 1240 and a content creator application 1250. The content creator application 1250 may enable the content creator computer system to mint NFTs by writing smart contracts to blockchains via the network interface 1230. The content creator application may include sets of content creator wallet (CCW) keys 1270 that may include a public key/private key pairs. Content creator applications may use these keys to sign NFTs minted by the content creator application. The content creator application may also implement some or all of the various functions described above with reference to content creators as appropriate to the requirements of a given application in accordance with various embodiments of the invention.

Computer systems in accordance with many embodiments of the invention incorporate digital wallets (herein also referred to as “wallets” or “media wallets”) for NFT and/or fungible token storage. In several embodiments, the digital wallet may securely store rich media NFTs and/or other tokens. Additionally, in some embodiments, the digital wallet may display user interface through which user instructions concerning data access permissions may be received.

In a number of embodiments of the invention, digital wallets may be used to store at least one type of token-directed content. Example content types may include, but are not limited to crypto currencies of one or more sorts; non-fungible tokens; and user profile data.

Example user profile data may incorporate logs of user actions. In accordance with some embodiments of the invention, example anonymized user profile data may include redacted, encrypted, and/or otherwise obfuscated user data. User profile data in accordance with some embodiments may include, but are not limited to, information related to classifications of interests, determinations of a post-advertisement purchases, and/or characterizations of wallet contents.

Media wallets, when storing content, may store direct references to content. Media wallets may also reference content through keys to decrypt and/or access the content. Media wallets may use such keys to additionally access metadata associated with the content. Example metadata may include, but is not limited to, classifications of content. In a number of embodiments, the classification metadata may govern access rights of other parties related to the content.

Access governance rights may include, but are not limited to, whether a party may indicate their relationship with the wallet; whether they may read summary data associated with the content; whether they have access to peruse the content; whether they may place bids to purchase the content; whether they may borrow the content, and/or whether they are biometrically authenticated.

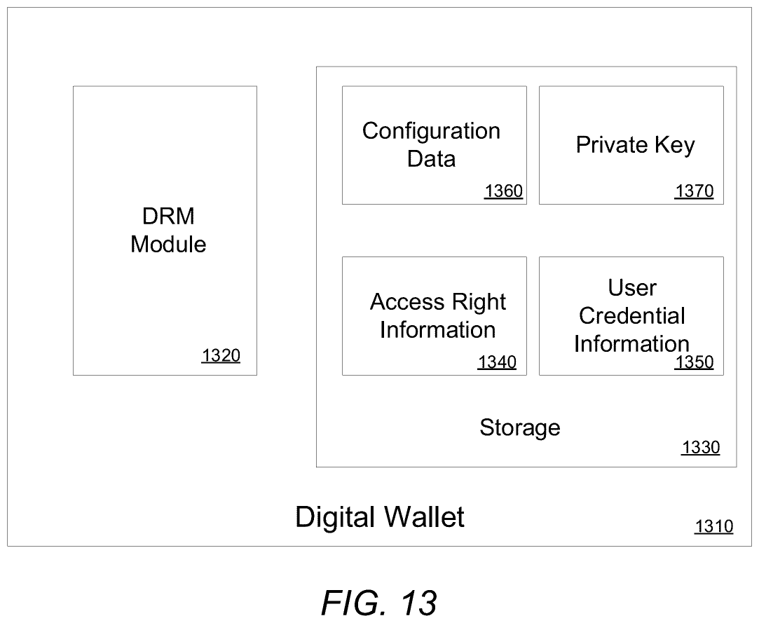

An example of a media wallet 1310 capable of storing rich media NFTs in accordance with an embodiment of the invention is illustrated in FIG. 13. Media wallets 1310 may include a storage component 1330, including access right information 1340, user credential information 1350, token configuration data 1360, and/or at least one private key 1370. In accordance with many embodiments of the invention, a private key 1370 may be used to perform a plurality of actions on resources, including but not limited to decrypting NFT and/or fungible token content. Media wallets may also correspond to a public key, referred to as a wallet address. An action performed by private keys 1370 may be used to prove access rights to digital rights management modules. Additionally, private keys 1370 may be applied to initiating ownership transfers and granting NFT and/or fungible token access to alternate wallets. In accordance with some embodiments, access right information 1340 may include lists of elements that the wallet 1310 has access to. Access right information 1340 may also express the type of access provided to the wallet. Sample types of access include, but are not limited to, the right to transfer NFT and/or fungible ownership, the right to play rich media associated with a given NFT, and the right to use an NFT and/or fungible token. Different rights may be governed by different cryptographic keys. Additionally, the access right information 1340 associated with a given wallet 1310 may utilize user credential information 1350 from the party providing access.

In accordance with many embodiments of the invention, third parties initiating actions corresponding to requesting access to a given NFT may require user credential information 1350 of the party providing access to be verified. User credential information 1350 may be taken from the group including, but not limited to, a digital signature, hashed passwords, PINs, and biometric credentials. User credential information 1350 may be stored in a manner accessible only to approved devices. In accordance with some embodiments of the invention, user credential information 1350 may be encrypted using a decryption key held by trusted hardware, such as a trusted execution environment. Upon verification, user credential information 1350 may be used to authenticate wallet access.

Available access rights may be determined by digital rights management (DRM) modules 1320 of wallets 1310. In the context of rich media, encryption may be used to secure content. As such, DRM systems may refer to technologies that control the distribution and use of keys required to decrypt and access content. DRM systems in accordance with many embodiments of the invention may require a trusted execution zone. Additionally, said systems may require one or more keys (typically a certificate containing a public key/private key pair) that may be used to communicate with and register with DRM servers. DRM modules 1320 in some embodiments may also use one or more keys to communicate with a DRM server. In several embodiments, the DRM modules 1320 may include code used for performing sensitive transactions for wallets including, but not limited to, content access. In accordance with a number of embodiments of the invention, the DRM module 1320 may execute in a Trusted Execution Environment. In a number of embodiments, the DRM may be facilitated by an Operating System (OS) that enables separation of processes and processing storage from other processes and their processing storage.

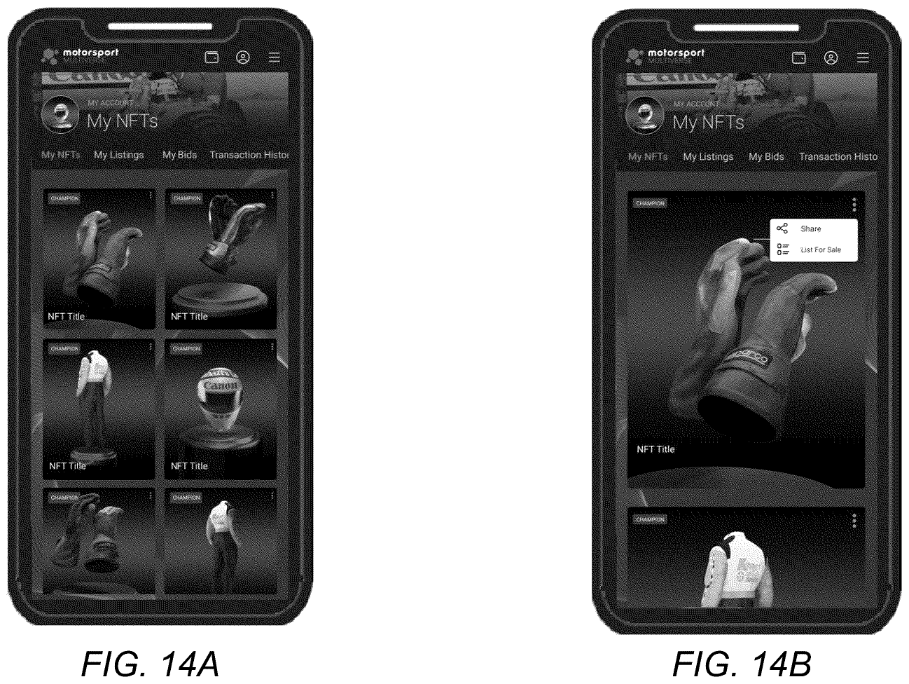

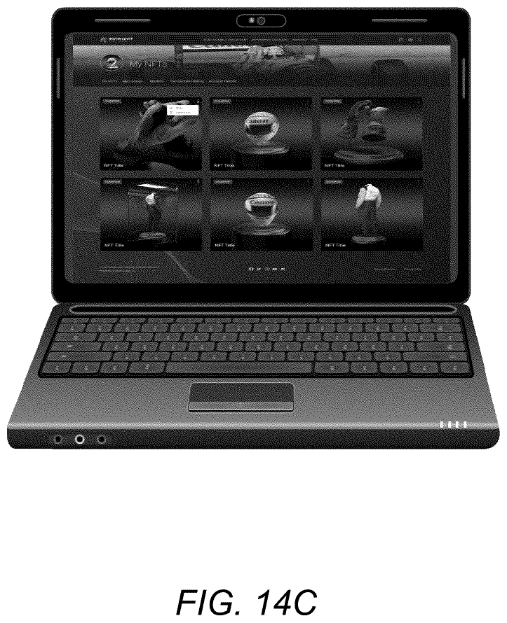

Operation of media wallet applications implemented in accordance with some embodiments of the invention is conceptually illustrated by way of the user interfaces shown in FIGS. 14A-14C. In many embodiments, media wallet applications may refer to applications that are installed upon user devices such as (but not limited to) mobile phones and tablet computers running the iOS, Android and/or similar operating systems. Launching media wallet applications may provide a number of user interface contexts. In many embodiments, transitions between these user interface contexts may be initiated in response to gestures including (but not limited to) swipe gestures received via a touch user interface. As may readily be appreciated, the specific manner in which user interfaces operate through media wallet applications is largely dependent upon the user input capabilities of the underlying user device. In several embodiments, a first user interface context is a dashboard (see, FIGS. 14A, 14C) that may include a gallery view of NFTs owned by the user. In several embodiments, the NFT listings may be organized into category index cards. Category index cards may include, but are not limited to digital merchandise/collectibles, special event access/digital tickets, fan leaderboards. In certain embodiments, a second user interface context (see, for example, FIG. 14B) may display individual NFTs. In a number of embodiments, each NFT may be main-staged in said display with its status and relevant information shown. Users may swipe through each collectible and interacting with the user interface may launch a collectible user interface enabling greater interaction with a particular collectible in a manner that may be determined based upon the smart contract underlying the NFT.

A participant of an NFT platform may use a digital wallet to classify wallet content, including NFTs, fungible tokens, content that is not expressed as tokens such as content that has not yet been minted but for which the wallet may initiate minting, and other non-token content, including executable content, webpages, configuration data, history files and logs. This classification may be performed using a visual user interface. Users interface may enable users to create a visual partition of a space. In some embodiments of the invention, a visual partition may in turn be partitioned into sub-partitions. In some embodiments, a partition of content may separate wallet content into content that is not visible to the outside world (“invisible partition”), and content that is visible at least to some extent by the outside world (“visible partition”). Some of the wallet content may require the wallet use to have an access code such as a password or a biometric credential to access, view the existence of, or perform transactions on. A visible partition may be subdivided into two or more partitions, where the first one corresponds to content that may be seen by anybody, the second partition corresponds to content that may be seen by members of a first group, and/or the third partition corresponds to content that may be seen by members of a second group.

For example, the first group may be users with which the user has created a bond, and invited to be able to see content. The second group may be users who have a membership and/or ownership that may not be controlled by the user. An example membership may be users who own non-fungible tokens (NFTs) from a particular content creator. Content elements, through icons representing the elements, may be relocated into various partitions of the space representing the user wallet. By doing so, content elements may be associated with access rights governed by rules and policies of the given partition.

One additional type of visibility may be partial visibility. Partial visibility may correspond to a capability to access metadata associated with an item, such as an NFT and/or a quantity of crypto funds, but not carry the capacity to read the content, lend it out, or transfer ownership of it. As applied to a video NFT, an observer to a partition with partial visibility may not be able to render the video being encoded in the NFT but see a still image of it and a description indicating its source.

Similarly, a party may have access to a first anonymized profile which states that the user associated with the wallet is associated with a given demographic. The party with this access may also be able to determine that a second anonymized profile including additional data is available for purchase. This second anonymized profile may be kept in a sub-partition to which only people who pay a fee have access, thereby expressing a form of membership. Alternatively, only users that have agreed to share usage logs, aspects of usage logs or parts thereof may be allowed to access a given sub-partition. By agreeing to share usage log information with the wallet comprising the sub-partition, this wallet learns of the profiles of users accessing various forms of content, allowing the wallet to customize content, including by incorporating advertisements, and to determine what content to acquire to attract users of certain demographics.

Another type of membership may be held by advertisers who have sent promotional content to the user. These advertisers may be allowed to access a partition that stores advertisement data. Such advertisement data may be encoded in the form of anonymized profiles. In a number of embodiments, a given sub-partition may be accessible only to the advertiser to whom the advertisement data pertains. Elements describing advertisement data may be automatically placed in their associated partitions, after permission has been given by the user. This partition may either be visible to the user. Visibility may also depend on a direct request to see “system partitions.” A first partition may correspond to material associated with a first set of public keys, a second partition to material associated with a second set of public keys not overlapping with the first set of public keys, wherein such material may comprise tokens such as crypto coins and NFTs. A third partition may correspond to usage data associated with the wallet user, and a fourth partition may correspond to demographic data and/or preference data associated with the wallet user. Yet other partitions may correspond to classifications of content, e.g., child-friendly vs. adult; classifications of whether associated items are for sale or not, etc.

The placing of content in a given partition may be performed by a drag-and-drop action performed on a visual interface. By selecting items and clusters and performing a drag-and-drop to another partition and/or to a sub-partition, the visual interface may allow movement including, but not limited to, one item, a cluster of items, and a multiplicity of items and clusters of items. The selection of items may be performed using a lasso approach in which items and partitions are circled as they are displayed. The selection of items may also be performed by alternative methods for selecting multiple items in a visual interface, as will be appreciated by a person of skill in the art.

Some content classifications may be automated in part or full. For example, when user place ten artifacts, such as NFTs describing in-game capabilities, in a particular partition, they may be asked if additional content that are also in-game capabilities should be automatically placed in the same partition as they are acquired and associated with the wallet. When “yes” is selected, then this placement may be automated in the future. When “yes, but confirm for each NFT” is selected, then users may be asked, for each automatically classified element, to confirm its placement. Before the user confirms, the element may remain in a queue that corresponds to not being visible to the outside world. When users decline given classifications, they may be asked whether alternative classifications should be automatically performed for such elements onwards. In some embodiments, the selection of alternative classifications may be based on manual user classification taking place subsequent to the refusal.

Automatic classification of elements may be used to perform associations with partitions and/or folders. The automatic classification may be based on machine learning (ML) techniques considering characteristics including, but not limited to, usage behaviors exhibited by the user relative to the content to be classified, labels associated with the content, usage statistics; and/or manual user classifications of related content.

Multiple views of wallets may also be accessible. One such view may correspond to the classifications described above, which indicates the actions and interactions others may perform relative to elements. Another view may correspond to a classification of content based on use, type, and/or users-specified criterion. For example, all game NFTs may be displayed in one collection view. The collection view may further subdivide the game NFTs into associations with different games or collections of games. Another collection may show all audio content, clustered based on genre. users-specified classification may be whether the content is for purposes of personal use, investment, or both. A content element may show up in multiple views. users may search the contents of his or her wallet by using search terms that result in potential matches.

Alternatively, the collection of content may be navigated based the described views of particular wallets, allowing access to content. Once a content element has been located, the content may be interacted with. For example, located content elements may be rendered. One view may be switched to another after a specific item is found. For example, this may occur through locating an item based on its genre and after the item is found, switching to the partitioned view described above. In some embodiments, wallet content may be rendered using two or more views in a simultaneous manner. They may also select items using one view.

Media wallet applications in accordance with various embodiments of the invention are not limited to use within NFT platforms. Accordingly, it should be appreciated that applications described herein may also be implemented outside the context of an NFT platform network architecture unrelated to the storage of fungible tokens and/or NFTs. Moreover, any of the computer systems described herein with reference to FIGS. 10-14C may be utilized within any of the NFT platforms described above.

### NFT Platform NFT Interactions

NFT platforms in accordance with many embodiments of the invention may incorporate a wide variety of rich media NFT configurations. The term “Rich Media Non-Fungible Tokens” may be used to refer to blockchain-based cryptographic tokens created with respect to a specific piece of rich media content and which incorporate programmatically defined digital rights management. In some embodiments of the invention, each NFT may have a unique serial number and be associated with a smart contract defining an interface that enables the NFT to be managed, owned and/or traded.

Under a rich media blockchain in accordance with many embodiments of the invention, a wide variety of NFT configurations may be implemented. Some NFTs may be referred to as anchored NFTs (or anchored tokens), used to tie some element, such as a physical entity, to an identifier. Of this classification, one sub-category may be used to tie users' real-world identities and/or identifiers to a system identifier, such as a public key. In this disclosure, this type of NFT applied to identifying users, may be called a social NFT, identity NFT, identity token, and a social token. In accordance with many embodiments of the invention, an individual's personally identifiable characteristics may be contained, maintained, and managed throughout their lifetime so as to connect new information and/or NFTs to the individual's identity. A social NFT's information may include, but are not limited to, personally identifiable characteristics such as name, place and date of birth, and/or biometrics.

An example social NFT may assign a DNA print to a newborn's identity. In accordance with a number of embodiments of the invention, this first social NFT might then be used in the assignment process of a social security number NFT from the federal government. In some embodiments, the first social NFT may then be associated with some rights and capabilities, which may be expressed in other NFTs. Additional rights and capabilities may also be directly encoded in a policy of the social security number NFT.

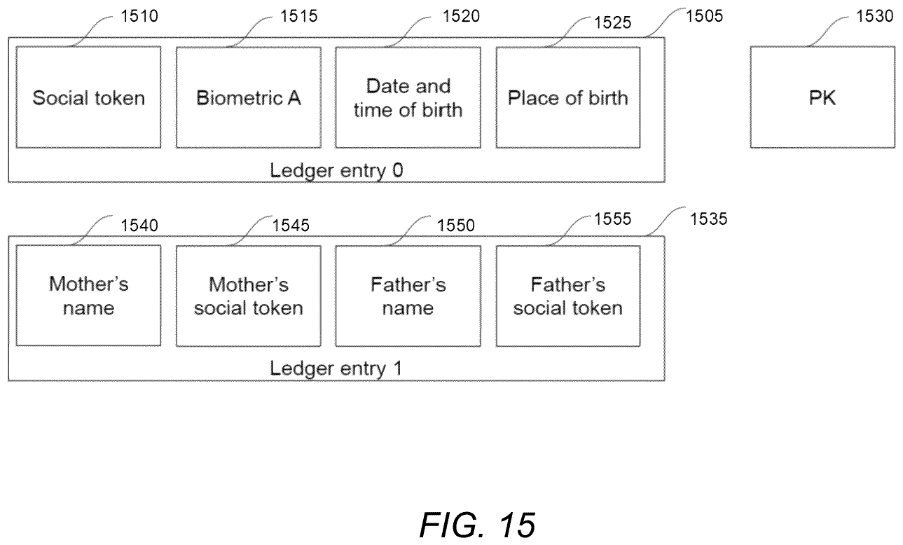

A social NFT may exist on a personalized branch of a centralized and/or decentralized blockchain. Ledger entries related to an individual's social NFT in accordance with several embodiments of the invention are depicted in FIG. 15. Ledger entries of this type may be used to build an immutable identity foundation whereby biometrics, birth and parental information are associated with an NFT. As such, this information may also be protected with encryption using a private key 1530. The initial entry in a ledger, “ledger entry 0” 1505, may represent a social token 1510 assignment to an individual with a biometric “A” 1515. In this embodiment, the biometric may include but is not limited to a footprint, a DNA print, and a fingerprint. The greater record may also include the individual's date and time of birth 1520 and place of birth 1525. A subsequent ledger entry 1 1535 may append parental information including but not limited to mothers' name 1540, mother's social token 1545, father's name 1550, and father's social token 1555.

In a number of embodiments, the various components that make up a social NFT may vary from situation to situation. In a number of embodiments, biometrics and/or parental information may be unavailable in a given situation and/or period of time. Other information including, but not limited to, race, gender, and governmental number assignments such as social security numbers, may be desirable to include in the ledger. In a blockchain, future NFT creation may create a life-long ledger record of an individual's public and private activities. In accordance with some embodiments, the record may be associated with information including, but not limited to, identity, purchases, health and medical records, access NFTs, family records such as future offspring, marriages, familial history, photographs, videos, tax filings, and/or patent filings. The management and/or maintenance of an individual's biometrics throughout the individual's life may be immutably connected to the first social NFT given the use of a decentralized blockchain ledger.

In some embodiments, a certifying third party may generate an NFT associated with certain rights upon the occurrence of a specific event. In one such embodiment, the DMV may be the certifying party and generate an NFT associated with the right to drive a car upon issuing a traditional driver's license. In another embodiment, the certifying third party may be a bank that verifies a person's identity papers and generates an NFT in response to a successful verification. In a third embodiment, the certifying party may be a car manufacturer, who generates an NFT and associates it with the purchase and/or lease of a car.

In many embodiments, a rule may specify what types of policies the certifying party may associate with the NFT. Additionally, a non-certified entity may also generate an NFT and assert its validity. This may require putting up some form of security. In one example, security may come in the form of a conditional payment associated with the NFT generated by the non-certified entity. In this case, the conditional payment may be exchangeable for funds if abuse may be detected by a bounty hunter and/or some alternate entity. Non-certified entities may also relate to a publicly accessible reputation record describing the non-certified entity's reputability.

Anchored NFTs may additionally be applied to automatic enforcement of programming rules in resource transfers. NFTs of this type may be referred to as promise NFTs. A promise NFT may include an agreement expressed in a machine-readable form and/or in a human-accessible form. In a number of embodiments, the machine-readable and human-readable elements may be generated one from the other. In some embodiments, an agreement in a machine-readable form may include, but is not limited to, a policy and/or an executable script. In some embodiments, an agreement in a human-readable form may include, but is not limited to, a text and/or voice-based statement of the promise.

In some embodiments, regardless of whether the machine-readable and human-readable elements are generated from each other, one may be verified based on the other. Smart contracts including both machine-readable statements and human-accessible statements may also be used outside the implementation of promise NFTs. Moreover, promise NFTs may be used outside actions taken by individual NFTs and/or NFT-owners. In some embodiments, promise NFTs may relate to general conditions, and may be used as part of a marketplace.

In one such example, horse betting may be performed through generating a first promise NFT that offers a payment of $10 if a horse does not win. Payment may occur under the condition that the first promise NFT is matched with a second promise NFT that causes a transfer of funds to a public key specified with the first promise NFT if horse X wins.

A promise NFT may be associated with actions that cause the execution of a policy and/or rule indicated by the promise NFT. In some embodiments of the invention, a promise of paying a charity may be associated with the sharing of an NFT. In this embodiment, the associated promise NFT may identify a situation that satisfies the rule associated with the promise NFT, thereby causing the transfer of funds when the condition is satisfied (as described above). One method of implementation may be embedding in and/or associating a conditional payment with the promise NFT. A conditional payment NFT may induce a contract causing the transfer of funds by performing a match. In some such methods, the match may be between the promise NFT and inputs that identify that the conditions are satisfied, where said input may take the form of another NFT. In a number of embodiments, one or more NFTs may also relate to investment opportunities.

For example, a first NFT may represent a deed to a first building, and a second NFT a deed to a second building. Moreover, the deed represented by the first NFT may indicate that a first party owns the first property. The deed represented by the second NFT may indicate that a second party owns the second property. A third NFT may represent one or more valuations of the first building. The third NFT may in turn be associated with a fourth NFT that may represent credentials of a party performing such a valuation. A fifth NFT may represent one or more valuations of the second building. A sixth may represent the credentials of one of the parties performing a valuation. The fourth and sixth NFTs may be associated with one or more insurance policies, asserting that if the parties performing the valuation are mistaken beyond a specified error tolerance, then the insurer would pay up to a specified amount.

A seventh NFT may then represent a contract that relates to the planned acquisition of the second building by the first party, from the second party, at a specified price. The seventh NFT may make the contract conditional provided a sufficient investment and/or verification by a third party. A third party may evaluate the contract of the seventh NFT, and determine whether the terms are reasonable. After the evaluation, the third party may then verify the other NFTs to ensure that the terms stated in the contract of the seventh NFT agree. If the third party determines that the contract exceeds a threshold in terms of value to risk, as assessed in the seventh NFT, then executable elements of the seventh NFT may cause transfers of funds to an escrow party specified in the contract of the sixth NFT.

Alternatively, the first party may initiate the commitment of funds, conditional on the remaining funds being raised within a specified time interval. The commitment of funds may occur through posting the commitment to a ledger. Committing funds may produce smart contracts that are conditional on other events, namely the payments needed to complete the real estate transaction. The smart contract also may have one or more additional conditions associated with it. For example, an additional condition may be the reversal of the payment if, after a specified amount of time, the other funds have not been raised. Another condition may be related to the satisfactory completion of an inspection and/or additional valuation.

NFTs may also be used to assert ownership of virtual property. Virtual property in this instance may include, but is not limited to, rights associated with an NFT, rights associated with patents, and rights associated with pending patents. In a number of embodiments, the entities involved in property ownership may be engaged in fractional ownership. In some such embodiments, two parties may wish to purchase an expensive work of digital artwork represented by an NFT. The parties may enter into smart contracts to fund and purchase valuable works. After a purchase, an additional NFT may represent each party's contribution to the purchase and equivalent fractional share of ownership.

Another type of NFTs that may relate to anchored NFTs may be called “relative NFTs.” This may refer to NFTs that relate two or more NFTs to each other. Relative NFTs associated with social NFTs may include digital signatures that is verified using a public key of a specific social NFT. In some embodiments, an example of a relative NFT may be an assertion of presence in a specific location, by a person corresponding to the social NFT. This type of relative NFT may also be referred to as a location NFT and a presence NFT. Conversely, a signature verified using a public key embedded in a location NFT may be used as proof that an entity sensed by the location NFT is present. Relative NFTs are derived from other NFTs, namely those they relate to, and therefore may also be referred to as derived NFTs. An anchored NFT may tie to another NFT, which may make it both anchored and relative. An example of such may be called pseudonym NFTs.

Pseudonym NFTs may be a kind of relative NFT acting as a pseudonym identifier associated with a given social NFT. In some embodiments, pseudonym NFTs may, after a limited time and/or a limited number of transactions, be replaced by a newly derived NFTs expressing new pseudonym identifiers. This may disassociate users from a series of recorded events, each one of which may be associated with different pseudonym identifiers. A pseudonym NFT may include an identifier that is accessible to biometric verification NFTs. Biometric verification NFTs may be associated with a TEE and/or DRM which is associated with one or more biometric sensors. Pseudonym NFTs may be output by social NFTs and/or pseudonym NFTs.

Inheritance NFTs may be another form of relative NFTs, that transfers rights associated with a first NFT to a second NFT. For example, computers, represented by an anchored NFT that is related to a physical entity (the hardware), may have access rights to WiFi networks. When computers are replaced with newer models, users may want to maintain all old relationships, for the new computer. For example, users may want to retain WiFi hotspots. For this to be facilitated, a new computer may be represented by an inheritance NFT, inheriting rights from the anchored NFT related to the old computer. An inheritance NFT may acquire some or all pre-existing rights associated with the NFT of the old computer, and associate those with the NFT associated with the new computer.

More generally, multiple inheritance NFTs may be used to selectively transfer rights associated with one NFT to one or more NFTs, where such NFTs may correspond to users, devices, and/or other entities, when such assignments of rights are applicable. Inheritance NFTs may also be used to transfer property. One way to implement the transfer of property may be to create digital signatures using private keys. These private keys may be associated with NFTs associated with the rights. In accordance with a number of embodiments, transfer information may include the assignment of included rights, under what conditions the transfer may happen, and to what NFT(s) the transfer may happen. In this transfer, the assigned NFTs may be represented by identifies unique to these, such as public keys. The digital signature and message may then be in the form of an inheritance NFT, or part of an inheritance NFT. As rights are assigned, they may be transferred away from previous owners to new owners through respective NFTs. Access to financial resources is one such example.

However, sometimes rights may be assigned to new parties without taking the same rights away from the party (i.e., NFT) from which the rights come. One example of this may be the right to listen to a song, when a license to the song is sold by the artist to consumers. However, if the seller sells exclusive rights, this causes the seller not to have the rights anymore.

In accordance with many embodiments of the invention, multiple alternative NFT configurations may be implemented. One classification of NFT may be an employee NFT or employee token. Employee NFTs may be used by entities including, but not limited to, business employees, students, and organization members. Employee NFTs may operate in a manner analogous to key card photo identifications. In a number of embodiments, employee NFTs may reference information including, but not limited to, company information, employee identity information and/or individual identity NFTs.

Additionally, employee NFTs may include associated access NFT information including but not limited to, what portions of a building employees may access, and what computer system employees may utilize. In several embodiments, employee NFTs may incorporate their owner's biometrics, such as a face image. In a number of embodiments, employee NFTs may operate as a form of promise NFT. In some embodiments, employee NFT may comprise policies or rules of employing organization. In a number of embodiments, the employee NFT may reference a collection of other NFTs.

Another type of NFT may be referred to as the promotional NFT or promotional token. Promotional NFTs may be used to provide verification that promoters provide promotion winners with promised goods. In some embodiments, promotional NFTs may operate through decentralized applications for which access restricted to those using an identity NFT. The use of a smart contract with a promotional NFT may be used to allow for a verifiable release of winnings. These winnings may include, but are not limited to, cryptocurrency, money, and gift card NFTs useful to purchase specified goods. Smart contracts used alongside promotional NFTs may be constructed for winners selected through random number generation.

Another type of NFT may be called the script NFT or script token. Script tokens may incorporate script elements including, but not limited to, story scripts, plotlines, scene details, image elements, avatar models, sound profiles, and voice data for avatars. Script tokens may also utilize rules and policies that describe how script elements are combined. Script tokens may also include rightsholder information, including but not limited to, licensing and copyright information. Executable elements of script tokens may include instructions for how to process inputs; how to configure other elements associated with the script tokens; and how to process information from other tokens used in combination with script tokens.

Script tokens may be applied to generate presentations of information. In accordance with some embodiments, these presentations may be developed on devices including but not limited to traditional computers, mobile computers, and virtual reality display devices. Script tokens may be used to provide the content for game avatars, digital assistant avatars, and/or instructor avatars. Script tokens may comprise audio-visual information describing how input text is presented, along with the input text that provides the material to be presented. It may also comprise what may be thought of as the personality of the avatar, including how the avatar may react to various types of input from an associated user.

In some embodiments, script NFTs may be applied to govern behavior within an organization. For example, this may be done through digital signatures asserting the provenance of the scripts. Script NFTs may also, in full and/or in part, be generated by freelancers. For example, a text script related to a movie, an interactive experience, a tutorial, and/or other material, may be created by an individual content creator. This information may then be combined with a voice model or avatar model created by an established content producer. The information may then be combined with a background created by additional parties. Various content producers may generate parts of the content, allowing for large-scale content collaboration.

Features of other NFTs may be incorporated in a new NFT using techniques related to inheritance NFTs, and/or by making references to other NFTs. As script NFTs may consist of multiple elements, creators with special skills related to one particular element may generate and combine elements. This may be used to democratize not only the writing of storylines for content, but also outsourcing for content production. For each such element, an identifier establishing the origin or provenance of the element may be included. Policy elements may also be incorporated that identify the conditions under which a given script element may be used. Conditions may be related to, but are not limited to execution environments, trusts, licenses, logging, financial terms for use, and various requirements for the script NFTs. Requirements may concern, but are not limited to, what other types of elements the given element are compatible with, what is allowed to be combined with according the terms of service, and/or local copyright laws that must be obeyed.

Evaluation units may be used with various NFT classifications to collect information on their use. Evaluation units may take a graph representing subsets of existing NFTs and make inferences from the observed graph component. From this, valuable insights into NFT value may be derived. For example, evaluation units may be used to identify NFTs whose popularity is increasing or waning. In that context, popularity may be expressed as, but not limited to, the number of derivations of the NFT that are made; the number of renderings, executions or other uses are made; and the total revenue that is generated to one or more parties based on renderings, executions or other uses.

Evaluation units may make their determination through specific windows of time and/or specific collections of end-users associated with the consumption of NFT data in the NFTs. Evaluation units may limit assessments to specific NFTs (e.g. script NFTs). This may be applied to identify NFTs that are likely to be of interest to various users. In addition, the system may use rule-based approaches to identify NFTs of importance, wherein importance may be ascribed to, but is not limited to, the origination of the NFTs, the use of the NFTs, the velocity of content creation of identified clusters or classes, the actions taken by consumers of NFT, including reuse of NFTs, the lack of reuse of NFTs, and the increased or decreased use of NFTs in selected social networks.

Evaluations may be repurposed through recommendation mechanisms for individual content consumers and/or as content originators. Another example may address the identification of potential combination opportunities, by allowing ranking based on compatibility. Accordingly, content creators such as artists, musicians and programmers may identify how to make their content more desirable to intended target groups.

The generation of evaluations may be supported by methods including, but not limited to machine learning (ML) methods, artificial intelligence (AI) methods, and/or statistical methods. Anomaly detection methods developed to identify fraud may be repurposed to identify outliers. This may be done to flag abuse risks or to improve the evaluation effort.

Multiple competing evaluation units may make competing predictions using alternative and proprietary algorithms. Thus, different evaluation units may be created to identify different types of events to different types of subscribers, monetizing their insights related to the data they access.

In a number of embodiments, evaluation units may be a form of NFTs that derive insights from massive amounts of input data. Input data may correspond, but is not limited to the graph component being analyzed. Such NFTs may be referred to as evaluation unit NFTs.

The minting of NFTs may associate rights with first owners and/or with an optional one or more policies and protection modes. An example policy and/or protection mode directed to financial information may express royalty requirements. An example policy and/or protection mode directed to non-financial requirements may express restrictions on access and/or reproduction. An example policy directed to data collection may express listings of user information that may be collected and disseminated to other participants of the NFT platform.

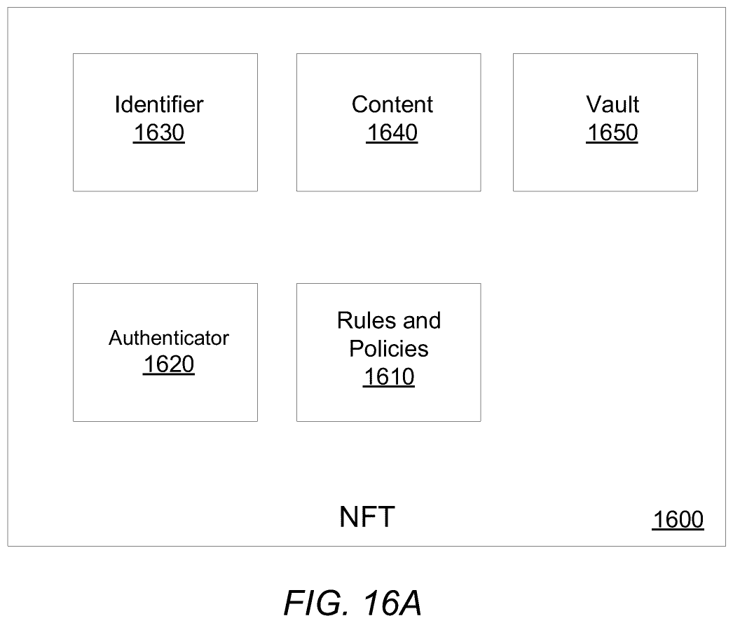

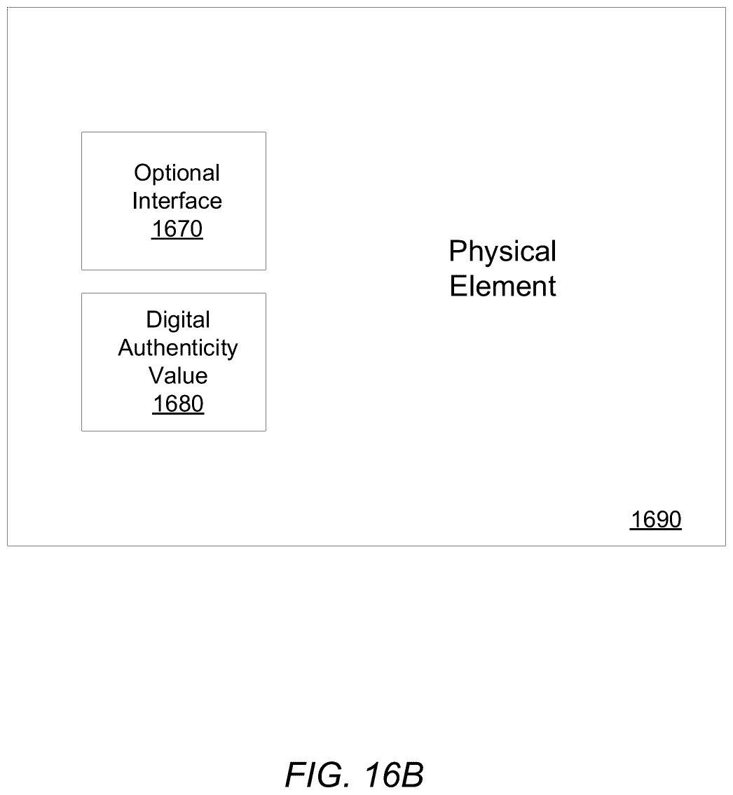

An example NFT which may be associated with specific content in accordance with several embodiments of the invention is illustrated in FIG. 16A. In some embodiments, an NFT 1600 may utilize a vault 1650, which may control access to external data storage areas. Methods of controlling access may include, but are not limited to, user credential information 1350. In accordance with a number of embodiments of the invention, control access may be managed through encrypting content 1640. As such, NFTs 1600 may incorporate content 1640, which may be encrypted, not encrypted, yet otherwise accessible, or encrypted in part. In accordance with some embodiments, an NFT 1600 may be associated with one or more content 1640 elements, which may be contained in or referenced by the NFT. A content 1640 element may include, but is not limited to, an image, an audio file, a script, a biometric user identifier, and/or data derived from an alternative source. An example alternative source may be a hash of biometric information). An NFT 1600 may also include an authenticator 1620 capable of affirming that specific NFTs are valid.

In accordance with many embodiments of the invention, NFTs may include a number of rules and policies 1610. Rules and policies 1610 may include, but are not limited to access rights information 1340. In some embodiments, rules and policies 1610 may also state terms of usage, royalty requirements, and/or transfer restrictions. An NFT 1600 may also include an identifier 1630 to affirm ownership status. In accordance with many embodiments of the invention, ownership status may be expressed by linking the identifier 1630 to an address associated with a blockchain entry.

In accordance with a number of embodiments of the invention, NFTs may represent static creative content. NFTs may also be representative of dynamic creative content, which changes over time. In accordance with many examples of the invention, the content associated with an NFT may be a digital content element.

One example of a digital content element in accordance with some embodiments may be a set of five images of a mouse. In this example, the first image may be an image of the mouse being alive. The second may be an image of the mouse eating poison. The third may be an image of the mouse not feeling well. The fourth image may be of the mouse, dead. The fifth image may be of a decaying mouse.

The user credential information 1350 of an NFT may associate each image to an identity, such as of the artist. In accordance with a number of embodiments of the invention, NFT digital content may correspond to transitions from one representation (e.g., an image of the mouse, being alive) to another representation (e.g., of the mouse eating poison). In this disclosure, digital content transitioning from one representation to another may be referred to as a state change and/or an evolution. In a number of embodiments, an evolution may be triggered by the artist, by an event associated with the owner of the artwork, randomly, and/or by an external event.

When NFTs representing digital content are acquired in accordance with some embodiments of the invention, they may also be associated with the transfer of corresponding physical artwork, and/or the rights to said artwork. The first ownership records for NFTs may correspond to when the NFT was minted, at which time its ownership may be assigned to the content creator. Additionally, in the case of “lazy” minting, rights may be directly assigned to a buyer.

In some embodiments, as a piece of digital content evolves, it may also change its representation. The change in NFTs may also send a signal to an owner after it has evolved. In doing so, a signal may indicate that the owner has the right to acquire the physical content corresponding to the new state of the digital content. Under an earlier example, buying a live mouse artwork, as an NFT, may also carry the corresponding painting, and/or the rights to it. A physical embodiment of an artwork that corresponds to that same NFT may also be able to replace the physical artwork when the digital content of the NFT evolves. For example, should the live mouse artwork NFT change states to a decaying mouse, an exchange may be performed of the corresponding painting for a painting of a decaying mouse.

The validity of one of the elements, such as the physical element, may be governed by conditions related to an item with which it is associated. For example, a physical painting may have a digital authenticity value that attests to the identity of the content creator associated with the physical painting.

An example of a physical element 1690 corresponding to an NFT, in accordance with some embodiments of the invention is illustrated in FIG. 16B. A physical element 1690 may be a physical artwork including, but not limited to, a drawing, a statue, and/or another physical representation of art. In a number of embodiments, physical representations of the content (which may correspond to a series of paintings) may each be embedded with a digital authenticity value (or a validator value) value. In accordance with many embodiments of the invention, a digital authenticity value (DAV) 1680 may be therefore be associated with a physical element 1690 and a digital element. A digital authenticity value may be a value that includes an identifier and a digital signature on the identifier. In some embodiments the identifier may specify information related to the creation of the content. This information may include the name of the artist, the identifier 1630 of the digital element corresponding to the physical content, a serial number, information such as when it was created, and/or a reference to a database in which sales data for the content is maintained. A digital signature element affirming the physical element may be made by the content creator and/or by an authority associating the content with the content creator.

In some embodiments, the digital authenticity value 1680 of the physical element 1690 may be expressed using a visible representation. The visible representation may be an optional physical interface 1670 taken from a group including, but not limited to, a barcode and a quick response (QR) code encoding the digital authenticity value. In some embodiments, the encoded value may also be represented in an authenticity database. Moreover, the physical interface 1670 may be physically associated with the physical element. One example of such may be a QR tag being glued to or printed on the back of a canvas. In some embodiments of the invention, the physical interface 1670 may be possible to physically disassociate from the physical item it is attached to. However, if a DAV 1680 is used to express authenticity of two or more physical items, the authenticity database may detect and block a new entry during the registration of the second of the two physical items. For example, if a very believable forgery is made of a painting the forged painting may not be considered authentic without the QR code associated with the digital element.

In a number of embodiments, the verification of the validity of a physical item, such as a piece of artwork, may be determined by scanning the DAV. In some embodiments, scanning the DAV may be used to determine whether ownership has already been assigned. Using techniques like this, each physical item may be associated with a control that prevents forgeries to be registered as legitimate, and therefore, makes them not valid. In the context of a content creator receiving a physical element from an owner, the content creator may deregister the physical element 1690 by causing its representation to be erased from the authenticity database used to track ownership. Alternatively, in the case of an immutable blockchain record, the ownership blockchain may be appended with new information. Additionally, in instances where the owner returns a physical element, such as a painting, to a content creator in order for the content creator to replace it with an “evolved” version, the owner may be required to transfer the ownership of the initial physical element to the content creator, and/or place the physical element in a stage of being evolved.

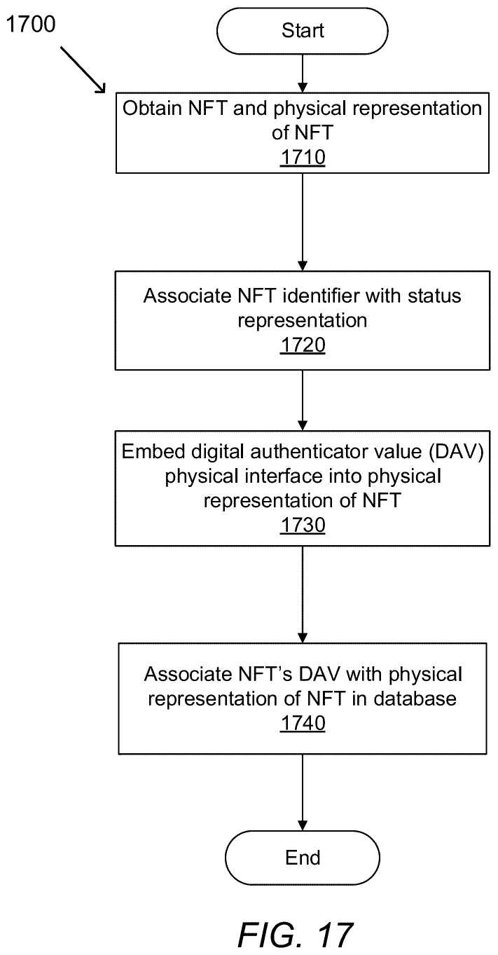

An example of a process for connecting an NFT digital element to physical content in accordance with some embodiments of the invention is illustrated in FIG. 17. Process 1700 may obtain (1710) an NFT and a physical representation of the NFT in connection with an NFT transaction. Under the earlier example, this may be a painting of a living mouse and an NFT of a living mouse. By virtue of establishing ownership of the NFT, the process 1700 may associate (1720) an NFT identifier with a status representation of the NFT. The NFT identifier may specify attributes including, but not limited to, the creator of the mouse painting and NFT (“Artist”), the blockchain the NFT is on (“NFT-Chain”), and an identifying value for the digital element (“no. 0001”). Meanwhile, the status representation may clarify the present state of the NFT (“alive mouse”). Process 1700 may also embed (1730) a DAV physical interface into the physical representation of the NFT. In a number of embodiments of the invention, this may be done by implanting a QR code into the back of the mouse painting. In affirming the connection between the NFT and painting, Process 1700 may associate (1740) the NFT's DAV with the physical representation of the NFT in a database. In some embodiments, the association may be performed through making note of the transaction and clarifying that it encapsulates both the mouse painting and the mouse NFT.

While specific processes are described above with reference to FIGS. 15-17, NFTs may be implemented in any of a number of different ways to enable as appropriate to the requirements of specific applications in accordance with various embodiments of the invention. Additionally, the specific manner in which NFTs may be utilized within NFT platforms in accordance with various embodiments of the invention is largely dependent upon the requirements of a given application.

### NFT Smart Contracts—Token Ownership Applications

Systems and methods for facilitating smart contracts to provide tokens (e.g., NFTs) with the capability to own tokens are illustrated. Tokens given ownership over other tokens may be referred to as meta-tokens and/or meta-NFTs herein. Additionally or alternatively, the groups of one or more tokens owned by individual meta-tokens may be referred to as “bundles,” “sets,” “wrapped” tokens, and/or “owned” tokens. Bundles may be transferred by assigning the ownership of the token(s) that are included in the bundle to new (e.g., token) addresses. Thus, as expressed above, meta-tokens (including but not limited to NFTs) may be made the owner of one or more wrapped tokens. In accordance with various embodiments of the inventions, these assignments of ownership may be implemented by entities including but not limited to blockchain nodes.

Tokens that may be owned by (meta-)NFTs generated in accordance with numerous embodiments of the invention may include but are not limited to cryptocurrency, digital fungible tokens, and other NFTs. Various general aspects of bundling NFTs and NFTs owning other NFTs have been described in U.S. patent application Ser. No. 18/323,344, titled “Systems and Methods for Facilitating Access to Token Content,” filed May 24, 2023, incorporated by reference in its entirety.

In accordance with various embodiments of the invention, smart contracts instantiating NFTs may be associated data structures known as mappings, which are used to store data concerning individual NFTs. Potential uses of mappings are disclosed in commonly known standards for NFTs, including the Ethereum ERC-721 standard for non-fungible tokens and the Ethereum ERC-1155 standard for fungible and non-fungible tokens, both incorporated by reference in their entirety. Typically each entry (also referred to as rows in this disclosure) used in mappings may map token identifiers to owners. In such cases, token identifiers may be represented by integers and/or owners may be represented by blockchain (e.g., Ethereum) addresses. When tokens are transferred to new addresses (including but not limited to new meta-token addresses), owner addresses listed in mappings for the corresponding token identifiers may be replaced with the new addresses. When a token with a particular token identifier does not exist, the token identifier may be mapped to a default address (e.g., null, a zero address). Rows representing tokens in data structures (including but not limited to mappings) may include a variety of data fields reflecting underlying digital information (such as a universal resource identifier to metadata).

I. Smart Contract-Based NFT Functions

Smart contracts configured in accordance with various embodiments of the invention may be utilized to implement meta-NFTs that operate as transferable pseudo-wallets. Additionally or alternatively, systems in accordance with certain embodiments of the invention may be utilized to wrap other cryptocurrencies and/or digital tokens such that they are made the balances of meta-NFTs. This may include but is not limited to meta-NFTs that hold token balances (e.g., cryptocurrency) rather than blockchain addresses. The quantities of given balances may be measured in terms of balance units in this disclosure. Balance units may be set by parties including but not limited to independent entities, individual smart contracts, and/or token marketplaces.

The relevant category of meta-NFTs that includes references to balance and/or balance values, may be referred to as balance tokens and/or balance NFTs in this section. In accordance with many embodiments of the invention, functions including but not limited to balance incrementing functions, withdrawal functions, transfer functions, and/or token-adding functions may be applied to these NFTs through smart contracts. In accordance with certain embodiments of the invention, smart contracts that instantiate NFTs and/or own/manage corresponding digital assets (on behalf of NFTs) may thereby be said to be “associated” with those NFTs, allowing the NFTs to be modified through functions of the smart contracts.

In accordance with certain embodiments, smart contracts may include incrementBalance( ) functions in order to increase the token balance corresponding to associated NFTs. On implementation of valid transactions calling the incrementBalance( ) function (optionally with appropriate payment to fund the incrementation), smart contracts configured in accordance with some embodiments of the invention may increment balances recorded against corresponding meta-NFTs. In accordance with many embodiments, balances may be incremented by updating data within the associated smart contracts. Smart contracts configured in accordance with multiple embodiments of the invention may store this data (representing balances) in data structures, wherein the balance NFTs (via token identifiers) are mapped to specific balances that may be increased. The owners of balance NFTs may thereby “deposit” funds in their balance NFTs, as they might for digital wallets.

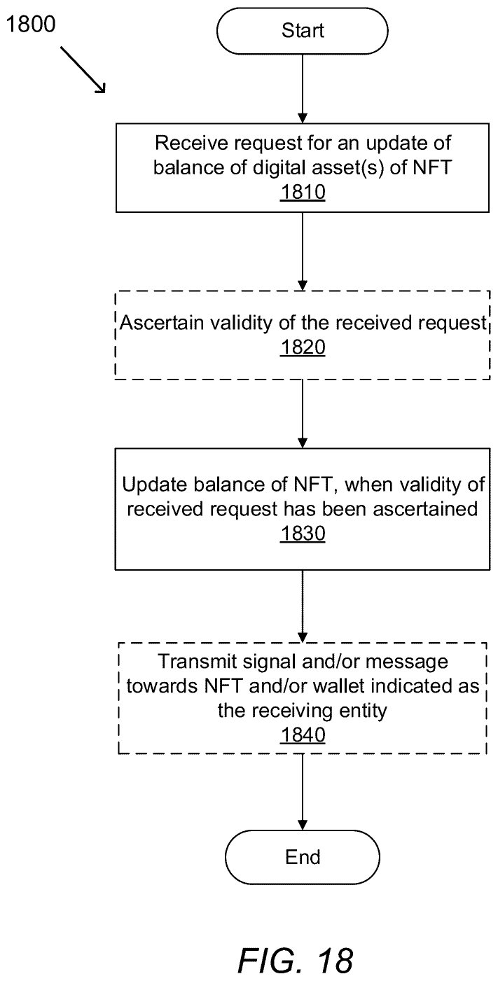

A process for updating balance, performed by smart contracts configured in accordance with numerous embodiments of the invention, is illustrated in FIG. 18. The balances updated may be associated with balance NFTs. Process 1800 receives (1810) a request for an update of a balance of digital asset(s) of a NFT. Requests may include, but are not limited to, indications of at least the type of update being performed and the corresponding NFT for which the update is to be performed. As explained and exemplified above, types of balance updates may include but are not limited to increments, withdrawals and/or transfers. Process 1800 optionally ascertains (1820) the validity of the received request. As said, this step may be optional and may be performed in order to make sure that the received request is a valid and/or verified request (e.g., that the party initiating the transaction is authorized to perform the function in relation to the meta-NFT). Process 1800 updates (1830) the balance of the NFT, when the validity of the received request has been ascertained. In cases of withdrawal and/or transfer, process 1800 optionally transmits (1840) the signal and/or message towards the NFT(s), smart contracts, and/or wallet(s) indicated as the receiving entities.

While specific processes for updating balances are described above, any of a variety of processes may be utilized to respond to requests as appropriate to the requirements of specific applications. In certain embodiments, steps may be executed or performed in any order or sequence not limited to the order and sequence shown and described. In a number of embodiments, some of the above steps may be executed or performed substantially simultaneously where appropriate or in parallel to reduce latency and processing times. In some embodiments, one or more of the above steps may be omitted.

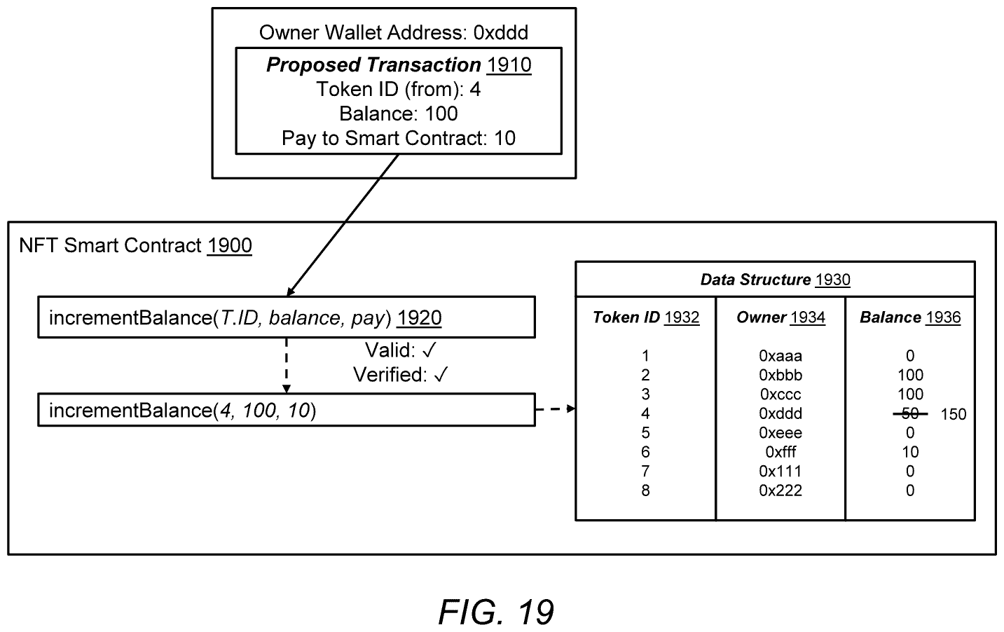

A balance incrementing function, utilized in smart contracts configured in accordance with various embodiments of the invention, is illustrated in FIG. 19. Those skilled in the art will appreciate that in FIG. 19 specific parameter values are presented for illustration, that these parameter values are not meant to be limiting, and that FIG. 19 should be interpreted without loss of generality.

NFT smart contracts 1900 configured in accordance with numerous embodiments of the invention may receive proposed transactions 1910 to be processed through calling functions, including but not limited to the incrementBalance( ) function 1920 in FIG. 19. The incrementBalance( ) function may receive input including but not limited to: an address of the sender of the transaction that calls the function; an identifier of the meta-token that is undergoing the balance change (T.ID); and the amount that balance should increase and/or decrease (balance). The address of the transaction sender may take the form of, but is not limited to the blockchain (e.g., wallet) address of the sender of the transaction. Additionally or alternatively, the balance(s) being incremented by the balance incrementing function(s) may follow units of measurement including but not limited to: cryptocurrency, independent currency units, units of particular brands of NFT (e.g., NFTs corresponding to a particular song release), and/or units corresponding to particular products (e.g., game copies). Additionally or alternatively, token identifiers may include but are not limited to: identifiers specific to the instantiating smart contracts, globally unique identifiers, and identifiers particular to specific marketplaces.

In accordance with some embodiments, as indicated in FIG. 19, implemented functions (e.g., balance incrementing functions) may include parameters governing payment (payment) for processing the transaction(s) 1910. Such payment may correspond to the incremented balance (and/or be proportional to that value). For the purposes of illustration, the NFT smart contracts 1900 may, for example, demand a payment of one unit of cryptocurrency for each 10 units of balance increase. In accordance with numerous embodiments, additional payment (e.g., a flat fee/royalty) may be intended for, but is not limited to, owners of the smart contracts, administrative entities, and/or managing escrow authorities.

The transaction 1910 depicted in FIG. 19 originates from a sender identified by wallet address 0xddd. The transaction 1910 includes parameters representing the token identifier (4), a balance increment amount (100), and a payment (10 units of cryptocurrency).

Upon receipt, incrementBalance( ) functions 1920 may examine the transaction(s) 1910. Examination may include but is not limited to determinations of transaction validity by comparing the structure of the transaction with accepted blockchain protocols; and verifications that the transaction has been correctly digitally signed (e.g., using a digital signing algorithm) in accordance with accepted blockchain protocols.

When the transaction is pronounced valid and verified, incrementBalance( ) functions may act on the transaction 1910. NFT smart contracts 1900 may be associated with data structures 1930 storing information regarding balance NFTs associated with the NFT smart contracts 1900. Associated balance NFTs that have information stored in the data structures 1930 may include but are not limited to NFTs that the NFT smart contracts 1900 instantiated and/or NFTs with assets owned by the NFT smart contracts 1900. The data structures 1930 may be represented as tables to be understood by human readers. Data structures 1930 configured in accordance with certain embodiments may include columns corresponding to fields including but not limited to token identifiers 1932, owners 1934, and balances 1936.

In FIG. 19, the incrementBalance( ) function 1920 performing the transaction 1910 is represented by an edit to a row corresponding to a specific token utilized for the transaction 1910. The token corresponds to identifier 4, is verified as belonging to address 0xddd, and is transacted upon such that the balance 1936 is incremented by 100 balance units, from 50 to 150. Upon performing this transaction, the NFT smart contracts 1900 may be configured to recover the payment (10 units of cryptocurrency) from the sender of the transaction.

As those skilled in the art will be aware, NFTs may be transferred from one ownership to another. Smart contracts configured in accordance with many embodiments of the invention may instantiate balance NFTs that may function effectively as “gift cards”. Specifically, users may mint balance NFTs, increment the corresponding balances, and then transfer the ownership of the balance NFTs to different parties, providing access to and ownership of the balance units.

In accordance with a number of embodiments, the owners of balance NFTs may sell some or all of the balance of the NFTs for (other types of) cryptocurrency and/or tokens. In accordance with a number of embodiments, the associated smart contracts may include withdrawBalance( ) functions indicating to withdraw balance units from NFTs. On receiving transactions calling withdrawBalance( ), smart contracts may reduce the balances of the NFTs by updating the mappings for particular token identifiers such that their balances are decreased, and transferring payment (equal to the reduction of the balances) in the form of cryptocurrency and/or digital tokens to the addresses of the owners of the NFTs.

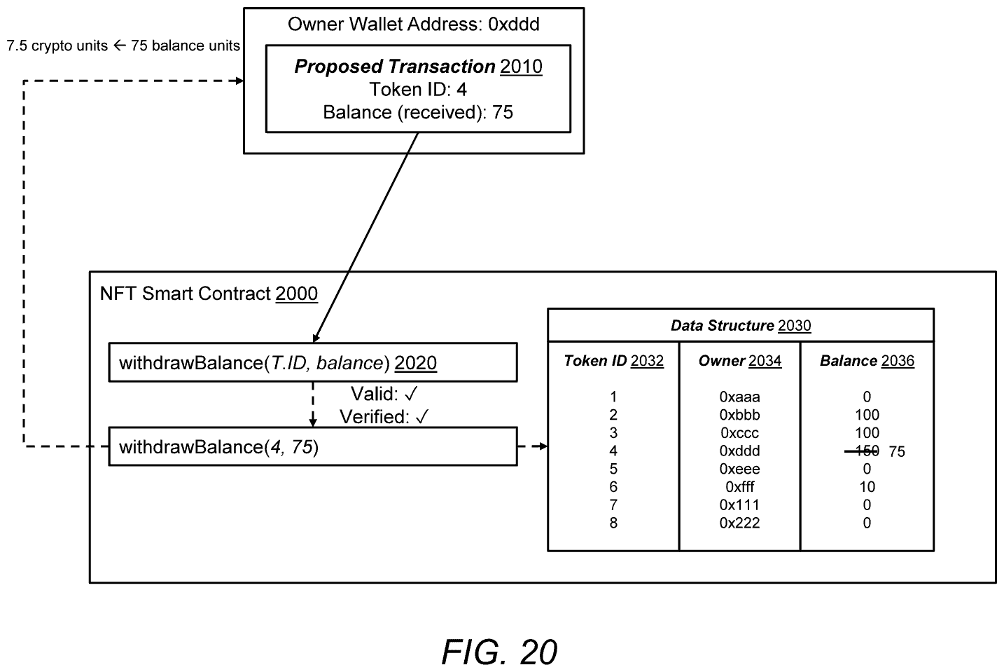

A withdrawal function, utilized in smart contracts configured in accordance with several embodiments of the invention, is illustrated in FIG. 20. Those skilled in the art will appreciate that in FIG. 20 specific parameter values are presented for illustration, that these parameter values are not meant to be limiting, and that FIG. 20 should be interpreted without loss of generality.

NFT smart contracts 2000 configured in accordance with various embodiments of the invention may receive proposed transactions 2010 to be processed through calling functions, including but not limited to withdrawBalance( ) 2020 functions in FIG. 20. Individual withdrawBalance( ) 2020 functions may receive input including but not limited to: addresses of the senders of the transactions that call the function; identifiers of the balance NFTs that are undergoing the balance change (T.ID); and the amounts that should be withdrawn from the balance NFTs (balance). As indicated above, the address(es) of the transaction sender(s) may take the form of, but is not limited to the blockchain (e.g., wallet) address(es) of the sender(s). Additionally or alternatively, the balance(s) being withdrawn by withdrawal functions may follow units of measurement including but not limited to: cryptocurrency, independent currency units, units of particular brands of NFT (e.g., NFTs corresponding to a particular song release), and/or units corresponding to particular products (e.g., game copies). Additionally or alternatively, token identifiers may include but are not limited to: identifiers specific to the instantiating smart contracts, globally unique identifiers, and identifiers particular to specific marketplaces.

In accordance with multiple embodiments, as indicated in the example of FIG. 19, implemented functions (e.g., withdrawal functions) may include parameters governing payment (payment) for transaction(s) 2010. In accordance with certain embodiments, payment (e.g., a flat fee/royalty) may be required for the transactions. The payment may be intended for, but is not limited to, owners of the smart contracts, administrative entities, and/or managing escrow authorities.

The transaction 2010 illustrated in FIG. 20 originates from a sender identified by wallet address 0xddd. The transaction 2010 additionally includes parameters representing the token identifier (4) and a balance withdrawal amount (75).

Upon receipt, withdrawBalance( ) 2020 functions may examine the transaction(s) 2010. Examination may include but is not limited to determinations of transaction validity by comparing the structure of the transactions with accepted blockchain protocols; and verifications that the transactions have been correctly digitally signed (e.g., using a digital signing algorithm) in accordance with accepted blockchain protocols.

When transactions are pronounced valid and verified, withdrawBalance( ) functions may act on the transactions 2010. NFT smart contracts 2000 may be associated with data structures 2030 storing information regarding NFTs associated with the NFT smart contracts 2000. Associated balance NFTs that have information stored in the data structures 2030 may include but are not limited to NFTs that NFT smart contracts 2000 instantiated and/or NFTs with assets owned (and/or managed) by the NFT smart contracts 2000. The data structures 2030 may be represented, in order to be understood by human readers, as tables. Data structures 2030 configured in accordance with some embodiments may include columns corresponding to fields including but not limited to token identifiers 2032, owners 2034, and balances 2036.

When the balance to be withdrawn is less than or equal to the present balance of the sending NFT, then the withdrawBalance( ) 2020 function may perform the withdrawal. In FIG. 20, the withdrawBalance( ) 2020 function performing the transaction 2010 is represented by an edit to a row corresponding to a specific token (e.g., meta-NFT) utilized for the transaction 2010. The token corresponds to identifier 4, is verified as belonging to address 0xddd, and is transacted upon such that the 75 balance units are withdrawn from the balance 2036, decreasing it from 150 to 75. In the example disclosed in FIG. 20, the function may again equate 10 balance units to 1 unit of cryptocurrency. As such, the submitted transaction transfers 7.5 units of cryptocurrency from the NFT smart contract 2000 to the wallet of the sender (address 0xddd).

Through this, native cryptocurrency of blockchains, and/or non-fungible tokens instantiated by other smart contracts, may be deposited against balance NFTs instantiated by the NFT smart contracts 2000. Additionally or alternatively, these tokens may later be withdrawn, thus implementing wrapped tokens stored against NFTs rather than blockchain addresses. In this disclosure, the meta-NFTs in which value is deposited may also be referred to as destination tokens and/or destination NFTs; and the NFTs from which value is removed may also be referred to as sending tokens and/or sending NFTs.

In accordance with some embodiments of the invention, owners of particular (sending) NFTs may transfer some or all of the balance of the NFTs to destination NFTs. In accordance with several embodiments, smart contracts may include transferBalance( ) functions, that may reduce the balances of the sending NFTs. As disclosed above, this data may be updated within the data structures such that the balances corresponding to the sending NFTs are decreased, and the balances of receiving NFTs are increased by corresponding amounts. Additionally or alternatively, these transactions may include payment in the form of fractions of the balances being transferred as royalties and/or transfer commissions for the smart contracts.

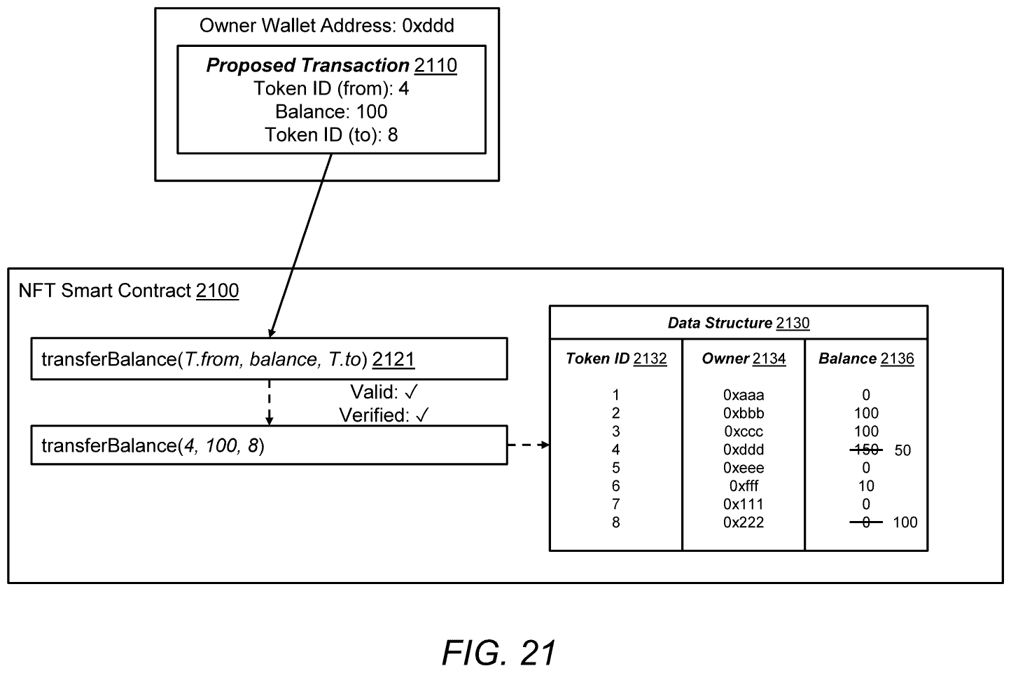

A transfer function, utilized in smart contracts configured in accordance with a number of embodiments of the invention, is illustrated in FIG. 21. Those skilled in the art will appreciate that in FIG. 21 specific parameter values are presented for illustration, that these parameter values are not meant to be limiting, and that FIG. 21 should be interpreted without loss of generality.

NFT smart contracts 2100 configured in accordance with several embodiments of the invention may receive proposed transactions 2110 to be processed through calling functions, including but not limited to the transferBalance( ) 2120 function in FIG. 21. The transferring function depicted in FIG. 21 (transferBalance( ) 2120) may receive input including but not limited to: addresses of the senders of the transactions that call the function; identifiers of the sending tokens which performing the transfers (T.from); the amount that should be transferred from the sending tokens (balance); and identifiers of the destination tokens of the transfers (T.to). As indicated above, the addresses of the transaction senders may take the form of, but is not limited to the blockchain (e.g., wallet) addresses of the senders of the transactions. Additionally or alternatively, the balance(s) being transferred may follow units of measurement including but not limited to: cryptocurrency, independent currency units, units of particular brands of NFT (e.g., NFTs corresponding to a particular song release), and/or units corresponding to particular products (e.g., game copies). Additionally or alternatively, token identifiers may include but are not limited to: identifiers specific to the instantiating smart contracts, globally unique identifiers, and identifiers particular to specific marketplaces. In accordance with several embodiments of the invention, the identifiers of the sending tokens and the identifiers of the destination tokens may follow different identification formats. In such cases, systems configured in accordance with some embodiments of the invention may store multiple identifiers for individual tokens.

The transaction 2110 depicted in FIG. 21 originates from a sender identified by wallet address 0xddd. The transaction 2110 additionally includes parameters representing the token identifier for the sending token (4), a transfer amount (100), and the token identifier for the receiving token (8). In accordance with many embodiments, payment (e.g., a flat fee/royalty) may be required for the transactions. The payment may be intended for, but is not limited to, owners of the smart contracts, administrative entities, and/or managing escrow authorities.

Upon receipt, transferBalance( ) 2120 functions may examine the transaction(s) 2110. Examination may include but is not limited to determinations of transaction validity by comparing the structure of the transactions with accepted blockchain protocols; and verifications that the transactions have been correctly digitally signed (e.g., using a digital signing algorithm) in accordance with accepted blockchain protocols.

When transactions 2110 are pronounced valid and verified, transferBalance( ) functions may act on the transactions 2110. NFT smart contracts 2100 may be associated with data structures 2130 storing information regarding NFTs associated with the NFT smart contracts 2100. Associated NFTs that have information stored in the data structures 2130 may include but are not limited to NFTs that the NFT smart contracts 2100 instantiated and/or NFTs with assets owned by the NFT smart contracts 2100. The data structure 2130 may be represented, in order to be understood by human readers, as a table. Data structures 2130 configured in accordance with some embodiments may include columns corresponding to fields including but not limited to token identifiers 2132, owners 2134, and balances 2136.

When the balance to be transferred is less than or equal to the present balance of the sending NFT, then the transferBalance( ) 2120 function may perform the transfer. In FIG. 21, the transferBalance( ) 2120 function performing the transaction 2110 is represented by an edit to a row corresponding to a specific (meta-)token utilized for the transaction 2110. The sending token corresponds to identifier 4, is verified as belonging to address 0xddd, and is transacted upon such that the 100 balance units are transferred from the balance 2136 for the sending token (T.ID=4), decreasing it from 150 to 50. These balance units are transferred to the destination token (T.ID=8), increasing its balance from 0 to 100.

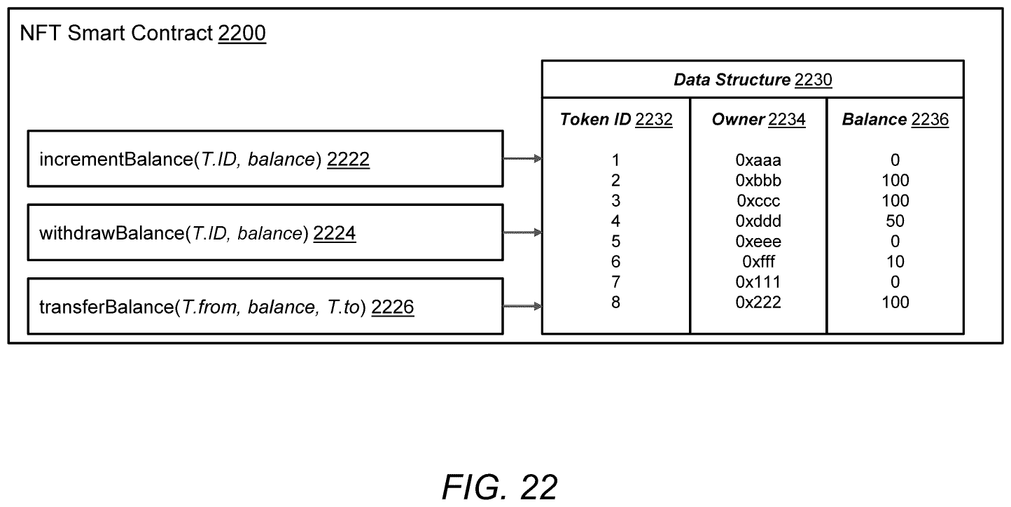

An NFT smart contract, configured in accordance with multiple embodiments of the invention, to implement various functions, is illustrated in FIG. 22. As indicated above, NFT smart contracts 2200 may be associated with data structures 2230 storing information regarding NFTs associated with the NFT smart contracts 2200. Associated NFTs that have information stored in the data structures 2230 may include but are not limited to NFTs that the NFT smart contracts 2200 instantiate and/or NFTs with assets owned by the NFT smart contracts 2200. As indicated above, data structures 2230 configured in accordance with numerous embodiments may include columns corresponding to fields including but not limited to token identifiers 2232, owners 2234, and balances 2236. Additionally or alternatively, as shown above, NFT smart contracts 2200 may include functions including but not limited to incrementBalance( ) 2222, withdrawBalance( ) 2224, and/or transferBalance( ) 2226 functions.

In the previous figures, the disclosed NFT smart contracts are illustrated as holding balances for one specific fungible token type at a time. For example, balances may specifically be used to specifically store Ether on Ethereum. They may, additionally or alternatively, be used to store specific ERC-20 tokens (e.g., USDC). However, systems and methods in accordance with many embodiments of the invention may enable NFT smart contracts capable of instantiating (meta-)NFTs that may hold a plurality of token types.

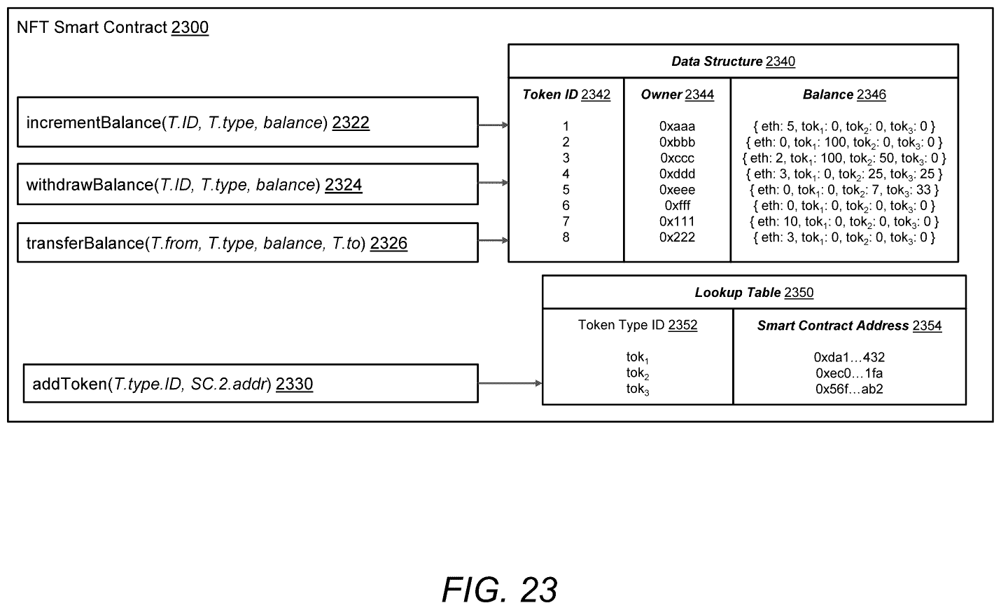

An NFT smart contract, configured in accordance with certain embodiments of the invention, to store multiple token types, is illustrated in FIG. 23. Those skilled in the art will appreciate that in FIG. 23 specific parameter values are presented for illustration, that these parameter values are not meant to be limiting, and that FIG. 23 should be interpreted without loss of generality. Those skilled in the art will also appreciate that FIG. 23 is described in the context of the Ethereum blockchain and smart contracts, but the invention may be similarly applied to other smart contract blockchains.

As disclosed above in relation to FIG. 22, NFT smart contracts 2300 may include various functions including but not limited incrementBalance( ) 2322 functions, withdrawBalance( ) 2324 functions, and transferBalance( ) 2326 functions.

However, as disclosed in FIG. 23, in accordance with some embodiments of the invention, functions may additionally input parameters specifying attributes like token type (T.type). Potential token types may include but are not limited to balance tokens and/or specific lines of NFTs. For example, the sender of a transaction may call incrementBalance( ) 2322, providing additional parameters for token identifier (T.ID). However, in such an instance, the sender may indicate that the type of token involved in the transaction is a balance token (as was used in FIGS. 19-22). In such cases, the parameters may include balance amounts (indicated by the balance parameter). Additionally or alternatively, when T.type refers to specific lines of NFTs, the parameters may include values representing the number of NFTs of that type involved in the transactions. This parameter may be commensurate with the balance parameter. Additionally or alternatively, for native cryptocurrency, including but not limited to ether used in the Ethereum blockchain system, transactions may include a value transfer of cryptocurrency in the transaction, commensurate with the balance parameter. In an example, using ether, the T.Type may be specified as eth, with the called function taking the form:

tx(contract.incrementBalance(1,eth,5,5ETH)) (1)

In the example in transaction (1), an NFT is identified by a token ID parameter of 1, a token to credit to the NFT is identified by ether (eth), and an amount of ether is identified by 5 ETH. Additionally, the payment required to implement the balance is indicated to be 5 units of cryptocurrency, representing the amount “deposited.”

In accordance with some embodiments, in the absence of T.Type and balance as parameter arguments, NFT smart contracts may convert the intended increase in terms of the balance of native cryptocurrency (e.g., ether). In accordance with a few embodiments, smart contracts may perform such deductions by inspecting value transferred by the transaction(s) (i.e., payment) and crediting said value to the balance stored against the NFT specified by token ID parameters (e.g., T.ID).

For fungible tokens defined through smart contracts, including but not limited to Ethereum Request for Comment 20 (ERC-20) type tokens, transactions may include parameters specifying the ERC-20 type token and a balance to transfer to the NFT specified by the (T.ID) parameter:

tx(contract.incrementBalance(1,dai,5)) (2)

In the example in transaction (2), the destination NFT is identified by a token ID parameter of 1, a fungible token to credit to the NFT is identified by dai, and an amount of the fungible token is identified by 5. Provided the transaction is issued by an owner of the token with a token ID of 1 and the owner has at least 5 DAI (e.g., 5 DAI in their wallet), the amount of DAI possessed by the owner may be decreased by 5, and the NFT smart contract may transfer 5 DAI to be registered against the token (with the token ID parameter of 1).

Those skilled in the art will appreciate similar approaches apply to withdrawBalance( ) 2324 and transferBalance( ) 2326 in light of FIG. 19 and FIG. 20 respectively. For the edification of those not skilled in the art, the following examples, which are presented for illustration only and are not meant to be limiting, are presented and explained:

tx(contract.withdrawBalance(1,dai,5)) (3)

In this example in transaction (3), an NFT is identified by a token ID parameter of 1, a fungible token to credit to the NFT is identified by dai, and an amount of the fungible token (DAI) is identified by 5. Provided the transaction is issued by an owner of the sending token with a token ID of 1 that has a balance of at least 5 DAI, the amount of DAI registered against the sending token may be decreased by 5, and the NFT smart contract may transfer 5 DAI to the sender of the transaction.

tx(contract.transferBalance(1,dai,5,2)) (4)

In the example in transaction (4), a (sending) NFT is identified by a token ID parameter of 1, a fungible token to credit to the NFT is identified by dai, an amount of the fungible token (DAI) is identified by 5 and the destination NFT is identified by a token ID parameter of 2. In transaction (4), provided the transaction is issued by an owner of the (sending) token with a token ID of 1 then has a balance of at least 5 DAI, the amount of DAI registered against the token may be decreased by 5, and the NFT smart contract may register an increment of 5 dai against the (destination) token identified by 2.

NFT smart contracts 2300 may correspond to, but are not limited to data structures 2340 storing information regarding NFTs associated with the NFT smart contracts 2300. Associated NFTs that have information stored in the data structures 2340 may include but are not limited to NFTs that the NFT smart contracts 2300 instantiate and/or NFTs with assets owned by the NFT smart contracts 2300. The data structures 2340 may be represented as tables to be understood by human readers. Data structures 2340 configured in accordance with some embodiments may include columns corresponding to fields including but not limited to token identifiers 2342, associated owners 2344, and balances 2346.

In accordance with multiple embodiments of the invention, rows in the balances column 2346 of the data structures 2340 may include recording structures for recording balances for any of a plurality of cryptocurrencies and tokens. Recording structure configurations may include but are not limited to arrays, JSON objects, dictionaries, and/or other data structures. For the purposes of illustration, and not meant to be limiting, in FIG. 23, an example of a possible recording structure utilizing a JSON object is presented in the balances column 2346. In the example, balances for the NFT smart contract 2300, implemented on the Ethereum blockchain, include a key for ether (eth) and a value for a quantity of ETH stored against an NFT instantiated by the NFT smart contract 2300. For example, token 1 owned by owner 0xaaa has a balance of 5 ETH. Additionally or alternatively, in accordance with many embodiments of the invention, fungible token balances may be stored against unique token-type identifiers. FIG. 23 illustrates the use of several token types: tok₁, tok₂, and tok₃. Again, in the present example, token 3 owned by owner 0xccc has a balance of 50 registered against a fungible token type denoted by tok₂.

In accordance with various embodiments of the invention, NFT smart contracts 2300 may be associated with lookup tables 2350 which may include but are not limited to token-type identifier columns 2352 and contract address columns 2354. Through lookup tables 2350, NFT smart contracts 2300 may look up contract addresses for token types. For example, a token with token type identifier tok₁ may correspond to a contract with address 0xda1 . . . 432. Additionally or alternatively, new entries may be added to the lookup tables 2350 on a manual basis using addToken( ) 2330 functions. In accordance with some embodiments, the addToken( ) 2330 functions may take, as input, a specific token type identifier (T.Type.ID) and/or a smart contract address (SC.2.addr).

In accordance with numerous embodiments of the invention, NFT smart contracts 2300 may be approved to utilize functions on tokens instantiated by various types of (fungible and/or non-fungible) token smart contracts. For example, users may approve NFT smart contracts 2300 to withdraw a number of (e.g., 50) tokens from a token smart contract with identifier tok₂ and contract address 0xec0 . . . 1fa. Additionally or alternatively, users may submit incrementBalance( ) transactions to NFT smart contracts 2300 as shown below:

tx(contract.incrementBalance(1,tok₁,50)) (5)

In transaction (5), the NFT smart contract 2300 may subsequently look up a contract address for a token contract corresponding to the token with identifier tok₁, withdraw 50 tok₁ tokens from the token smart contract with contract address 0xec0 . . . 1fa, and when successful, increment a balance of tok₁ in a JSON object in row 1 of the balances table 2346 corresponding to an NFT with token identifier 1.

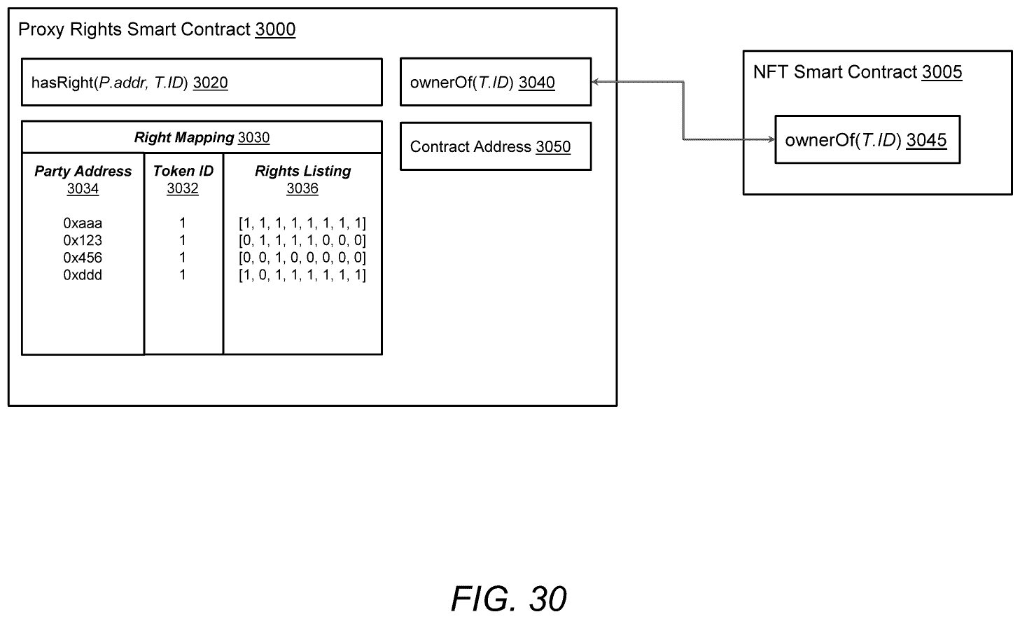

As described below in relation to FIG. 30, in accordance with a number of embodiments, proxy smart contracts may act as brokers between NFT smart contracts 2300 and user, confirming that tokens have been transferred to the NFT smart contracts 2300 and/or instructing the NFT smart contracts 2300 to increment, withdraw, and/or transfer balances (registered against NFTs instantiated by the NFT smart contracts 2300).

While specific processes and smart contract configurations are described above with reference to FIGS. 18-23, NFT-based token ownership may be implemented in any of a number of different ways to enable as appropriate to the requirements of specific applications in accordance with some embodiments of the invention. Additionally, the specific manner in which smart contract configurations may be utilized within NFT platforms in accordance with numerous embodiments of the invention is largely dependent upon the requirements of a given application.

II. NFTs Owning Other Tokens—Configurations

In accordance with numerous embodiments of the invention, systems in which tokens (e.g., meta-NFTs) have ownership of other tokens may have various configurations. In one example, singular meta-tokens may be provided with ownership over one or more different tokens. In accordance with certain embodiments, two or more tokens, each one including at least one element as described above, may be tied together in terms of ownership and/or contractual relationships.

In accordance with some embodiments, when bundled, sets of tokens may cease to exist as independent entities. In such cases, they may be prevented from being unbundled. For example, some tokens may be converted such that they may be transferred as bundles, as their owner(s) may not correspond to wallet address(es) but other token(s). As a meta-token is transferred, in terms of ownership, the associated rights of the NFTs that the meta-token owns may be transferred accordingly. Various aspects of meta-tokens were disclosed in U.S. patent application Ser. No. 17/808,264, titled “Systems and Methods for Token Creation and Management,” filed Jun. 22, 2022, incorporated by reference in its entirety. Further, co-pending application PCT Patent Application No. PCT/US23/62851, titled “Systems and Methods for Abuse Safeguards in NFT-Directed Environments,” filed on Feb. 17, 2023, incorporated by reference in its entirety, describes methods for detecting and verifying whether a given token may be considered a member of a set associated with another token. Here such methods may be employed to assess whether a given token may be bundled with another to form a meta-token. The previous application additionally describes methods for encoding and ascertaining properties of a set and/or members thereof, such as ordering and completeness, which here may be applied to sets of NFTs which (potentially) include meta-tokens.

Bundles configured in accordance with many embodiments of the invention may be unbundled into their constituent components including but not limited to the NFTs and associated elements described above. In accordance with some embodiments of the invention, bundles may be unbundled by meta-tokens (e.g., through smart contracts), which may act as owners. Unbundling may involve transferring ownership of constituent components to entities including but not limited to other meta-tokens and/or wallet addresses. Unbundling may be selective wherein only some of the bundled components are transferred away. Additionally or alternatively, unbundling may be complete, causing all assets to be transferred out (which may effectively empty the corresponding meta-token). Such emptied meta-tokens may still exist, unless explicitly destroyed (e.g., by assigning them to a “null” entity), and may be used to house new bundles.

Meta-tokens may wrap one or more assets, including but not limited to NFTs, wherein individual assets and/or meta-tokens may be associated with their own sets of terms. In accordance with numerous embodiments, meta-tokens and/or constituent tokens within meta-tokens may be associated with terms that dictate constraints (i.e., limitations on access) and/or privileges (i.e., rights of access).

One example of a first set of terms, which may apply to a first type of NFT associated with meta-tokens, may dictate the types of devices on which content associated with the NFTs of this type may be rendered. For example, the first set of terms may require that the full-resolution version of the content may only be rendered on a device with trusted execution environments (TEEs). Additionally or alternatively, the first set of terms may require that a degraded version (e.g., one with lower resolution, and/or included watermarks) must be rendered on devices that do not have a TEE. Another second set of terms may apply to a second type of NFT associated with meta-tokens. These terms may specify that, to use a resource, (including but not limited to scripts included in and/or referenced by NFTs of this type), the execution must be performed by digital rights management (DRM) modules. A third type of NFT associated with meta-tokens may have terms specifying that the usage of the content associated with NFTs of this type requires the reporting of demographic data to a third party.

In accordance with multiple embodiments of the invention, meta-tokens may combine the terms of all the constituent tokens (e.g., NFTs). This may involve applying all terms of constituent tokens to the meta-tokens; additionally or alternatively, this may involve applying all terms of constituent tokens to all other constituent tokens. In accordance with numerous embodiments of the invention, terms may be stored in external data storage and accessed through references incorporated into the NFTs. Doing so in relation to the above term examples may result in requirements related to the use of TEEs for full-resolution versions of content; the use of a DRM module for the use of the corresponding scripts; and the use of reporting for inclusion (e.g., of the asset of the third type of NFT).

Meta-tokens configured in accordance with various embodiments of the invention may, additionally or alternatively, incorporate additional constraints. Such constraints may include but are not limited to requirements (for access to content) of membership in particular organizations. Membership may be proved by tokens and/or digital signatures certifying valid memberships. In accordance with numerous embodiments of the invention, when users attempt to use meta-tokens in contexts that do not satisfy the requirements, partial experiences may be created. A partial experience may correspond to the rendering of a degraded version of content, and/or use of only some elements of some wrapped NFTs. Additionally or alternatively, non-satisfaction of requirements may lead meta-tokens to cause notifications to be rendered, identifying the problems and/or how to rectify them.

Meta-tokens may, additionally or alternatively, cause the escalation of rights relative to the intersection of requirements from the constituent NFTs. For example, the intersection of requirements may cause some terms to be relaxed and/or removed. In accordance with some embodiments, relaxed term sets may be obtained from parties with particular rights including but not limited to content creators associated with the NFTs for which relaxation is desired. Such relaxations may take the form of digital signatures and/or tokens (e.g., NFTs) providing greater rights for the identified NFTs. The relaxations may be obtained by paying fees that may be indicated in the NFTs and/or associated meta-data for which term relaxation is desired.

In accordance with a number of embodiments, constraints and/or privileges may be made contingent in part on being associated with meta-tokens (and/or with the state of the associated meta-tokens) including but not limited to the presence and properties of other constituent tokens. For example, a number of NFTs may each individually have metadata corresponding to an episode of a television series, with terms that enable them to be played back according to the requirements of associated DRM modules. But these NFTs may additionally include terms specifying that, when they are wrapped by meta-tokens such that constituent NFTs are wrapped that correspond to all episodes in a particular season of the series, additional content may be unlocked. In accordance with various embodiments, unlocking additional content may take the form of allowing access rights to hidden tokens associated with new content; additionally or alternatively, unlocking may involve the constituent tokens and/or the meta-token(s) spawning new tokens response to the condition of all the constituent tokens being wrapped by the meta-token(s). In the above example, directors' commentary for the episodes may additionally be viewed. As another example, a musician may release a number of musical tracks as NFTs, one of which includes terms that allow it to spawn when and only when bundled in meta-tokens alongside certain other tracks; when this happens, the constituent tokens and/or the meta-token(s) may spawn a new NFT representing a bonus track which may now be played as well as sold.

In accordance with many embodiments, the “root tokens” of sets of tokens may refer to the meta-tokens owned by non-token entities (e.g., wallets, smart contracts) to which they are assigned. In this disclosure, non-token entities that own tokens (e.g., meta-tokens) may be referred to as “containers.” When root tokens are transferred from one container to another, this may cause the transfer of the tokens that are owned by the root token, any tokens owned by these root-token-owned tokens, and so on. In accordance with various embodiments, these transfers may involve the systems disclosed above in reference to FIG. 21. In this example, a collection of tokens may be connected in the form of a directed acyclic graph (DAG), wherein the transfer of the root token causes the transfer of all tokens associated with the DAG. While any tokens that own one or more other tokens are termed herein as meta-tokens, any meta-tokens that are themselves (directly) owned by containers, as opposed to another token, may additionally be referred to as a root token (as it is the root of a DAG of token ownership).

Tokens may be reassigned from being owned by individual meta-tokens (including but not limited to root tokens) to instead be owned by other meta-tokens and/or containers (including but not limited to wallets). This may be performed in an analogous manner to how other ownership transfers are performed, e.g., by re-associating ownership by recording new ownership on blockchains. Additionally or alternatively, changes in ownership may be performed by generating digital signatures using private keys of the owner (meta-)token, on addresses identifying the owned tokens and addresses identifying the new owners (e.g., containers and/or other tokens. The determination of whether one meta-token would transfer the ownership rights of another token (which may be a form of unbundling) may be determined by scripts associated with the meta-token. In some examples, it may, additionally or alternatively, be determined by scripts associated with the owned tokens. Such scripts may be executed in execution environments where DAGs of tokens are stored, including but not limited to containers.

Just like containers may own tokens and/or tokens may own another token, it is also possible for tokens to own containers (which may, in turn, include tokens). This enables the automation of trading wherein automated agents are scripts that are associated with tokens, and these automated agents buy and sell tokens, and containers including tokens (such as wallets), based on policies indicating trading strategies.

Tokens may be transferred between containers by the direct transfers of tokens, and/or by the direct transfers of meta-tokens. In either case, in accordance with some embodiments, scripts may be evaluated to determine whether royalties and/or other fees (including but not limited to sales taxes) are due to be paid. Certain scripts may indicate that, when tokens are transferred from a first wallet to a second wallet, where both the first and second wallet are owned by the same entity, then no royalty and/or sales tax is due to be paid. In such cases, some other fee, such as a fee related to insurance of resources associated with the transferred assets, may nevertheless be collected. Similarly, when tokens are bundled with other tokens, no royalty payments may be due, but bundling fees may be required to be paid. Bundling fees may depend on, but are not limited to the exact assets being combined in the bundling process, and/or one or more policies associated with the tokens being bundled. In instances where it is not clear from one or more policies whether a given fee has to be paid and/or not, reports may be generated and logged in response to the bundling, and/or unbundling, of the resources. Additionally or alternatively, third-party entities may be appointed to administrate when the fees must be paid.

In accordance with various embodiments, root tokens may be used to implement the functionality of meta-tokens. As indicated above, root tokens may be used to associate two or more tokens with each other (e.g., by being assigned ownership of these). Some of these tokens may be non-fungible tokens, and some of them may be fungible tokens. The root tokens may reference and/or include information specifying the relationship between tokens being associated with each other. Rules of inheritance may mean that the root token is the owner of the entire DAG, including both the first token and the second token, even though the root token is only the “direct” owner of the first token. Meta-tokens may similarly be implemented in a variety of ways. One such way is by becoming the owner of one or more other tokens, as the root token disclosed herein is.

In accordance with some embodiments, singular tokens may be associated with various types of content, (including but not limited to audio files, movie files, image files, and/or text files); while other tokens may be associated with the corresponding ownership assertions. An example of an ownership assertion may be biometric tokens as disclosed in U.S. patent application Ser. No. 17/933,659, titled “Systems and Methods for Token Content Unlocking, Biometric Authentication using Privacy-Protecting Tokens, Ownership-Based Limitations of Content Access, Policy-Based Time Capsule Technology, and Content Lock Mechanisms,” filed Sep. 20, 2022, incorporated by reference in its entirety. Another example of an ownership assertion is the encrypted identifier disclosed in U.S. patent application Ser. No. 17/821,444, titled “Systems and Methods for Management of Token Interactions,” filed Aug. 22, 2022, incorporated by reference in its entirety. By associating the content-associated tokens with ownership-assertion-associated tokens, the two aspects may be combined, effectively assigning the ownership assertions to the content. Such ownership assertions may be used for access control, as in cases involving biometric tokens. Ownership assertions may, additionally or alternatively, be used for selective tracking, as in the case of the encrypted identifier. A person of skill in the art will recognize that this is only one illustrative example of a benefit obtained by systems in accordance with various embodiments. The use of ownership associations is a novel structure disclosed herein, enabling the association of tokens with each other, where these associations may be functional. The setting of some tokens as owning other tokens may thereby establish associations of the tokens with each other.

In accordance with various embodiments, the association of two or more tokens by the representation of them as DAGs may be temporary. For example, they may be undone, at least in part, by having “owned” tokens transferred away from meta-tokens (e.g., by the generation of digital signatures expressing the transfers, where the digital signatures are verified using public keys associated with the meta-tokens). As described, other entities may also be allowed to create such digital signatures. One example of such entities is the containers to which the root tokens associated with DAGs are assigned.

In accordance with some embodiments, at least some of the associations between tokens may be irreversible. This may be guaranteed through methods including but not limited to having the entities associated with the private keys (needed to initiate the transfers of tokens away from meta-tokens) be associated with parties that will not generate the digital signatures needed for reversal operations. This stipulation may be established through contractual reasons, legal reasons, and/or lack of full control over the private keys needed to perform the operations. Such tokens, once combined, may be destined to remain associated with each other. This may be used to assign irrevocable ownership of tokens and/or DAGs representing two or more bundled tokens.

One or more tokens in DAGs may include and/or reference scripts. Such scripts may correspond to algorithms directed to tasks including but not limited to performing security and/or privacy management, determining what policies apply to use and/or transfer of the DAGs, determining how to configure and/or select content based on observations associated with the DAGs, etc. For instance, such a script may be used to determine whether conditions for unlocking and/or spawning new content are met by the current configuration of the DAGs, enabling examples such as unlocking directors' commentary on television episodes and/or spawning of a bonus music track described above. The scripts may, additionally or alternatively, include non-deterministic behaviors, including but not limited to implementing the ability to reward wallets with prizes of non-predetermined value upon purchasing certain NFTs and bundling them together, and/or spawning new NFTs under certain conditions, certain features and/or properties of which may be determined by chance. The scripts may have the effect of automatically modifying tokens in the DAGs, including but not limited to updating NFT token URIs with the effect of altering media and/or other metadata associated with them and/or enabling the evolution of NFT content that is informed by DAG properties. Scripts may be machine learning (ML) scripts and/or artificial intelligence (AI) scripts, and/or be part of such. For example, scripts may employ existing classifiers, where the classifier logic is embedded in the script itself and/or referenced in the script. Additionally or alternatively, scripts may employ generative AI methods including but not limited to GANs and/or transformers to generate new content, which may be associated with existing and/or new tokens.

In accordance with many embodiments, two or more tokens may be assigned as the joint owners of another token. The owned token may correspond to, but are not limited to biometric tokens and/or policies indicating DRM rules, for example. In accordance with some embodiments when a first meta-token that is a joint owner is transferred (e.g., sold) to another wallet but without a second meta-token/joint owner being transferred, one of the joint owners' ownership may be severed. This may be the situation in the example where the owned token is a biometric token, for example. On the other hand, the severing of the relationship may not be necessary, e.g., the first and the second meta-token may both be the owners of even while having different owners. Therefore, ownership of root tokens may not necessarily indicate ownership of tokens in the same DAG as the root token. In fact, in the example where both the first token and the second token own the third token, the corresponding DAG may have (at least) two root tokens.

In accordance with various embodiments of the invention, three or more tokens may be assigned as the joint owners of another distinct token. This joint ownership structure may be conjunctive, disjunctive, and/or more complex, e.g. requiring certain combinations of owning entities to agree to a transfer of ownership.

Joint ownership configurations in accordance with some embodiments of the invention may be facilitated in various ways. For example, as indicated above, one entity may change the ownership of a resource to enable another entity to be a joint owner. As suggested above, joint ownership may mean that either one of the two (or more) entities may collectively change the ownership of the resource, e.g., transfer all rights to yet another entity. Additionally or alternatively, ownership changes may require that all of the owners together must collaborate to make an ownership change.

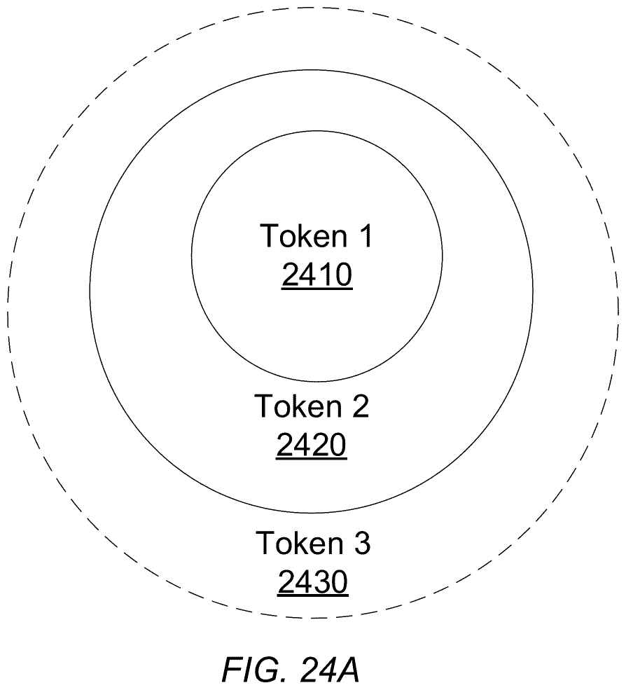

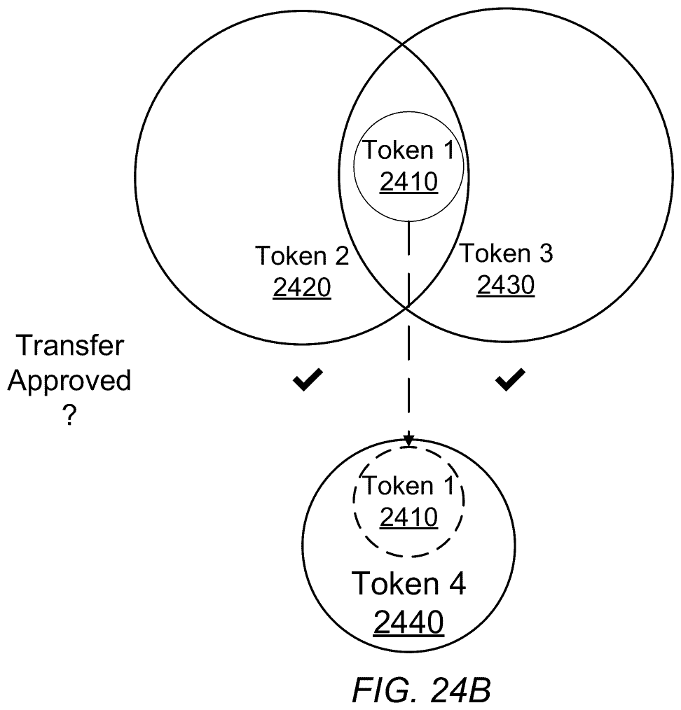

A system of use for meta-tokens configured in accordance with various embodiments of the invention, is illustrated in FIG. 24A. As indicated above, token hierarchies in accordance with multiple embodiments of the invention may include the capacity for one or more tokens to own another token. FIG. 24A is an illustration of three tokens, a first token 2410, a second (meta-)token 2420 and an optional third (root) token 2430. In this figure, the first token 2410 has its ownership assigned to the second token 2420, which is illustrated by the second token 2420 encompassing the first token 2410. In this illustration, the second token 2420 is thus a meta-token. In the case that the second token 2420 is owned by a wallet, the second token 2420 would also be the root token of the token hierarchy. Alternatively, as shown in FIG. 24A, the ownership of meta-tokens (e.g., the second token 2420) may itself be assigned to its own meta-tokens. The figure reflects this through the second token 2420 being assigned to a third token 2430, making the third token 2430 the root token. In such a case, the second token 2420 would be a meta-token while the third token 2430 would be both a meta-token and a root token due to owning the second token 2420, while being owned by the wallet (as opposed to its own meta-tokens). However, as indicated above, in accordance with some embodiments, tokens may have split ownership over individual tokens.

A system of joint ownership by meta-tokens configured in accordance with many embodiments of the invention is illustrated in FIG. 24B. FIG. 24B illustrates the ownership transfer of a first token 2410, from the joint pair of a second token 2420 and a third token 2430, to a singular fourth token 2440. In this exemplifying illustration, the first token 2410 has its ownership assigned jointly to the second token 2420 and the third token 2430, which is illustrated by the first token 2410 existing in the overlap between the second token 2420 and the third token 2430. As indicated above, the ownership being conjunctive may require that the two or more tokens that have joint ownership of another token need to agree to sell in order for the sale to be authorized. In the conjunctive ownership illustrated in FIG. 24B, both the second token 2420 and the third token 2430 agree and sell the first token to the fourth token 2440.

Tokens may indicate the manner in which they exercise control over tokens that it is indicated as the owner of through methods including but not limited to the use of metadata fields. For example, the indication in metadata fields may indicate that scripts associated with tokens are responsible for transferring out any ownership rights associated with the tokens. This transfer may be done through methods including but not limited to a script being provided an input related to an owned token, processing the input, and conditional on the processing outcome, and/or generating a digital signature that causes the owned token to be transferred away from the token that the script is associated with. As another example, indications in metadata fields may indicate that containers that own the applicable root token(s) have the right to generate digital signatures. In some cases, such a right may be conditional on validating that given tokens should be transferred away from given DAGs associated with the root tokens. Metafield indications may also indicate external services as being responsible for determining whether to initiate token transfers.

Other means of associating tokens to graphs such as DAGs may be performed in accordance with some embodiments. For example, such means may not involve ownership changes but the assignment of access rights. Additionally or alternatively, such access rights may be expressed using access control lists (ACL).

While specific processes and smart contract configurations are described above with reference to FIGS. 24A-24B, directed acyclic graphs may be implemented in any of a number of different ways to enable as appropriate to the requirements of specific applications in accordance with numerous embodiments of the invention. Additionally, the specific manner in which token ownership configurations may be utilized within NFT platforms in accordance with certain embodiments of the invention is largely dependent upon the requirements of a given application.

III. NFTs Owning Other Tokens—Implementations

As suggested above, systems and methods in accordance with various embodiments of the invention may implement NFT smart contracts capable of instantiating NFTs that are capable of owning their own NFTs.

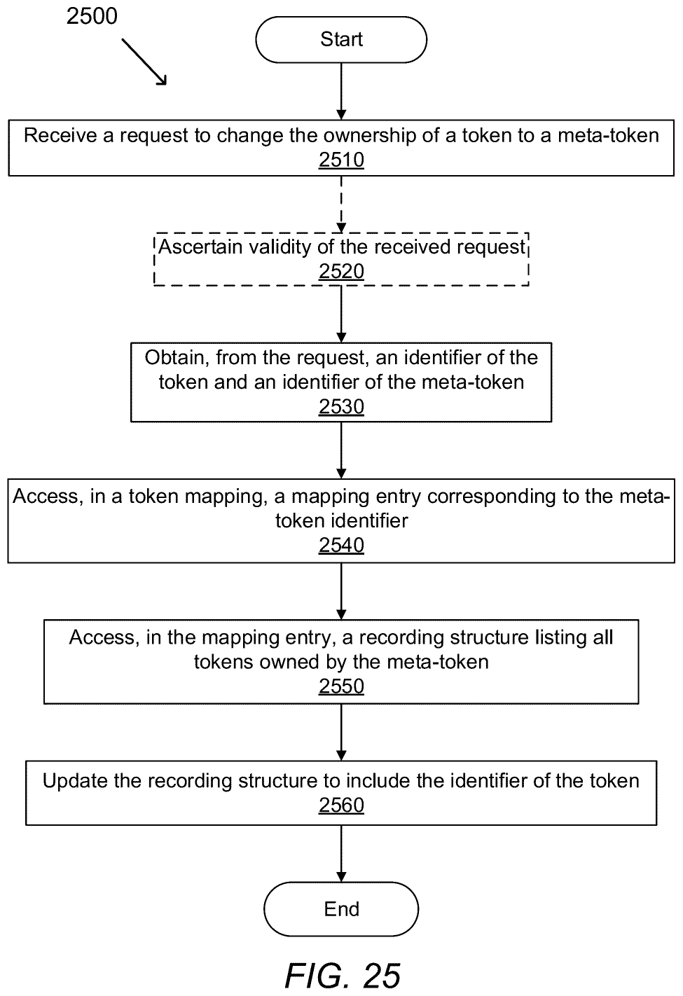

A process utilized in changing ownership of tokens, configured in accordance with many embodiments of the invention, is illustrated in FIG. 25. Process 2500 may, in accordance with various embodiments of the invention, be performed through smart contracts. Smart contracts used to change token ownership may be associated with the destination (meta-)token(s) and/or the token(s) experiencing the change in ownership. Additionally or alternatively, the association between smart contracts and particular tokens may mean that the smart contracts instantiated the tokens. Process 2500 receives (2510) a request to change the ownership of a token to a meta-token. Requests including but not limited to requests for changes in ownership may be initiated by entities with ownership access to particular tokens. As disclosed above, and expounded upon below, ownership access rights may be held by multiple entities simultaneously. Process 2500 ascertains (2520) validity of the received request. Ascertaining (2520) validity may be optional and/or may be performed in order to make sure that the received request is a valid request. Ascertaining (2520) validity may involve, but is not limited to comparing the structure of the request(s) with accepted blockchain protocols; and/or verifying that the request(s) have been digitally signed by one or more entities with ownership access. In accordance with certain embodiments, entities with ownership access may have public keys, for which an associated private key may be used to control changes to the ownership access.

In accordance with various embodiments, process 2500 may depend on one or more token identifiers. Process 2500 obtains (2530), from the request, an identifier of the token and an identifier of the meta-token. As indicated above, token identifiers may include but are not limited to: identifiers specific to the instantiating smart contracts, globally unique identifiers, and identifiers particular to specific marketplaces. Process 2500 accesses (2540), in a token mapping, a mapping entry corresponding to the meta-token identifier. Token mappings may include, but are not limited to listings of the owners and/or right holders of given tokens. Process 2500 accesses (2550), in the mapping entry, a recording structure listing all tokens owned by the meta-token. Owned tokens may include but are not limited to fungible and/or non-fungible tokens. Process 2500 updates (2560) the recording structure to include the identifier of the token.

While specific processes for changing ownership are described above, any of a variety of processes may be utilized to respond to requests as appropriate to the requirements of specific applications. In certain embodiments, steps may be executed or performed in any order or sequence not limited to the order and sequence shown and described. In a number of embodiments, some of the above steps may be executed or performed substantially simultaneously where appropriate or in parallel to reduce latency and processing times. In some embodiments, one or more of the above steps may be omitted.

Token (e.g., ownership) transfers may have a wide variety of effects in accordance with several embodiments of the invention. For instance, when the token already has an owner, the transfer may not remove ownership access to the first owner, but just adds it to the third party (e.g., meta-token). Additionally or alternatively, performing the transfer may depend on approval from parties including but not limited to administrators and/or joint owners. Additionally or alternatively, performing the transfer may depend on conditions (e.g., conditions specific to particular marketplaces).

In accordance with multiple embodiments of the invention, ownership changes may provide various permissions. This may include but is not limited to the ownership changes modifying the underlying tokens in some way. For example, token changes in ownership may initiate token evolution, as disclosed in U.S. patent application Ser. No. 17/929,894, titled “Methods for Evolution of Tokenized Artwork, Content Evolution Techniques, Non-Fungible Token Peeling, User-Specific Evolution Spawning and Peeling, and Graphical User Interface for Complex Token Development and Simulation,” filed Sep. 6, 2022, incorporated by reference in its entirety. Additionally or alternatively, ownership changes may be used as their own conditions (such as resetting timers for particular obligations). In accordance with some embodiments, entities with ownership access may be limited in the amount of ownership changes and/or transfers they may implement. In such cases, the amount may depend on characteristics including but not limited to the addresses of the owning entities and/or smart contracts.

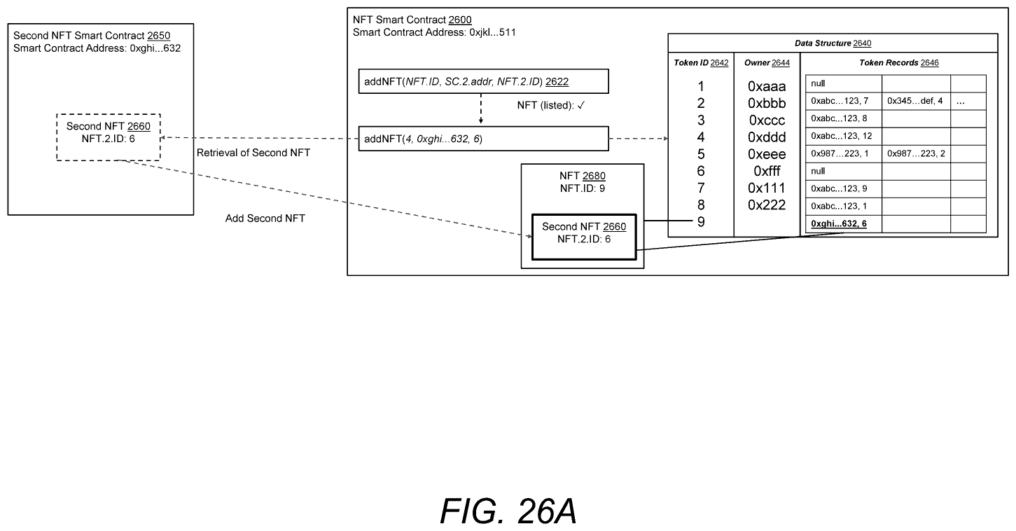

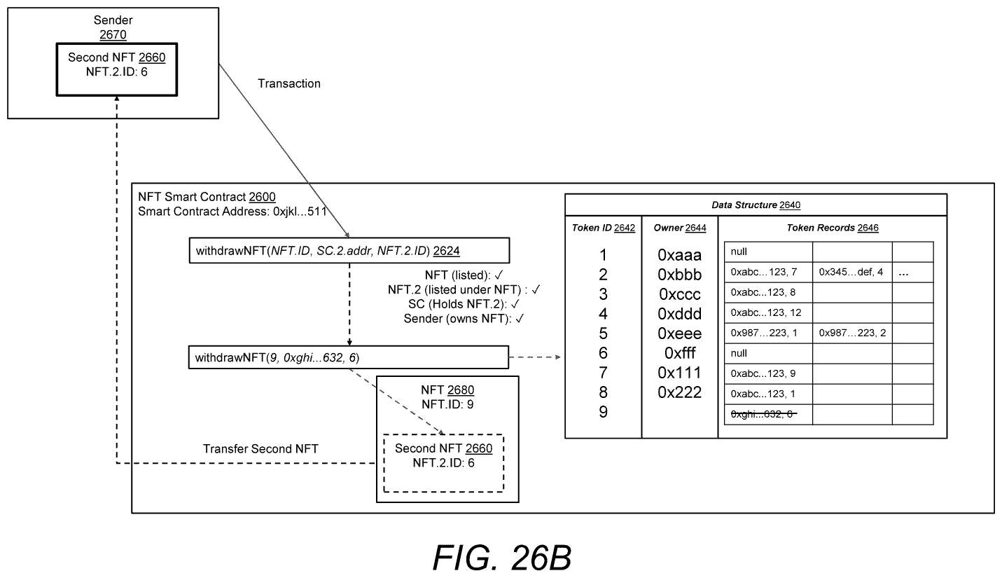

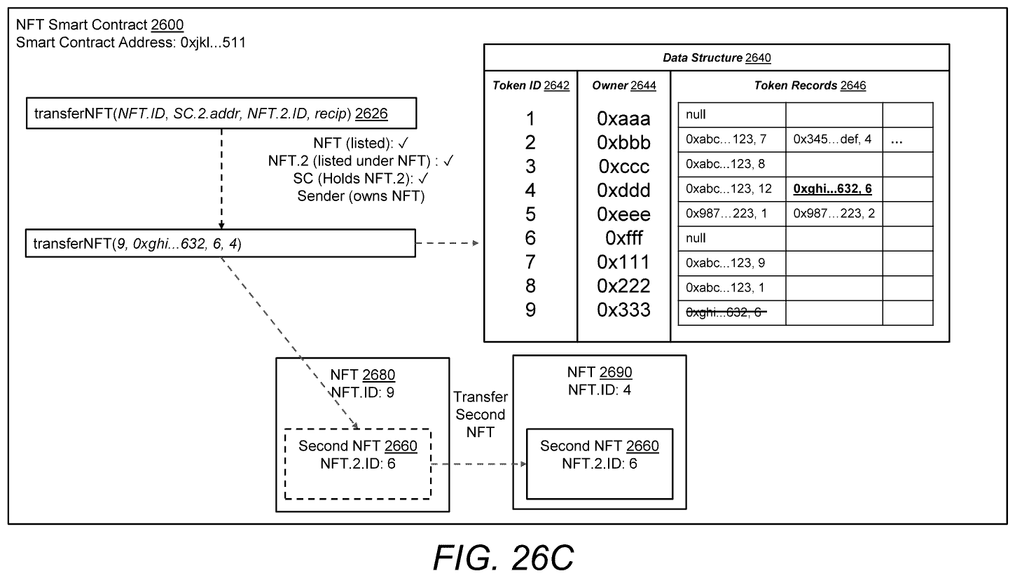

Examples of NFT smart contracts configured in accordance with numerous embodiments of the invention are illustrated in FIGS. 26A-26C. Those skilled in the art will appreciate that in FIGS. 26A-26C, specific parameter values are presented for illustration, that are not meant to be limiting, and that FIGS. 26A-26C should be interpreted without loss of generality. Those skilled in the art will also appreciate that FIGS. 26A-26C are described in the context of the Ethereum blockchain and smart contracts, but the invention and the systems and methods it discloses may be similarly applied to any number of other smart contract blockchains.

In accordance with many embodiments of the invention, NFT smart contracts 2600 may include functions for adding (e.g., addNFT( ) 2622), withdrawing (e.g., withdrawNFT( ) 2624), and transferring (e.g., transferNFT( ) 2624) tokens (including but not limited to NFTs) held by (meta-)NFTs instantiated by the NFT smart contracts 2600.

As indicated above, individual NFT smart contracts 2600 may include, but are not limited to recording structures 2640 that store information regarding NFTs associated with the NFT smart contracts 2600. Associated NFTs that have information stored in the recording structures 2640 may include but are not limited to NFTs that the NFT smart contracts 2600 instantiate and/or NFTs with assets owned by the NFT smart contracts 2600. As indicated above, recording structures 2640 configured in accordance with certain embodiments may include columns corresponding to fields including but not limited to token identifiers 2642, associated owners 2644, and token records 2646.

Rows in the token records column 2646 may include, but are not limited to recording structures used to record information about (any of a plurality of) NFTs that may be associated with and/or instantiated by (any of a plurality of) NFT smart contracts. Recording structure configurations may include but are not limited to arrays, JSON objects, dictionaries, and/or other data structures. For the purposes of illustration, and not meant to be limiting, in FIGS. 26A-26C, examples of a possible recording structure, utilizing an array of arrays, is presented in the token records column 2646.

In FIGS. 26A-26C, token ownership for NFTs instantiated by the NFT smart contracts 2600 (e.g., on the Ethereum blockchain) is recorded by elements in the array. Recording structures configured in accordance with some embodiments of the invention may include one or more elements corresponding to associated tokens. FIGS. 26A-26C represent owned tokens (for each meta-NFT) with individual arrays including two elements: the first element corresponds to a contract address of one of the plurality of NFT smart contracts (e.g., 0xabc . . . 123), the second element corresponds to token identifiers for a second NFT owned by the meta-NFT (e.g., 7). For example, in FIGS. 26A-26C, token 1 owned by owner 0xaaa holds no NFTs (null), and token 2 owned by owner 0xbbb holds two NFTs, namely token number 7 instantiated by smart contract 0xabc . . . 123 and token number 4 instantiated by smart contract 0x345 . . . def.

A function for adding tokens to be owned by NFTs, through NFT smart contracts configured in accordance with various embodiments of the invention is illustrated in FIG. 26A. The NFT smart contracts 2600 of FIG. 26A performs this objective using the addNFT( ) 2622 function, which may take parameters including but not limited to corresponding to token identifiers (NFT.ID) for a “main” meta-token instantiated by the NFT smart contract 2600; SC.2.addr, specifying a second NFT smart contract 2650 address, and NFT.2.ID, specifying a second NFT 2660 instantiated by the second NFT smart contract 2650.

On receiving transactions calling the addNFT( ) 2622 function, the NFT smart contracts 2600 may perform a series of steps to determine whether to add the second NFT(s) 2660 to the (meta-token) NFT(s) 2680 instantiated by the NFT smart contracts 2600. As a prerequisite, the NFT smart contracts 2600 may need to verify that there exist corresponding entries in the token identifier table 2642 of the recording structure 2640 identified by the NFT.ID parameter. When there is, the NFT smart contracts 2600 may receive the second NFT(s) 2660 (NFT.2.ID) from the second NFT smart contracts 2650 (SC.2.addr), and/or withdraw the second NFT(s) 2660 from the second NFT smart contract(s) 2650 when prior approval and/or authorization has been granted to withdraw the second NFT(s). The NFT smart contracts 2600 may add the second NFT(s) to the (meta-)NFTs 2680 represented by the NFT.ID parameter. The NFT smart contracts 2600 may update the entries (in the token identifier table 2642) such that the row entries for the token records 2646 include the SC.2.addr and the NFT.2.ID. FIG. 26A illustrates this process to add a second NFT 2660 (NFT.2.ID=6) instantiated by the second NFT smart contract 2650 (SC.2.addr=0xghi . . . 632) to the (meta-token) NFT 2680 (NFT.ID=9).

Additionally or alternatively, in cases where the (meta-token) NFT 2680 does not have an (additional) owner (as in FIG. 26A), the owner column 2644 may be left blank to represent that the NFT smart contracts 2600 itself owns the token.

A function for withdrawing tokens to be held by NFTs, through NFT smart contracts configured in accordance with several embodiments of the invention is illustrated in FIG. 26B. The NFT smart contracts 2600 configured in accordance with some embodiments of the invention (as shown in FIG. 26B) may perform this objective using the withdrawNFT( ) 2624 function, which may take parameters including but not limited to token identifiers (NFT.ID) for “main” meta-tokens instantiated by the NFT smart contracts 2600; SC.2.addr, specifying addresses of second NFT smart contract(s) 2650, and NFT.2.ID, specifying a second NFT 2660 instantiated by the second NFT smart contract(s) 2650.

On receiving transactions calling the withdrawNFT( ) 2624 function, the NFT smart contracts 2600 may perform a series of steps to determine whether to withdraw the second NFT(s) 2660 from the “main” (meta-token) NFT(s) 2680 instantiated by the NFT smart contracts 2600. As a prerequisite, the NFT smart contracts 2600 may again need to verify that there exist entries in the token identifier table 2642 of the recording structure 2640 identified by the NFT.ID parameter. Additionally or alternatively, NFT smart contracts 2600 may need to verify that they are the owner(s) of the second NFT(s) 2660 identified by NFT.2.ID in the second NFT smart contract(s) 2650 (identified by SC.2.addr); and/or verify that the sender(s) of the transaction(s) are registered as the owner(s) of the (meta-token) NFT(s) 2680 (as identified by the NFT.ID parameter in the owner table 2644).

When the verifications are made, the NFT smart contracts 2600 may transfer the second NFT(s) 2660 to the sender(s) 2670 of the transaction(s). Additionally or alternatively, the NFT smart contracts 2600 may remove SC.2.addr and NFT.2.ID from the entries (in the token records 2646) identified by the NFT.ID parameter, effectively removing the record corresponding to the second NFT(s) 2660. FIG. 26B illustrates this process to withdraw a second NFT 2660 (NFT.2.ID=6) instantiated by the second NFT smart contract 2650 (SC.2.addr=0xghi . . . 632) from the (meta-token) NFT 2680 (NFT.ID=9), and transferring it to the sender 2670 of the transaction.

A function for transferring tokens between meta-tokens through NFT smart contracts configured in accordance with certain embodiments of the invention is illustrated in FIG. 26C. The NFT smart contracts 2600 may perform this objective using the transferNFT( ) 2626 function, which may take parameters including but not limited to token identifiers (NFT.ID) for “main” meta-tokens instantiated by the NFT smart contracts 2600; SC.2.addr, specifying addresses of second NFT smart contracts 2650, identifiers of second NFTs 2660 (NFT.2.ID) instantiated by the second NFT smart contracts 2650; and addresses corresponding to the intended recipients (recip) of the second NFTs 2660.

As indicated above, in accordance with some embodiments of the invention, transfers may be made to destinations including but not limited to (destination) NFTs associated with other smart contracts, in which case the parameters may include identifiers for the respective smart contracts and/or associated tokens; wallets, in which case the parameters may include identifiers for the wallets and/or associated tokens; and other data storage entities (e.g., containers), in which case the parameters may include identifiers for the data storage entities. Nevertheless, the example disclosed in FIG. 26C represents a transfer between two (meta-)NFTs 2680, 2690, both associated with the same NFT smart contract 2600. These transfers may be facilitated by specifying contract addresses for the NFT smart contracts 2600 as an SC.2.addr parameter for the addNFT( ) 2622 function. In essence, in such cases, the NFT smart contract 2600 may be considered the same as the second NFT smart contract 2650, as is disclosed in FIG. 26C. In some cases, this feature may be applied recursively.

On receiving transactions calling the transferNFT( ) 2626 function, the NFT smart contracts 2600 may perform a series of steps to determine whether to transfer the second NFTs 2660 from the “main” (meta-token) NFTs 2680 instantiated by the NFT smart contracts 2600. As a prerequisite, the NFT smart contracts 2600 may again need to verify that there exist entries in the token identifier table 2642 of the recording structure 2640 identified by the NFT.ID parameter. Additionally or alternatively, the NFT smart contracts 2600 may need to verify that the NFT smart contracts 2600 are the owners of the second NFTs 2660 identified by NFT.2.ID in the second NFT smart contracts 2650 (identified by SC.2.addr); and/or verify that the senders of the transactions are registered as the owners of the (meta-token) NFTs 2680 (as identified by the NFT.ID parameter in the owner table 2644).

When the verifications are made, the NFT smart contracts 2600 may transfer the second NFTs 2660 to the recipients of the transactions. Additionally or alternatively, the NFT smart contracts 2600 may remove the NFT smart contract 2650 addresses and second NFT 2660 identifiers from the entries in the token records 2646 identified by the NFT.ID parameters. Additionally or alternatively, the NFT smart contracts 2600 may update the entries in the recording structure 2640 identified by the recipient parameters, such that the row entries for the token records 2646 include the SC.2.addr and the NFT.2.ID used in calling the transferNFT( ) 2626 function.

In instances where the second NFTs 2660 are being transferred to an external entity (e.g., tokens associated with different smart contracts, wallets, data storage entities, and/or containers) the NFT smart contracts 2600 may be prevented from adding the new locations to the token records 2646 following the structure disclosed in FIG. 26C. Nevertheless, in such cases, systems and methods configured in accordance with various embodiments of the invention, may have independent records of external transfer recipients.

Systems and methods in accordance with several embodiments of the invention, in which resources (including but not limited to non-fungible tokens) may own other resources (e.g., other tokens, and/or access rights), may facilitate ownership changes. Additionally or alternatively, resources (such as tokens) may have policies that identify various ownership-based requirements including but not limited to the manners in which ownership may be changed and/or other operational decisions as required to manage and/or realize the value of the resource. Such policies may be associated with the resources at the time of the creation of the resources, including but not limited to when NFTs are minted. Additionally or alternatively, policies may be added afterwards. Later-added policies may be facilitated through means including but not limited to appointing one token as the owner for other policy-related tokens; and/or associating smart contracts with tokens, where the smart contracts identify the added policies.

In accordance with numerous embodiments, policies may be added by the current owners of resources. The adding of policies may be governed by their own policy-adding policies. Policies may be required and/or allowed based on the jurisdictions to which the resources are transferred, used, and/or executed.

In accordance with some embodiments policies for tokens may be governed by the rules of the blockchain on which the tokens are recorded. Potential blockchain-based policies may, for example, be used to enable security mechanisms in which ownership changes may be selectively reversed in case of the identification of triggering conditions by trusted parties. In such cases, triggering conditions may include but are not limited to evidence of fraud. Additionally or alternatively, parties capable of reverting security mechanisms may include but are not limited to consumer representatives, operators on the blockchain, law enforcement entities, etc.

In accordance with various embodiments, policy-directed functionality may be implemented using smart contracts that are associated with the resources, where these smart contracts may specify how ownership modifications may be reversed. Such specifications may take the form of one or more rules, which may be expressed as policies. The use of such policies to modify rights (e.g., to transfer of ownership) may, additionally or alternatively, be applied to other rights, including but not limited to rights to modify content (e.g., update with new insights); to redact incorrect and/or illegal content; and/or to access associated resources, (such as databases), using the token ownerships as access control mechanisms.

Policies such as those described above are not only useful in the context of tokens owning tokens, but also in traditional settings, as will be appreciated by a person of skill in the art; thus, the techniques disclosed herein apply both to contexts where resources (such as tokens) are owners, and where traditional entities (such as persons and/or corporations) are owners.

The technique of controlling rights based on policies associated with resources may be used to create new applications. Systems and methods in accordance with many embodiments may be used to create new services and technology uses. Potential examples of the limiting capabilities of policies may include but are not limited to:
1. Identifying resources associated with tokens, where the tokens may be NFTs and/or fungible tokens. Associated resources may include but are not limited to the ability to access data, the ability to transfer and/or modify access rights (e.g., ownership rights), the ability to modify policies, the ability to cause changes to the token;
2. Determining at least one limitation associated with the tokens. An example limitation may be whether ownership rights may be modified, and when so, under what circumstances; another may be whether the token may be transferred without the automatic payment of taxes and royalties;
3. Associating, in (e.g., third-party verifiable) manners, limitations with tokens. In accordance with some embodiments of the invention, limitations may be associated with tokens by recording the limitations and (and corresponding references) to the associated tokens; recording the limitations and storing references from the tokens to the limitations; modifying tokens and/or corresponding meta-tokens; and/or updating data related to smart contracts associated with the tokens; and/or
4. Applying limitations to tokens and verifying compliance. In accordance with various embodiments, limitations may be applied to (and/or verified for) the tokens by policy-compliant entities. It should be noted that it does not matter whether all entities who could act as verifiers related to the tokens (e.g., to determine ownership) themselves comply with the proper verifications of the limitations. This is because, for specific token platforms (e.g., token marketplaces and/or blockchains) as long as a sufficient portion of such verifiers do comply with the verification protocols, the value of tokens processed in a manner that is inconsistent with the associated limitations (e.g., due to willful blindness of one or more entities) may still be degraded. Potential applications of limitations may include but are not limited to making the transfer invalid, making the action invalid, and/or making the token invalid in the view of compliant entities. As a result, systems operating in accordance with various embodiments may cause rational entities to avoid causing such damage to the tokens and their associated values.

For example, tokens marketplaces and/or blockchains in accordance with some embodiments, may refuse to accept tokens whose associated policies have, in past transactions, been disregarded (and/or for which compliance is not verified). Their refusal may end up reducing the utility of these tokens by restricting their use on such marketplaces and/or blockchains, thereby reducing the associated value. The more services agree to be bound by the policies and/or enact penalizing actions for tokens and/or other entities associated with a disregard for policies, the greater the loss of value becomes when the token policies are willfully ignored.

In accordance with many embodiments of the invention, non-compliance with policies may lead to a significant drop in value for tokens. The marketplaces and/or blockchains in question may apply penalizing actions to the tokens through penalties including but not limited to refusing to process such tokens and/or agreeing to limiting and/or modifying the actions that may be taken for the tokens. Additionally or alternatively, penalties may be applied to users (e.g., owners of tokens whose policies were ignored during and/or prior to the ownership of these owners of the tokens) and/or processing entities (e.g., other marketplaces and blockchains). In such cases, the application of penalties may correspond to a greater loss of value.

Therefore, the ability to publicly verify the current and past compliance with policies associated with tokens may be considered valuable. Such verification may be achieved, for example, by reference to databases of information that are continuously maintained and are indelible. An example of such a database may correspond to the storage functionality a blockchain implements. The entities that may verify compliance, to protect their associated users against future loss of utility and value, may include but are not limited to: marketplaces, blockchains, escrow entities, consumer representatives, wallets, security service providers, and search engines.

In accordance with a number of embodiments, owners of tokens may wish to explicitly disavow actions of second parties including but not limited to co-owners, when the owners perceive such actions to be detrimental. Detrimental actions may be undertaken through (but are not limited to) accident, incompetence, malice, and/or pre-determined reasons. Owners of tokens may determine that actions may be detrimental, and may thus result in sanctions and/or penalties from other participants in the community. The owners may wish to avoid such sanctions and/or penalties. Functionality within token instantiating smart contracts and/or other smart contracts may enable owners to register records of the owners' disavowal of the actions. Subsequently, other participants in the community may detect the disavowal and may decide not to apply the sanctions and/or penalties to the owners.

In accordance with numerous embodiments of the invention, transfer of resources, including but not limited to tokens, from a first party to a second party may be based on conditions. Systems in accordance with various embodiments may indicate that transfer should only succeed when one or more conditions are satisfied, including but not limited to the completion of a second transfer from the second party to the first party (i.e., an exchange). This is a situation in which a middleman including but not limited to escrow authorities are often used, and wherein these escrow authorities are provided with both the first and the second resource/token, after which it verifies the correctness of the exchange. Such verifications may determine whether the first and second resources correspond to the expectations of the two parties wishing to exchange the resources with each other. Conditional on the correctness, escrow authorities may provide the resources to the parties for which they were intended; otherwise, after a specified amount of time and/or arrival of some specified event, the escrow authorities may undo the exchange by returning the received resource(s) to the originating parties. Systems in accordance with many embodiments may refer to these escrow solutions as “online” escrow solutions, as the escrow authorities are involved in each and every transaction and need to perform actions before the transactions may complete.

In accordance with various embodiments, “offline” escrow solutions may be created. Herein, a first party has access to a first resource and a second party has access to a second resource. The two parties agree on terms, which correspond to one or more policies. An example of such a set of policies may be: “Party 1 will send token A to party 2, and party 2 will send token B to party 1. When token A has not been received by party 2 within time t1 of the recording of the transmission of token B by party 1, then escrow authority C is instructed to reverse the transfer of token A and perform an additional optional action X.” The above set of policies only addresses one of the directions of transfer. Bi-directional policies are also possible, for example: “When token A has not been received by party 2 within time t1 of the recording of the transmission of token B by party 1, then escrow authority C is instructed to reverse the transfer of token A and perform an additional optional action X. Moreover, when token B has not been received by party 1 within time t2 of the recording of the transmission of token A by party 2, then escrow authority C2 is instructed to reverse the transfer of token B and perform an additional optional action X2.” Here, C2 may be the same as C, and X2 may be the same as X, but they do not have to be the same.

For concreteness, policies configured in accordance with some embodiments may specify the parameters of any transfers. For example, policies may specify what blockchains and/or other public storage will be used to record any transfers. Furthermore, policies involving three or more parties exchanging resources may be specified. This may be expressed using one or more policies. The set of policies may be digitally signed by one or more parties associated with the exchange, and the digitally signed policies may be referenced and/or included in the recording of the transfer(s) these parties perform.

When transactions including multiple transfers are not completed according to the one or more policies, then the parties associated with the transaction and/or representatives thereof may file a complaint. The complaints may be received by escrow authorities, which verify, by reviewing the blockchain entries of relevance to verify that the complaint is correct and the claimed failed transaction indeed was failed (e.g., incomplete, and/or not matching the one or more policies). The escrow authorities may, additionally or alternatively, verify the correctness of the digital signature(s) on the policies. Based on a determination that complaints are legitimate, which may also involve verification of temporal aspects such that at least a specified time has elapsed and/or no more than another specified time has elapsed since a specified event, the escrow authorities may reverse and/or otherwise modify the transactions. Specifically, this may be enabled due to the corresponding identities and/or public keys being specified in the policies, and the failure of the transaction according to the policies capable of being publicly verified. Thus, by digitally signing ownership changes using private keys, the escrow authorities may reverse selected transfers and/or otherwise modify the transactions according to the policies. These techniques are also applicable to situations where at least some of the actions are applied by the escrow authorities online. Thus, the approach benefits from being flexible in terms of the involvement of the escrow authorities.

Escrow functionality enabled in accordance with various embodiments may, additionally or alternatively, be implemented using smart contracts. In accordance with some embodiments, smart contracts may be implemented with functionality for receiving and subsequently transferring tokens, including but not limited to one or more of: fungible tokens including but not limited to those specified by ERC-20 (Ethereum Request for Comments 20), non-fungible tokens including but not limited to those specified by ERC-721 (Ethereum Request for Comments 721), mixed fungible/non-fungible tokens including but not limited to those specified by ERC-1155 (Ethereum Request for Comments 1155), and/or some other class/type of token.

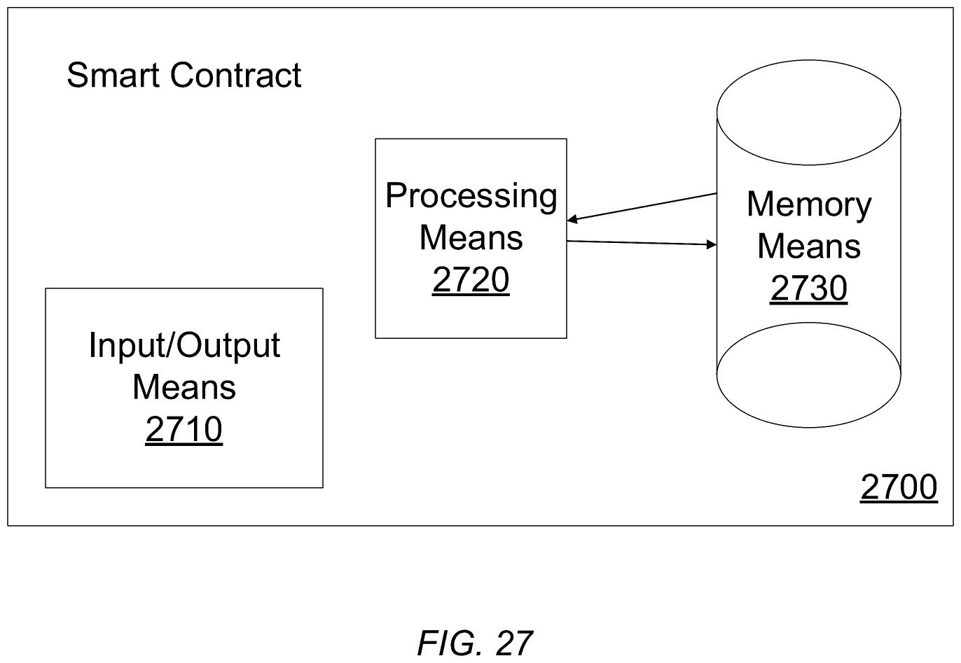

A physical model of smart contracts configured in accordance with various embodiments of the invention is illustrated in FIG. 27. The smart contract 2700 includes memory 2730, input/output means 2710, and processing means 2720 configured for transactions including but not limited to minting and/or transfer of tokens (including but not limited to NFTs).

Memory means 2730 may include but are not limited to instructions, which when executed by the processing means 2720 may allow the smart contract 2700 to perform various methods configured in accordance with several embodiments of the invention. Additionally or alternatively, the smart contract 2700 methods may be implemented through mediums including but not limited to servers, computers, smartphones, cloud servers and/or any entity/arrangement with processing means.

The smart contract 2700 also includes input/output means 2710 that may enable communication for the smart contract 2700. Smart contracts 2700 may utilize input/output means 2710 to receive, transmit and/or provide information to other units, devices and/or entities.

Transactions for transferring any number of tokens may, in accordance with numerous embodiments, include one or more of: addresses of (an array of) potential end recipients; expected payment type, which may include one or more token types and/or instances; expected payment amount, which may include a list of expected payment amounts corresponding to the one or more token types and/or instances; time periods during which payment in exchange for the token(s) is to be accepted; and/or deadline(s) by which payment in exchange for the token and/or number of tokens must be received for an exchange to happen.

As indicated above, in accordance with certain embodiments, when a suitable payment is not made within the listed time period(s) and/or deadline(s), the originator(s) of the transaction(s) may be able to reclaim the token(s) transferred to the smart contract(s) and/or escrow authorities. Additionally or alternatively, when suitable payments are made by suitable end recipients, the smart contract(s) and/or escrow authorities may transfer the payments to the originator(s) of the transaction(s) and/or transfer the token(s) to addresses of the suitable end recipient(s). In particular, the suitable end recipients may include but are not limited to the potential end recipient and/or element(s) within the array of potential end recipients.

In accordance with many embodiments, escrow authorities may be tasked with evaluating one or more policies related to the escrow functionality, as described above. Additionally or alternatively, escrow authorities may be tasked with evaluating one or more policies related to additional functionality to conditionally be performed. These additional functionalities may be triggered by the outcome of the evaluation of the one or more policies related to the escrow functionality. For example, some additional functionalities may be conditional on the matching of escrow policies; on the failure to match escrow policies; and/or the completion of determinations related to escrow outcomes. For example, additional functionality may implement, but are not limited to, the collection of royalties (conditional on transfers completing); the registration of ownership in encrypted databases (conditional on the transfer completing, and optionally on the jurisdiction(s) of the parties involved in the transaction; the reporting of potential abuse (e.g., conditional on the failure of transfers); etc.

In accordance with some embodiments, escrow authorities may be permitted and/or required to perform services and/or actions related to one or more resources being transferred. For example, escrow authorities may have the right to invest transferred funds and/or obtain the earned interest, as a payment for its services. In such cases, the escrow authorities may be allowed to perform investments for the duration of particular escrow periods. The escrow authorities may be limited by one or more policies, implicit and/or explicit, that identify what types of investments they are allowed to perform (e.g., to limit risk). Escrow authorities may, additionally or alternatively, be explicitly paid as part of performing their duties, including but not limited to by being the indicated recipient of payments associated with the transfers. The escrow authorities may, additionally or alternatively, saddle responsibilities as part of their efforts to transfer the tokens; for example, they may insure the proper escrowing of the assets, backed by deposits made with third parties (e.g., insurance originators). The escrow authorities may, additionally or alternatively, be tasked with verifying the security of the pending transactions, including but not limited to verifying the authenticity of the transferred assets; verifying that none of the parties involved is a known scammer and/or has performed actions indicative of abuse, etc.

In accordance with a number of embodiments, the escrow authorities and/or associated parties may, during the escrow process, discover errors (e.g., in title ownership) and/or wrongdoing (e.g., attempts at fraud, and/or indications of the likelihood of such). In these cases, the escrow authorities may involve additional parties including but not limited to government recording offices and/or law enforcement. Additionally or alternatively, the escrow authorities may perform auditing, logging and/or verification tasks on behalf of such entities. The escrow authorities' terms of service may define this capacity in a way that differentiates various escrow authority services from each other. For example, some may differentiate by being more discreet about sharing escrow obstacles while others may differentiate by being more public about obstacles and/or processes.

After transfers have been completed, systems in accordance with numerous embodiments may take post-transfer actions. These may be mandatory actions and/or conditional actions governed by one or more policies that are evaluated relative to the transfers. In accordance with some embodiments, escrow authorities may have the capability to grant access rights to data. For example, access rights may be granted access through decrypting key safes and transmitting the corresponding keys to the parties who should be granted access (e.g., read access). Key safes may be encrypted records that are part of and/or associated with tokens. The parties who should be granted access may coincide with the parties to whom ownership access rights are transferred.

Additionally or alternatively, access rights may be granted to different sets of parties, whether overlapping and/or not. Parties that may be granted access in accordance with numerous embodiments include but are not limited to auditors that determine that content is approved and legal in given jurisdictions and/or classes of users. In accordance with many embodiments, auditors may grant further access to content, and/or refuse to grant such access, based on such certain determination. These determinations may be based on but are not limited to policies (such as what groups of users are allowed to access what types of content); content descriptors (such as “X-rated”); and information related to the parties to whom access is tentatively to be granted (e.g., whether they are certified to be adults, whether they are certified to be system admins, etc.)

Tokens may, additionally or alternatively, be modified based on determinations made by access granted parties (e.g., auditors), and/or by escrow authorities. For example, content may be redacted, partially given access to, degraded based on subscription level and/or security clearance, etc. Tokens may, additionally or alternatively, be evolved in response to transfers, where the evolution may be conditional on characteristics including but not limited to whether the recipient user(s) is a certified person as opposed to a potential bot, whether the recipients are adults, whether the recipients have ever been in possession of the tokens considered, etc. Tokens may, additionally or alternatively, be destroyed as a result of transfers. Destruction may be based on determinations including but not limited to fraud and/or unauthorized transfer.

In accordance with certain embodiments, as token transfers are made, the associated token transfers may be associated with counters and/or timers; and/or have already-associated counters and/or timers updated. The counters and/or timers may be used to determine whether conditions are satisfied, which may be used in the evaluation of policies that determine what actions to take on tokens. For example, one particular token may be associated with a policy that states that the token needs to be transferred to a new owner who has never possessed the token, that such transfers must be made within 48 hours of the previous transfer, and/or when this is not done, then the token is considered expired. In such examples, after counters/timers meet particular thresholds, the tokens may expire and be burnt (i.e., destroyed) when processed. Such processing may be performed by escrow authorities and/or other entities associated with the transfer of the token, including but not limited to marketplaces. In accordance with some embodiments, rewards may be provided to entities that take action on tokens based on such policies.

While specific smart contract configurations are described above with reference to FIGS. 26A-27, smart contracts may be incorporate various attributes as appropriate to the requirements of specific applications in accordance with a number of embodiments of the invention. Additionally, the specific manner in which token ownership may be facilitated by smart contracts utilized within NFT platforms in accordance with multiple embodiments of the invention is largely dependent upon the requirements of a given application.

IV. NFT Ownership Management

As indicated above, in accordance with certain embodiments, changes in ownership access may go beyond general transfers of ownership status (e.g., from party A to party B). In accordance with some embodiments, ownership access may be split (e.g., change from party A to party A and party B). Additionally or alternatively, changes in ownership access may be partial (e.g., from party A, B, and C to party A and C). Ownership may, additionally or alternatively, be interpreted as access complying with specific (ownership) policies, which may follow various structures. For example, certain ownership policies may allow one owner to have different access rights than others; for example, it is possible for A, B, and C to have ownership access where A may change the ownership status in any way it wishes, and/or B and C may add and remove owners as long as they do not remove A.

The rules for how ownership access may be modified may be governed by policies associated with tokens. Further, when two tokens are combined (through means including but not limited to one taking ownership of the other) then the (meta-)token that is the owner may impose its ownership access structure on the (wrapped) token that is owned. Additionally or alternatively, the meta-token that is the owner may select and/or impose other structures.

In accordance with certain embodiments, ownership may be fractionalized to identify the portion(s) of ownership rights that given parties have. These rights may pertain to what the owners receive when there are changes of ownership access and/or the manner in which the owners have the right to modify the ownership. The policies for the rights and the access may be the same or different, and all the methods disclosed herein apply to both of these notions (i.e., rights and access). In various embodiments, polynomial structures (e.g., k-out-of-n structures) may be used to govern rights and access, including but not limited to rights and/or access with different thresholds.

Additionally or alternatively, in accordance with various embodiments of the invention, the documentation of the provenance defined by transfers (i.e., the flow of assets and liabilities among the parties) may vary. For example, transfers may be documented (e.g., on blockchain) as permanent records. Additionally or alternatively, only the final ownership of assets may be documented while the flow of assets and liabilities among the parties may be intentionally obscured.

Limitations may be associated, in accordance with numerous embodiments, with tokens and users through modes including but not limited to policies associated with the tokens and/or users. One way to associate policies with tokens may be to include the policies (and/or references to them) in tokens. Another way may be to include the policies and/or references thereto in associated smart contracts. Yet another way may be to associate the policies with the parties that minted the tokens, allowing determination of the policies by looking up records associated with these parties. The policies may, additionally or alternatively, be associated with jurisdictions including but not limited to jurisdictions where the tokens were minted; where the tokens are currently owned; and/or from which the tokens the resources may be accessed. In accordance with some embodiments, policies may indicate the terms under which the tokens may be transferred (e.g., to what types of entities, how many times the tokens may be owned by one entity, how many times the tokens may be sold) and/or accessed (e.g., whether royalty payment must be made for each access and when so, how much has to be paid; whether anybody may access the information and/or only members of some groups, including but not limited to subscribers, adults, employees of an organization and/or citizens of given country). The policies may be complex (e.g., specifying rules of how the tokens may be transferred and/or at what price they may be sold, based on the number of previous transfers they have been part of). The policies may depend on outside information, including but not limited to information provided by oracles, information on user condition (e.g., whether they are alive, time of year), and/or information on specific conditions (e.g., something as specific as whether there is a heat advisory in effect).

Systems and methods in accordance with numerous embodiments of the invention may support different types of transfers. For example, in terms of the number of parties, transfers may be characterized as being 1 party to N parties (e.g., a last will and testament); N parties to 1 party (e.g., tender offer for shares of a company); and/or N parties to N parties (e.g., typical escrow acceptance and redistribution of assets). The type of transfer may be limited by, governed by, and/or required by one or more policies, which may be associated with tokens as described above. Moreover, one or more policies may stipulate aspects related to asset conversion. For example, assets may be simply accepted and redistributed; additionally or alternatively, assets may be manipulated (e.g., stock portfolios liquidated before redistribution; raw materials converted to final form). Policies may indicate temporal aspects, including but not limited to when a transfer must take place ASAP, when a transfer must take place when practical, when a transfer must take place in a manner governed by a defined schedule, when a transfer must take place “not sooner than [event]”, and/or when a transfer must take place “before [event]”. In accordance with many embodiments, entities including but not limited to escrow authorities may be informed of any quality of service requirements and timing considerations of importance.

Ownership of tokens may confer rights, and these rights may be distinct from the fundamental concept of ownership. In many jurisdictions, a distinction is made between ownership (that is, title to an asset), and possession (that is, to have immediate control over and/or access to the asset). At the present time, most when not all tokens are implemented in a manner that conflates ownership, possession, and access to rights. when an owner wishes to confer some or all of the rights that come with ownership of tokens to a second party, there may be a need to be able to separate ownership from such rights.

For example, tokens may provide access to services including but not limited to online games (that is, the token is required to log on to the game), online conferencing services, and/or document repositories. In another example, tokens may represent, but are not limited to, assets within services. For example, tokens may provide editing rights within a service such as a document repository. In doing so, a token may be required to edit and/or delete a document within the document repository. Another example of tokens representing assets within services is item possession within games (e.g., weapons and/or vehicles).

In accordance with several embodiments, quorums may be needed to perform actions including but not limited to allowing content access. This may be implemented in smart contracts by smart contract terms identifying what constitutes a valid quorum. Such determinations may be based on policies, polynomial access structures, and/or sets of rules, such as a point-based system wherein different tokens are associated with different numbers of points. Other access control structures may be implemented in the same manner, as will be understood by a person of skill in the art. For example, such structures may require collections of participants to agree to actions, wherein the collections may correspond to valid quorums as identified by the smart contracts of the associated tokens. In accordance with various embodiments, smart contracts may have to be part of the same family of smart contracts, e.g., issued by the same content creators, digitally signed by the same mint, and/or generated from the same tokens. Additionally or alternatively, each smart contract in a collection may carry lists indicating what other contracts are acceptable and may be part of the quorum, where these contracts may be identified by but are not limited to their cryptographic hash value (i.e., digest); by identifiers of the token creators, and/or references to publicly accessible lists of identifiers of such smart contracts and/or associated tokens.

In accordance with some embodiments, tokens may be instantiated in a manner that separates ownership from rights conferred by ownership through smart contracts while preserving legacy functionality. This may be done in a manner similar to that provided by ERC-721 (Ethereum Request for Comment 721), incorporated by reference in its entirety.

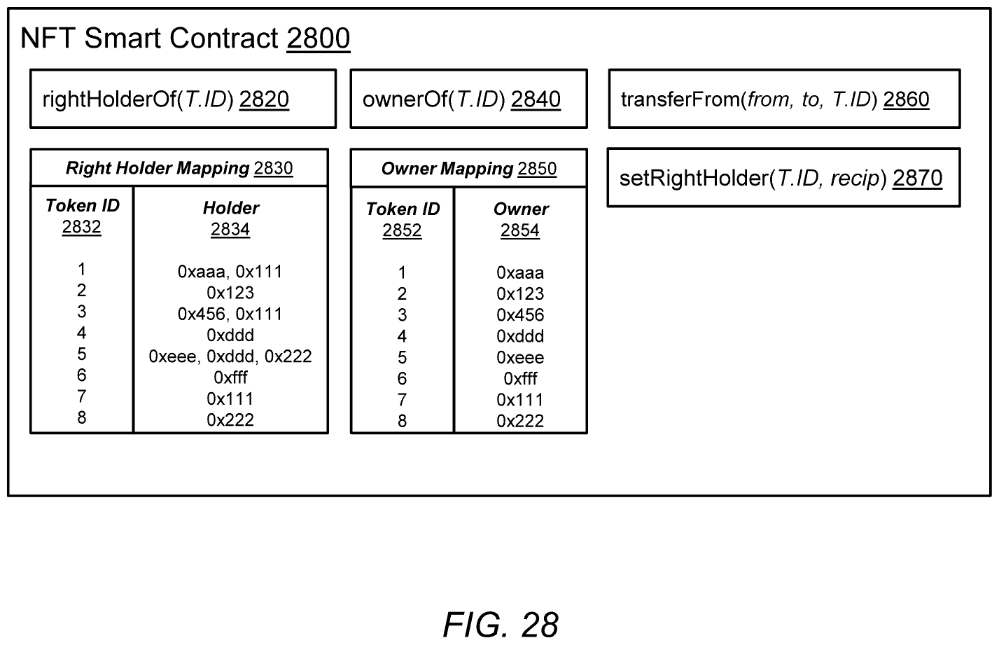

A diagram of an NFT smart contract configured in accordance with multiple embodiments of the invention, for separating token ownership from conferred token rights, is illustrated in FIG. 28. NFT smart contracts 2800 may include a variety of functions for distinguishing token-related rights, including but not limited to transfer functions (e.g., transferFrom( ) 2860), functions for recovering the right holders for certain tokens (e.g., rightHolderOf( ) 2820), functions for recovering the owners for certain tokens (e.g., ownerOf(2840), and/or functions for setting right holders (e.g., setRightHolder( ) 2870 functions). Additionally or alternatively, smart contracts configured in accordance with many embodiments of the invention may include one or more data structures 2830, 2850.

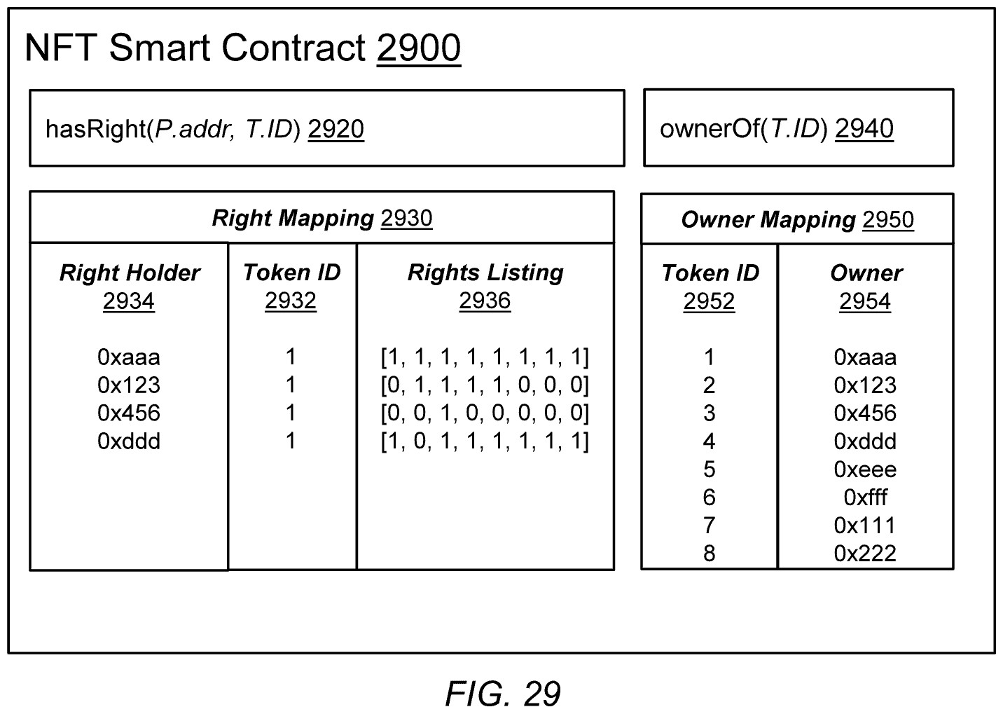

Data structures 2850 may include various mapping including but not limited to owner mappings 2850 and/or right holder mappings 2830. Owner mappings 2850 may be used for recording the owners of minted tokens (e.g., NFTs). Owner mappings 2850 may include but are not limited to lists of associated tokens (Token IDs 2852) for the NFT smart contracts 2800 and owner columns 2854 for recording owners of individual minted tokens (e.g., NFT). NFT smart contracts 2800 may, additionally or alternatively, include right holder mappings 2830. Right holder mappings 2830 may include but are not limited to lists mapping tokens (Token IDs 2832) to corresponding right holders 2834. Right holders 2834 may include but are not limited to possessors of access rights associated with individual minted token(s). Such access rights may include but are not limited to the right to consume the digital assets associated with the tokens, the right to rent out the tokens, the right to make derivative tokens, etc. Potential rights are expanded upon below in relation to FIG. 29.

As mentioned above, a number of functions may be used to facilitate the distinction between owners 2854 and right holders 2834. For example, calls to the rightHolderOf( ) 2820 function, through inputting token identifier(s) (T.ID) for at least one token, may return one or more addresses, taken from the right holder mapping 2830, that correspond to right holders 2834 for the corresponding token(s). For example, under the NFT smart contract 2800 in FIG. 28 calling the rightHolderOf(5) 2820 function, may output the addresses for the three right holders 2834 for the token possessing the T.ID of 5 (addresses 0xeee, 0xddd, and 0x222).

Additionally or alternatively, calls to the ownerOf( ) 2840 function, through inputting token identifier(s) (T.ID) for at least one token, may return one or more addresses, taken from the owner mapping 2850, that correspond to owners 2854 for the corresponding token(s). For example, the NFT smart contract 2800 in FIG. 28 calling the ownerOf(5) 2820 function, may output the address for the owner for the token possessing the T.ID of 5 (address 0xeee). Despite the owner 2854 column in FIG. 28 having singular entries for convenience; as disclosed above, multiple entities may have joint ownership over particular tokens.

In accordance with numerous embodiments of the invention, third parties may be able to use the ownerOf( ) 2840 and/or rightHolderOf( ) 2820 function to determine any number of allowances (e.g., for verification purposes). For example, to log onto game servers associated with certain tokens, some user(s) may need to sign authentication challenges, provided by the game servers with their address(es). The game servers may require the user(s) to provide the signed challenge(s) and specific token identifier(s). The game servers may verify the signature(s), extract the address(es), and use the ownerOf( ) 2840 and/or rightHolderOf( ) 2820 function to verify that the extracted address(es) of the user(s) match to the owner and/or right holder address(es) associated with the specific token identifier(s) before allowing the user(s) access to a game.

In accordance with various embodiments, the transferFrom( ) 2860 function may allow token owners to transfer their tokens. Calls to the transferFrom( ) 2860 function may involve inputting token identifier(s) (T.ID) for at least one token, a sending entity (from), and/or a receiving entity (to). In accordance with a number of embodiments, both sending and receiving entities may take various forms including but not limited to tokens (as described above), wallets, smart contracts, and/or data storage entities.

In accordance with many embodiments of the invention, when the transferFrom( ) 2860 function is called, verification of authorization to send and/or receive the underlying token(s) may be performed by NFT smart contracts 2800. For example, NFT smart contracts 2800 may be configured to verify that any receiving entities are listed (in the right holder mapping 2830) as right holders of the tokens before executing the function call to transfer ownership of tokens. This verification may be performed through a direct lookup of rights holders 2834 in the right holder mapping 2830, calls on the rightHolderOf( ) 2820 function, and/or some other means. Additionally or alternatively, the transferFrom( ) 2860 function may need to verify that the sending entity is the owner of the token. This verification may be performed through a direct lookup of owners 2854 in the owner mapping 2850, calls on the ownerOf( ) 2840 function, and/or some other means.

In accordance with many embodiments of the invention, upon minting and/or transfer of individual tokens, smart contracts 2800 may set the receiving entity (in the transferFrom( ) function call) to become a right holder 2834 and/or owner 2854 of the token. In such cases, the right holder 2834 and/or owner 2854 corresponding to the token identifier 2832, 2852 may be set to the receiving entity address in the right holder mapping 2850 and/or the owner mapping 2830.

In accordance with certain embodiments, token owners may be able to set right holders using the setRightHolder( ) 2870 function. In accordance with a few embodiments, the setRightHolder( ) 2870 function may take, as input, parameters including but not limited to token identifier(s) (T.ID) for at least one token and/or addresses corresponding to the intended recipient of the right holder status (recip). Additionally or alternatively, in accordance with some embodiments, the setRightHolder( ) 2870 function may take, as input, an identification of the specific rights being granted. In some cases, smart contracts 2800 may specifically be able to execute transactions calling the setRightHolder( ) 2870 function when the transaction is submitted and/or signed by the owner(s) of the token(s).

Tokens may have permissions to perform actions associated with them by entities (that do not have to be their owners). The permission to perform such actions may be referred to as “possession” herein. Different types of access rights for different entities may be implemented as part of possession policies. A first token that owns and/or possesses a second token, may be permitted to perform actions on and/or related to the second token. The first token may mint a second token; assign and/or be assigned ownership rights and/or possession rights to one or more entities, including other tokens. The first token may be controlled by smart contact terms that take actions based on external events, for example, the number of tokens minted, Additionally or alternatively, the ownership rights of those tokens may be determined by factors including but not limited to which sports team wins a game, the status of a stock (equity) index on a certain date, whether a loan with terms defined by a different smart contract has been paid off and/or is up to date in payments, the success of a region's produce (fruit and/or vegetable) season, sea level rise and/or highest and/or lowest recorded temperature at a defined location on a defined date. The first token may have permissions to perform actions associated with it by an entity (that does not have to be its owner), such as “spend these funds.”

In accordance with various embodiments, NFTs may provide rights to files and/or folders on file systems such as Linux, where rights may include one or more of: reading files, writing to files, deleting files, renaming files, moving files, changing access rights to files for other users, viewing contents of folders, moving folders, deleting folders, renaming folders, etc.

A diagram of an NFT smart contract configured in accordance with various embodiments of the invention, for managing conferred token rights, is illustrated in FIG. 29. NFT smart contracts 2900 may include a variety of functions for managing token-related rights, including but not limited to (as discussed for FIG. 28) functions for recovering the owners for certain tokens (e.g., ownerOf( ) 2940), and/or functions for determining what rights particular parties have in particular tokens (e.g., hasRight( ) 2920). Additionally or alternatively, smart contracts configured in accordance with many embodiments of the invention may include one or more data structures 2930, 2950, including but not limited to rights mapping 2930 data structure(s), and ownership mapping 2950 data structure(s).

As disclosed above, data structures 2950 may include various mapping including but not limited to owner mappings 2950 and/or right holder mappings 2930. Owner mappings 2950 may be used for recording the owners of minted tokens (e.g., NFTs). Owner mappings 2950 may include but are not limited to lists of associated tokens (token IDs 2952) for the NFT smart contracts 2900 and owner columns 2954 for recording owners of individual minted tokens (e.g., NFT).

Further, as disclosed above, the ownerOf( ) 2940 function, through inputting token identifier(s) (T.ID) for at least one token, may return one or more addresses, taken from the owner mapping 2950, that correspond to owners 2954 for the corresponding token(s). For example, under the NFT smart contract 2900 in FIG. 29 calling the ownerOf(7) 2920 function, may output the address for the owner for the token possessing the T.ID of 7 (address 0x111). Despite the owner 2954 column in FIG. 29 having singular entries for convenience; as disclosed above, multiple entities may have joint ownership over particular tokens. A right to transfer the token may, in a number of embodiments, reside exclusively with the owner. In various embodiments, transferability may include a right represented in a rights mapping 2930.

NFT smart contracts 2900 may, additionally or alternatively, incorporate right holder mappings 2930. Right holder mappings 2930 may include but are not limited to lists mapping tokens (Token IDs 2932) to corresponding right holders 2934. In numerous embodiments, the rights mappings 2930 may include structures for indicating which listings of rights 2936 associated with tokens are allocated to which right holders 2934.

Potential rights may cover a wide variety of possible actions related to digital assets and/or tokens corresponding to digital assets. In an example, provided for illustrative purposes and not meant to be limiting in any way, tokens may represent access rights to files within a file system, such rights including but not limited to listing, viewing, editing, copying, moving, and deleting specific assets. Tokens may, additionally or alternatively, include the right to allocate the aforementioned rights to other addresses. Tokens may, additionally or alternatively, include the right to transfer tokens to new owners.

The various rights associated with tokens may be represented through recording structures including but not limited to binary numbers, arrays, and/or other data structures. Those skilled in the art will appreciate that there are many other data structures that may be utilized to represent a collection of rights, but that they are homologous with each other. For the illustrative purposes of the present example, FIG. 29 utilizes a (rights) array of Boolean values, focused on configurations of eight rights. The rights array (R) may represent rights such that an element n, corresponding to a particular right, is represented as R[n].

In accordance with a number of embodiments, smart contracts 2900 may interpret R[0] as an ownership and/or operator right. Ownership rights may permit corresponding addresses to transfer tokens to a recipient address. On transfer, all existing rights for a given token may be deleted from the rights mapping 2930, and a new entry may be added to the rights mapping 2930, mapping the token ID and recipient address to a rights listing 2936 representing an allocation of all the associated rights to the recipient address. In various embodiments, the ownership mapping 2950 may be replaced by the rights mapping 2930, as those skilled in the art will appreciate, under the assumption ownership is a right (e.g., R[0]) and may be represented in and queried from the rights mapping 2930.

Additionally or alternatively, NFT smart contracts 2900 may interpret R[1] as a right to assign rights to other addresses and/or remove rights from other addresses. In some embodiments, the right to assign rights and the right to remove rights may be implemented as separate rights represented by separate entries within the rights listing 2936 and/or rights data structure.

In this disclosure, rights outside the right assignment and/or ownership rights may be referred to as external rights. In the present example, rights R[2] through to R[7], i.e., the external rights, may respectively represent the rights of: listing, viewing content, editing content, copying, moving, and deleting digital assets. External rights may, additionally or alternatively, be interpreted by external systems. In accordance with multiple embodiments, external rights may have meaning within the context of the smart contracts 2900.

Another example of external rights, presented for illustrative purposes and not meant to be limiting, may pertain to an online game, such as a massively multiplayer online game (MMO) and/or massively multiplayer online role-playing game (MMORPG). In such cases, external rights may represent shared assets within the game, owned by one or more players. The NFT may provide a subset of the game players with abilities and/or access to subsections of the game. For example, R[2] through R[7] may represent access to subsections one through six of the game, allowing players registered within the rights mapping to enter areas not accessible to unregistered players. Those skilled in the art will now appreciate that rights stored in the rights mapping 2930 may represent access and/or permission rights that have many different applications in digital spaces.

In accordance with many embodiments, any number of rights may be represented and stored within NFT smart contracts 2900. In some embodiments, rights may apply or have significance across a plurality of services provided by a plurality of service providers. For example, certain NFTs may include arrays of rights, some of which apply to a first game provided by a first game company, and some of which may apply to a second game provided by a second game company. The set of rights that apply to the first game and the set of rights that apply to the second game may, in some cases, overlap.

Additionally or alternatively, NFT smart contracts 2900 configured in accordance with some embodiments of the invention may include hasRight( ) 2920 function to assess whether (and how many) rights associated with tokens are possessed by particular entities. The hasRight( ) 2920 function may enable external parties (for example, an operating system managing a file system, a game provided by a gaming company, and/or other smart contracts) to query NFT smart contracts 2900 for information pertaining to rights provided. This information may concern rights related to NFTs instantiated by NFT smart contracts 2900 and/or rights potentially possessed by entities with (e.g., blockchain) addresses.

In an example, an operating system managing a file system may receive a request from an entity to perform a restricted action (for example, to delete a file corresponding to the NFT). The operating system may then execute a call to the hasRight( ) 2920 function, with parameters including the identifier of the NFT (T.ID) and the address of the entity (P.addr). In doing so, the output of the hasRight( ) 2920 function may be the rights array 2936 (R). The operating system may then inspect the rights array 2936 returned. In the above rights array configuration example, this right would correspond to R[7]: a right to delete. In assessing the existence of this right, and when R[7] is equal to an affirmative indication (e.g., 1, true, and/or any other affirmation), the operating system may delete the file. Additionally or alternatively when R[7] is not equal to an affirmative indication, the operating system may reject the request from the party to delete the file. As the example in FIG. 29 utilizes a Boolean array, all entries where a 1 is listed represent affirmations that the corresponding right exists for the entity. Therefore, for right holder 0x456, in relation to the token with token ID of 1, only the right for R[2], listing, exists.

In general, rights conferred by NFTs may apply to services and/or assets off and/or off blockchain. In numerous embodiments, rights may apply to other smart contracts on blockchain. For example, a second smart contract may query NFT smart contracts 2900 configured in accordance with certain embodiments to determine whether an externally owned account and/or third smart contract making a call to the second smart contract holds rights allowing the call to proceed. Further, systems and methods in accordance with numerous embodiments may be configured in order to prioritize rights management.

A proxy rights smart contract configured in accordance with several embodiments of the invention is illustrated in FIG. 30. In accordance with various embodiments, proxy rights smart contracts 3000 may enable proxy instantiation of rights management for other smart contracts. Proxy rights smart contracts 3000 may include a variety of functions for managing token-related rights, including but not limited to (as discussed in FIG. 28) functions for recovering the owners for certain tokens (e.g., ownerOf( ) 3040), and/or functions for determining what rights particular parties have in particular tokens (e.g., hasRight( ) 3020).

Additionally or alternatively, smart contracts configured in accordance with many embodiments of the invention may include one or more data structures 3030, 3050, including but not limited to rights mapping 3030 data structure(s), and contract address 3050 data structure(s). In particular, contract address 3050 data structure(s) may be used for identifying smart contracts that the proxy right smart contracts 3000 are acting as proxies for (i.e., legacy NFT smart contracts 3005). Specifically, these legacy NFT smart contracts 3005 may refer to smart contracts that may not enable the instantiation of right management. The proxy rights smart contracts 3000 may maintain rights mapping 3030 data structures. Right holder mappings 3030 may include but are not limited to lists mapping tokens (Token IDs 3032) to corresponding right holders 3034 and/or right listings 3036.

In some embodiments, the proxy rights smart contracts 3000 may include ownerOf( ) functions 3040 taking token identifiers (T.ID) as parameters, as disclosed in FIGS. 28-29. In a number of embodiments, the ownerOf( ) function 3040 when called may make an onward call to the legacy NFT smart contracts 3005, to determine the owner(s) of the token(s) specified by the token identifier(s). In many embodiments, the ownerOf function 3040 may be included in other functionality of the proxy rights smart contracts 3000.

In certain embodiments, the contract address 3050 may be addresses of the (legacy) NFT smart contracts 3005, and the ownerOf function 3040 may use the contract address 3050 to determine which smart contract to call. In some embodiments, the contract address 3050 may, additionally or alternatively, include an ABI (application binary interface) value for a function within the NFT smart contracts 3005 to call. In many embodiments, the function within the NFT smart contracts 3005 that is called is an ownerOf( ) function, but other functions may be called in various embodiments.

For access rights, in addition to NFTs, rights may be implemented using fungible tokens (e.g., tokens implemented by a smart contract compiling with ERC-20).

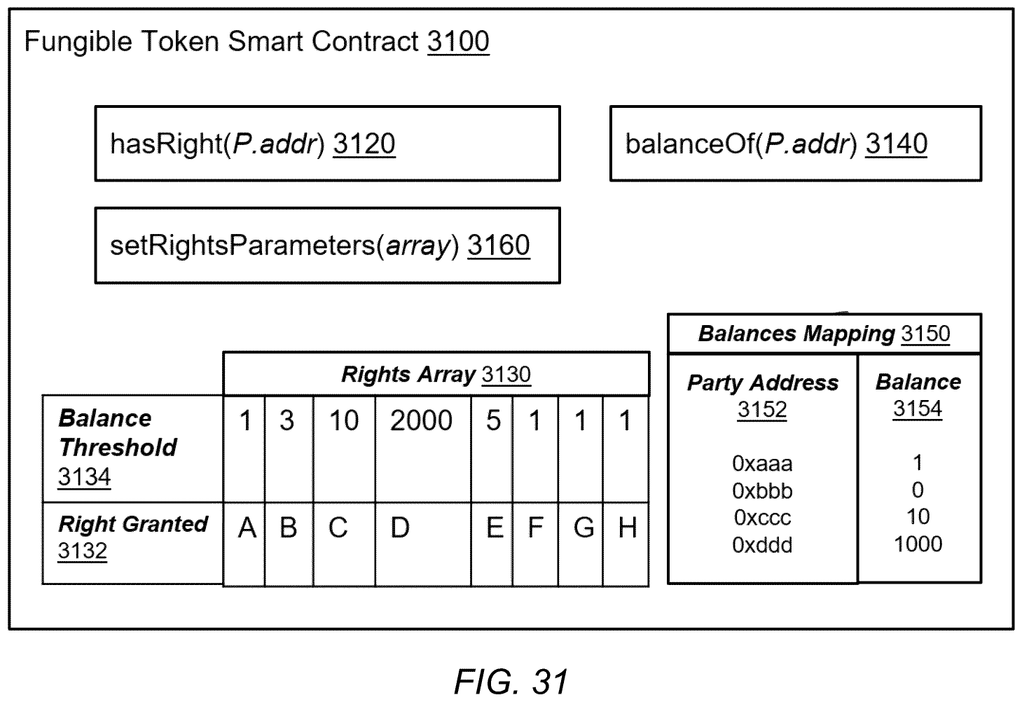

A fungible token smart contract configured in accordance with numerous embodiments of the invention is illustrated in FIG. 31. In particular, such systems may be used for providing an allocation of token-based rights. Specifically, rights may be automatically allocated depending on the balances associated with particular entities.

Fungible token smart contracts 3100 configured in accordance with multiple embodiments of the invention may include, but are not limited to functions for recovering the balances associated with certain tokens (e.g., balanceOf( ) 3140), functions for determining what rights particular parties have in particular tokens (e.g., hasRight( ) 3120), and/or functions that utilize balance amounts to allocate token-based rights (e.g., setRightsParameters( ) 3160). In accordance with several embodiments of the invention, balanceOf( ) 3140 functions may take, as input, (blockchain) addresses, returning the balance of tokens associated with the particular addresses. Fungible token smart contracts 3100 may include hasRight( ) 3120 functions that similarly take (blockchain) addresses (P.addr) as input, returning arrays indicating which rights the addresses hold (for example, the arrays shown in the rights listings 2936, 3036). In numerous embodiments of the invention, the hasRight( ) 3120 functions may optionally input indexes for particular rights, in which case, the function may return a Boolean value indicating whether the input addresses hold the individual right. Specifically, when the right exists, the output may be an affirmative indication (e.g., 1, true, and/or any other affirmation).

Fungible token smart contracts 3100 may, additionally or alternatively, include data structures including but not limited to balances mapping 3150 data structures, in which a list of addresses 3152 are mapped to a list of balances 3154; and/or rights arrays 3130, in which balance thresholds 3134 are mapped to the corresponding rights granted 3132. In some embodiments, the hasRight function 3120 may query the array 3130 to determine which rights certain addresses hold.

In various embodiments the rights array 3130 values may be specified with different amounts; the rights array 3130 values may correspond to different rights; and/or the rights array may have different numbers of elements, corresponding to a greater and/or lesser number of rights that are to be represented by the fungible token smart contracts 3100. In several embodiments, the rights array 3130 may indicate a balance required that is greater than or equal to the balance threshold 3134 specified. Additionally or alternatively, in some embodiments, the rights array 3130 may indicate a balance required that is greater than the amount specified.

The fungible token smart contracts 3100 may, additionally or alternatively, include setRightsParameters( ) 3160 functions. These functions may take, as input, arrays of balance thresholds required for sets of rights to be held. The setRightsParameters( ) 3160 functions may be restricted to be called only by a limited set of addresses. The limited sets of addresses may include one or more of: the addresses of the fungible token smart contracts 3100 deployer, addresses of the fungible token smart contracts 3100, addresses holding the right to edit the array 3130 (wherein the right is determined from the fungible token smart contracts 3100 and/or some other smart contract), and/or some other set of addresses.

In FIG. 31 exemplary values for fungible token smart contracts 3100 are presented for the purpose of illustration and are not meant to be limiting in any way. For example, the rights array 3130 may include an array with values 1, 3, 10, 2000, 5, 1, 1, and 1 corresponding to balance thresholds 3134 for each right 3132 associated with the fungible token smart contracts 3100. For addresses (e.g., 0xccc) that holds a balance of 10, the output of the hasRight( ) function may be: hasRight(0xccc)=[true, true, true, false, true, true, true, true].

On querying the hasRight( ) 3120 function with the address 0xccc, fungible token smart contracts 3100 configured in accordance with certain embodiments may return the above array indicating that address 0xccc holds all rights recorded by fungible token smart contracts 3100 except a fourth right (e.g., viewing content), as the fourth right has a balance threshold 3134 of 2000 tokens and address 0xccc holds a lower balance of 10 tokens.

Exemplary use cases for access rights based on a fungible token balance may include but are not limited to:

Access to facilities and services for holders of frequent-flyer miles. For example, holding 1000 or more miles may grant access to priority boarding, holding 2000 or more miles may also grant access to an airport lounge, holding 3000 or more miles may grant the holder priority access to travel class upgrades, and so on.

Services in conjunction with bank accounts. For example, those with a balance of more than 1000 currency tokens may receive access to an assistance hotline, those with a balance of more than 10,000 currency tokens may receive free travel insurance, and those with a balance of more than 100,000 currency tokens may receive access to a premium online brokerage account.

Voting rights in DAOs (distributed autonomous organizations). For example, holders of more than 100 tokens may receive a right to vote on specific policies of high importance, and there may be a requirement to hold more than 1000 tokens to be allowed to submit a proposal to the DAO for voting on.

In accordance with certain embodiments, smart contracts may be elucidated in terms of Ethereum Virtual Machine implementations. Equivalent functionality may be implemented on other smart contract-enabled blockchains (including but not limited to Algorand, Cardano, Cosmos, Near, etc.), in the respective programming languages for their smart contracts using the respective data structures and functionality provided.

While specific smart contract configurations are described above with reference to FIGS. 28-31, smart contracts may be incorporate various attributes as appropriate to the requirements of specific applications in accordance with many embodiments of the invention. Additionally, the specific manner in which NFT ownership may be facilitated by smart contracts utilized within NFT platforms in accordance with various embodiments of the invention is largely dependent upon the requirements of a given application.

While the above description contains many specific embodiments of the invention, these should not be construed as limitations on the scope of the invention, but rather as an example of one embodiment thereof. Accordingly, the scope of the invention should be determined not by the embodiments illustrated, but by the appended claims and their equivalents.

1. A method for modifying token ownership rights, comprising:
determining that a set of one or more ownership rights over a first token should undergo a transfer to an entity, wherein:
the first token is associated with a second token;
the transfer is determined based on:
a policy associated with the second token, and
an input to the policy; and
the entity is identified in the input to the policy;
verifying that the transfer, of the set of one or more ownership rights over the first token to the entity, complies with a pre-determined protocol of a blockchain; and
recording the transfer, of the set of one or more ownership rights over the first token to the entity, on the blockchain.

2. The method of claim 1, wherein at least one of the first token and the second token is a non-fungible token (NFT).

3. The method of claim 1, wherein:
the first token is associated with a first token smart contract; and
the input to the policy comprises a smart contract address of the first token smart contract.

4. The method of claim 1, wherein the policy is implemented in a smart contract associated with the second token.

5. The method of claim 1, wherein the first token corresponds to a sum of cryptocurrency.

6. The method of claim 1, wherein the set of one or more ownership rights is associated with at least one of a wallet address, a smart contract address, and a public key.

7. The method of claim 1, wherein:
the set of one or more ownership rights of the second token over the first token are listed in a record; and
the record is a data structure.

8. The method of claim 7, wherein the data structure takes a form selected from the group consisting of an array, a JavaScript Object Notation object, a mapping, and a dictionary.

9. The method of claim 1, wherein verifying that the transfer of the set of one or more ownership rights of the first token complies with the pre-determined protocol of the blockchain comprises:
verifying that a part of the input to the policy is digitally signed by a current owner of the second token,
wherein the policy is digitally signed using a digital signing algorithm specified by the pre-determined protocol.

10. The method of claim 1, wherein an ownership right of the set of one or more ownership rights authorizes the entity to provide, to a second entity, at least one of:
an ownership right over the first token; and
an access right over the first token, wherein the access right is selected from the group consisting of: viewing content associated with the first token, editing content associated with the first token, copying the first token, transferring the first token, deleting digital assets associated with the first token, and assigning at least one access right to a third entity.

11. A non-transitory computer-readable medium storing instructions that, when executed by a processor, are configured to cause the processor to perform operations for modifying token ownership rights, the operations comprising:
determining that a set of one or more ownership rights over a first token should undergo a transfer to an entity, wherein:
the first token is associated with a second token;
the transfer is determined based on:
a policy associated with the second token, and
an input to the policy; and
the entity is identified in the input to the policy:
verifying that the transfer, of the set of one or more ownership rights over the first token to the entity, complies with a pre-determined protocol of a blockchain; and
recording the transfer, of the set of one or more ownership rights over the first token to the entity, on the blockchain.

12. The non-transitory computer-readable medium of claim 11, wherein at least one of the first token and the second token is a non-fungible token (NFT).

13. The non-transitory computer-readable medium of claim 11, wherein:
the first token is associated with a first token smart contract; and
the input to the policy comprises a smart contract address of the first token smart contract.

14. The non-transitory computer-readable medium of claim 11, wherein the policy is implemented in a smart contract associated with the second token.

15. The non-transitory computer-readable medium of claim 11, wherein the first token corresponds to a sum of cryptocurrency.

16. The non-transitory computer-readable medium of claim 11, wherein the set of one or more ownership rights is associated with at least one of a wallet address, a smart contract address, and a public key.

17. The non-transitory computer-readable medium of claim 11, wherein:
the set of one or more ownership rights of the second token over the first token are listed in a record; and
the record is a data structure.

18. The non-transitory computer-readable medium of claim 17, wherein the data structure takes a form selected from the group consisting of an array, a JavaScript Object Notation object, a mapping, and a dictionary.

19. The non-transitory computer-readable medium of claim 11, wherein verifying that the transfer of the set of one or more ownership rights of the first token complies with the pre-determined protocol of the blockchain comprises:
verifying that a part of the input to the policy is digitally signed by a current owner of the second token,
wherein the policy is digitally signed using a digital signing algorithm specified by the pre-determined protocol.

20. The non-transitory computer-readable medium of claim 11, wherein an ownership right of the set of one or more ownership rights authorizes the entity to provide, to a second entity, at least one of:
an ownership right over the first token, and
an access right over the first token, wherein the access right is selected from the group consisting of: viewing content associated with the first token, editing content associated with the first token, copying the first token, transferring the first token, deleting digital assets associated with the first token, and assigning at least one access right to a third entity.
